(19) United States
(12) Patent Application Publication
(10) Pub. No.: US 2026/0005840 A1
(43) Pub. Date: Jan. 1, 2026

(54) SYSTEM AND METHOD FOR SECRET-MESSAGE TRANSMISSION

(71) Applicant: The Regents of the University of California, Oakland, CA (US)

(72) Inventor: Yingbo Hua, Riverside, CA (US)

(73) Assignee: The Regents of the University of California, Oakland, CA (US)

(21) Appl. No.: 18/965,788

(22) Filed: Dec. 2, 2024

Related U.S. Application Data
(60) Provisional application No. 63/604,787, filed on Nov. 30, 2023.

(51) Int. Cl. H04L 9/08; H04L 9/32

(52) U.S. Cl. CPC H04L 9/0827; H04L 9/0838; H04L 9/3215

(57) ABSTRACT

Provided is a system and method for secret-message transmission by echoing encrypted probes (STEEP). Specifically, STEEP may comprise, in one embodiment, two phases. For Phase 1: Alice transmits probing signals (or probes) to Bob, and most likely and unintentionally to Eve, over one or more probing channels, from which Eve must obtain a noisy version of the probes while Bob may receive a noisier version of the probes. For Phase 2: Bob echoes back his estimates of the probes, but encrypted by his secret, over one or more return channels that have much higher quality than the probing channels in phase 1.

### RELATED APPLICATION DATA

This application claims the benefit of U.S. Provisional Application Ser. No. 63/604,787, entitled “Secret-Message Transmission by Echoing Encrypted Probes-STEEP”, filed Nov. 30, 2024, which is incorporated herein by reference.

### GOVERNMENT LICENSE RIGHTS STATEMENT

This invention was made with government support under US Dept. of Defense Grant No. W911NF-20-2-0267. awarded by the U.S. Department of Defense. The government has certain rights in the invention

### FIELD OF THE INVENTION

The invention relates to a system and method for secret-message transmission. More specifically, a system and method is used for secret-message transmission by echoing encrypted probes (STEEP).

### BACKGROUND OF THE INVENTION

The design of how to transmit a secret message through a network of nodes (including people, agents, devices, machines and organizations) has attracted human's interest for ages, and its development from the information-theoretic (IT) perspectives was pioneered by Shannon, C. E. Shannon in the 1940s, “Communication theory of secrecy systems,” Bell Lab Technical Journal, Vol. 28, No. 4, pp. 656-715, 1948. The IT achievable limits based on one-way transmission over a wire-tap channel (WTC) model was established in 1970s by Wyner, A. D. Wyner, “The wire-tap channel,” Bell Lab Technical Journal, Vol. 54, No. 8, pp. 1355-1367 October 1975, and Csiszar and Korner I. Csiszar and J. Korner, “Broadcast channel with confientiall messages,” IEEE Trans. Infomation Theory, Vol. 24, No. 3, pp. 339-348, May 1978. Further developments of coding techniques and their theoretical bounds for one-way transmission are well documented in C. Feng, H.-M. Wang, and H. V. Poor, “Reliable and secure short-packet communications,” IEEE Trans. Wireless Communications, Vol. 21, No. 3, pp. 1913-1926 March 2022., R. Wilson, D. Tse, and R. A. Scholtz, “Channel identification: secret sharing using reciprocity in ultrawideband channels,” IEEE Trans. Inf. Forensics Secur., vol. 2, no. 3, pp. 364-375, September 2007 and many references therein. The achievable secrecy capacity (in bits per channel use in each coherence period) of one-way transmission is known to be ξₛ=ξₘ−ξₑ which is zero if the main channel capacity ξₘ (from Alice to Bob) is less than or equal to the eavesdropping channel capacity ξₑ (from Alice to Eve). For finite-length packets, a smallest penalty to ξₛ was recently achieved in C. Feng, H.-M. Wang, and H. V. Poor, “Reliable and secure short-packet communications,” IEEE Trans. Wireless Communications, Vol. 21, No. 3, pp. 1913-1926 March 2022, and N. Ari, N. Thomos, and L. Musavian, “Performance analysis of short packet communications with multiple eavesdropper,” IEEE Trans. Communications, Vol. 70, No. 10, pp. 6778-6789 October 2022

For a vast variety of situations in the real world, the transmission of a secret does not need to be constrained to be one-way. Cooperative two-way transmissions between two agents in a modern network are widely feasible. Indeed, in parallel to the WTC based developments, there is another branch of developments called secret key generation (SKG) via public communications, which was pioneered by Maurer in U. Maurer, “Secret key agreement by public discussion from common information,” IEEE Trans. Information Theory, Vol. 39, No. 3, pp. 733-742, May 1993. and Ahlswede and Csiszar in R. Ahlswede and I. Csiszar, “Common randomness in information theory and cryptography, Part I: secret sharing,” IEEE Trans. Information Theory, Vol. 39, pp. 1121-1132 July 1993. in 1990s. One of the widely applicable results developed by Maurer, Ahlswede and Csiszar (MAC) is thoroughly revisited by Bloch and Barros in M. Bloch, J. Barros, M. R. D. Rodrigues, and S. W. Mclaughlin, “Wireless information-theoretic security,” IEEE Trans. Information Theory, Vol. 54, No. 6, pp. 2515-2534 June 2008., which can be stated as follows:

Let the data sets available to Alice, Bob and Eve be respectively [symbol] , [symbol] , and [symbol] . Then there is a public communication scheme such that the achievable secret-key capacity C_{key} (in bits per independent realization of [symbol] , [symbol] , and [symbol] ) between Alice and Bob against Eve is bounded by

$${C}_{L} \leq {C}_{key} \leq {C}_{U} \qquad ( Equation 1 )$$

with C_{L}=max(C_{A}, C_{B}), C_{A}=I( [symbol] ; [symbol] )−I( [symbol] ; [symbol] ), C_{B}=I( [symbol] ; [symbol] )−I( [symbol] ; [symbol] ), C_{U}=min(I( [symbol] ; [symbol] ), C_{E}), and C_{E}=I( [symbol] ; [symbol] | [symbol] ). Here, I(A; B|C) denotes the mutual information between A and B conditioned on C. C_{L} and C_{U} as MAC's lower and upper bounds respectively is referred to.

However, despite the fact that any secret key of n bits established between Alice and Bob allows one of them to transmit a message of n bits to the other in complete secrecy, the past works on SKG and/or MAC's bounds have been largely treated in isolation from WTC based secret-message transmission. Such examples include R. Wilson, D. Tse, and R. A. Scholtz, “Channel identification: secret sharing using reciprocity in ultrawideband channels,” IEEE Trans. Inf. Forensics Secur., vol. 2, no. 3, pp. 364-375, September 2007, J. W. Wallace and R. K. Sharma, “Automatic secret keys from reciprocal MIMO wireless channels: Measurement and analysis,” IEEE Trans. Inf., Forensics Secur., vol. 5, no. 3, pp. 381-392, September 2010, N. Aldaghri and H. Mahdavifar, “Physical layer secret key generation in static environments”, IEEE Transactions on Information Forensics and Security, Vol. 15, pp. 2692-275 February 2020 and G. Li, H. Yang, J. Zhang, H. Liu, and A. Hu, “Fast and secure key generation with channel obfuscation in slowly varying environments,” IEEE INFOCOM 2022 May 2022.

### SUMMARY OF THE INVENTION

To solve shortcomings of the systems and methods described above, according to one embodiment, provided is a system and method for secret-message transmission by echoing encrypted probes (STEEP). Specifically, STEEP may comprise, in one embodiment, two phases.

For Phase 1: Alice transmits probing signals (or probes) to Bob, and most likely and unintentionally to Eve, over one or more probing channels, from which Eve must obtain a noisy version of the probes while Bob may receive a noisier version of the probes.

For Phase 2: Bob echoes back his estimates of the probes, but encrypted by his secret, over one or more return channels that have much higher quality than the probing channels in phase 1. This creates an effective WTC model from Bob to Alice and Eve in such a way that the effective return channel from Bob to Alice is guaranteed to be stronger than that from Bob to Eve. Consequently, any established WTC scheme can be applied using this method to achieve a positive secrecy rate from Bob to Alice.

STEEP allows Alice to receive a secret message from Bob reliably, and it yields a positive secrecy rate as long as Eve observes a noisy (as opposed to noiseless) version of the probes. STEEP provides an important unification of the prior theories and algorithms developed for WTC and SKG. There is little restriction on the probing channel and/or the return channel. For example, the probing channel can be wireless or wireline, analog or digital, fading or non-fading, etc. And the return channel can be viewed as a generalization of a public channel. Unlike the prior art where a one-way scheme is developed, STEEP is a round-trip two-way scheme. Unlike the schemes in the prior art, where many iterative transmissions between Alice and Bob via public channel are assumed, STEEP only needs one round-trip communication. Unlike the prior art where the achieved secrecy rate is zero if Eve's channel from Alice is stronger than Bob's channel from Alice, STEEP yields a positive secrecy rate even if Eve's channel from Alice (during channel probing) is stronger than that of Bob's channel from Alice.

Unlike the prior art where public pilots are avoided in hope to achieve a positive secrecy that grows with the number of probing symbols in each coherence period, STEEP is guaranteed to yield a secrecy that increases with the number of probing symbols even for a static probing channel and even with public pilots used for channel estimation. Unlike the prior art which requires a perfectly-reciprocal fading channel between users and a weak channel at Eve for a SKG framework, STEEP can yield a positive secrecy rate even if users' channel gain is constant, non-reciprocal, known to Eve, and/or weaker than Eve's channel gain.

Unlike all prior art constrained to the physical layer, STEEP applies to all layers of networks.

Ignoring the contribution from correlated channel gains between Alice and Bob, the achievable secrecy limit (in bits per probing sample) of STEEP for analog probing channels is

$${ξ}_{STEEP , AC} = E \{ log ( 1 + \frac{{SNR}_{B , A}}{1 + {SNR}_{E , A}} ) \} \qquad ( Equation 2 )$$

where SNR_{B,A} is Bob's instantaneous signal-to-noise ratio (SNR) during channel probing, and SNR_{E,A} is Eve's (after matched filtering in the case of multiple antennas on Eve). The expectation E can be dropped for a probing channel with long coherence time. STEEP can deliver a positive secrecy rate virtually for any SNR_{E,A}. This should make STEEP attractive in many applications where one might only know an upper bound of SNR_{E,A}, which could be larger than SNR_{B,A}.

The development of STEEP is based on important insights into MAC's bounds of channel probing for SKG in the context of a single-input and single-out (SISO) channel between Alice and Bob. MAC's lower and upper bounds will first be presented based on a (half-duplex) two-way channel probing scheme, which then leads to an important observation that for one-way channel probing, MAC's lower and upper bounds meet each other and the corresponding secret-key capacity C_{key} is a positive and linearly increasing function of the number of probing symbols even if Eve's channel from Alice (during probing) is stronger than that of Bob's channel from Alice. Then, after channel probing from Alice to Bob, if Bob sends a combination of a random sequence (of his own) and his received (noisy or noiseless) probes back to Alice (and also to Eve) via a high-quality return channel, MAC's lower bound converges to C_{key} when a large power is used by Bob for the random sequence. Next, a refined insight into MAC's lower bound will be presented where Bob discards his received probes after he has generated and transmitted the random sequence in combination with his received probes. Optimal estimation by Alice and Eve of the random sequence transmitted by Bob is focused on, from which an important advantage of the round-trip communication (i.e., channel probing in one direction followed by transmission of encrypted probes in the other direction) becomes more clear.

With the above insights, the system and method called STEEP for analog channels is presented. The principle of STEEP is also applicable to digital channels in any connected networks. The only fundamental requirement in order for STEEP to yield a positive secrecy rate is that Eve does not receive the exact probing symbols sent by Alice.

### BRIEF DESCRIPTION OF THE DRAWINGS

FIG. 1. is a flow diagram illustrating a potential application of STEEP where the channel strength for Eve during probing is either weaker or stronger than that for Bob;

FIG. 2. is a flow diagram illustrating a potential application of STEEP in multihop digital networks;

FIG. 3 is a wireless network with multi-antenna Alice, single antenna Bob and multi-antenna Eve;

FIGS. 4A-4D are graphs showing the distribution of C_{STREEP} FOR n_{A}=4 and P_{A}=20 dB;

FIGS. 5A-5D are graphs showing the distribution of C_{STREEP} FOR n_{A}=4 and P_{A}=20 dB and under the same conditions as for FIGS. 4A-4D;

FIGS. 6A-6D are graphs showing the distribution of Gₛ for n_{A}=4 and P_{A}=20 dB;

FIGS. 7A-7D are graphs showing outage probabilities verses Rₛ for n_{A}=4 and P_{A}=30 dB;

FIGS. 8A-8D are graphs showing outage probabilities verses Rₛ for n_{A}=4 and P_{A}=20 dB;

FIGS. 9A-9D are graphs showing distributions of C̅_̅{̅s̅,̅1̅}̅ subject to p_{A}=10 dB and p_{B}=30 dB;

FIGS. 10A-10D are graphs showing distributions of C̅_̅{̅s̅,̅1̅}̅ subject to p_{A}=20 dB and p_{B}=30 dB;

FIGS. 11A-11D are graphs showing distributions of C̅_̅{̅s̅,̅1̅}̅ subject for n_{A}=1, n_{E}=4, and p_{A}=20 dB and p_{B}=30 dB;

FIGS. 12A-12D are graphs showing distributions of C̅_̅{̅s̅,̅1̅}̅ subject for n_{A}=1, n_{E}=4, and p_{A}=20 dB and p_{B}=30 dB;

FIGS. 13A-13-D are graphs showing distributions of [symbol] in dB for n_{E}=4, p_{A}=20 dB and M=2, 4, 8, 16;

FIGS. 14A-14D are graphs showing distributions of C̅ₛ̅ for M=2, 4, 8, 16 subject to n_{A}=n_{E}=4, p_{A}=10 dB and p_{B}=30 dB;

FIG. 15 STEEP is flow diagram illustrating a round-trip scheme with embedded secret message on returned (estimated) probes;

FIG. 16 is a diagram of a UAV wireless network with multi-antenna Alice and multi-antenna Eve;

FIGS. 17A-17D, shown are the distributions of C_{STEEP} for four combinations of p_{B}=30 dB or 40 dB and ρ=1 or 0;

FIGS. 18A-18D show the distributions of C₁ and C₂ for the conventional scheme where p_{B}=30, 40 dB and ρ=1,0;

FIGS. 19A-19D are graphs that compare the secrecy outage probabilities of the STEEP and conventional schemes versus a range of small but positive Rₛ for

$${θ}_{B , A} = \frac{π}{6} , \frac{π}{12} and ρ = 1 , 0 ;$$

FIGS. 20A-20D are graphs that compare the secrecy outage probabilities of both schemes versus p_{E}; and

FIGS. 21A-21D are graphs that compare the secrecy outage probabilities of both schemes versus the elevation angle θ_{B,A}.

### DETAILED DESCRIPTION

For the purpose of illustrating the invention, there is shown in the accompanying drawings several embodiments of the invention. However, it should be understood by those of ordinary skill in the art that the invention is not limited to the precise arrangements and instrumentalities shown therein and described below.

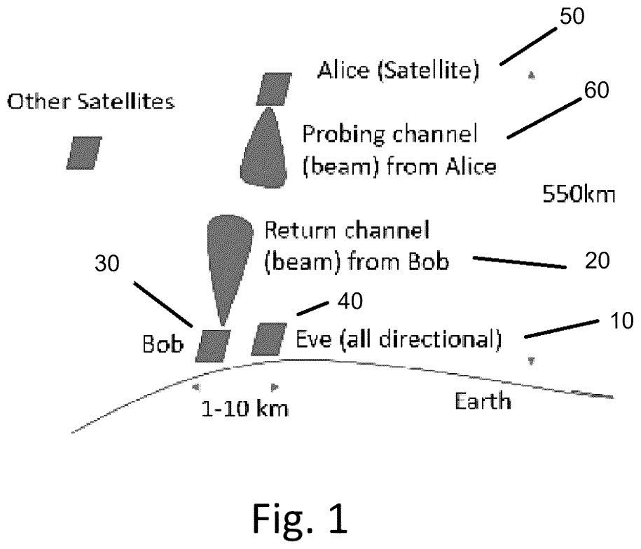

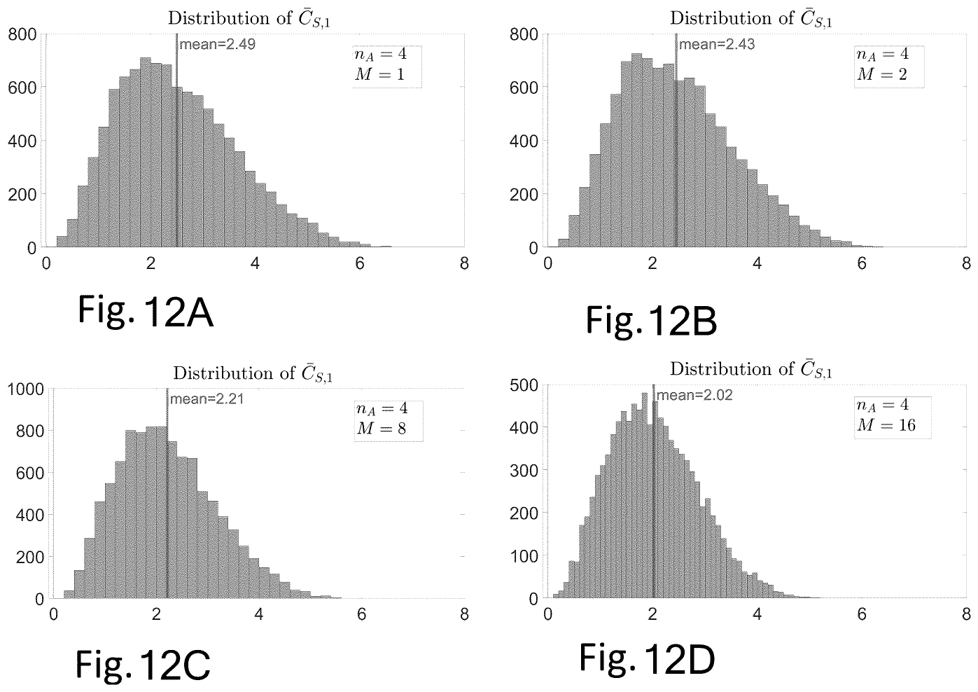

The system and method for secret-message transmission is disclosed in accordance with preferred embodiments of the present invention is illustrated in FIGS. 1-21 wherein like reference numerals are used throughout to designate like elements.

Two-way (half-duplex) channel probing schemes for SKG through a MIMO channel between Alice and Bob were recently studied where the degree of freedom of MAC's bounds relative to the probing power is shown. But the complexity caused by the MIMO channel still poses a challenge to fully understand the MIMO based MAC's bounds until recently by the same inventor in Y. Hua and A. Maksud, “Secret-Key Capacity from MIMO Channel Probing,” IEEE Wireless Communications Letters, Vol. 13, No. 5, May 2024 described below herein.

The SISO channel between Alice and Bob is examined in order to understand the exact MAC's bounds and their implications. It is assumed that Eve has n_{E}≥1 antennas. For a wireline network, the multiple antennas on Eve would correspond to multiple tapping points on the network. First, only considered are discrete-time analog channels (i.e., physical layer channels) until as described below.

Furthermore, it is assumed that Alice has applied a public pilot (of sufficient power) so that Bob has obtained his receive channel response h_{B,A}, and Eve has obtained her channel response vector g_{A}∈ [symbol] (relative to Alice). Similarly, Bob has applied a public pilot so that Alice knows her receive channel response h_{A,B}, and Eve knows her channel response vector g_{B}∈ [symbol] (relative to Bob).

Then Alice sends m_{A} i.i.d. random probing symbols (only known to Alice), denoted by X_{A}={x_{A}(k), k=1, . . . , m_{A}} by, over the SISO probing channel to Bob. After that, Bob also sends mg i.i.d. random probing symbols X_{B}={x_{B}(k), k=1, . . . , m_{B}} (only known to Bob) to Alice over the SISO probing channel (in reverse direction). Correspondingly, Alice and Bob receive respectively

$${y}_{A} ( k ) = {h}_{A , B} {x}_{B} ( k ) + {w}_{B} ( k ) \qquad ( Equation 3 )$$

$${y}_{B} ( k ) = {h}_{B , A} {x}_{A} ( k ) + {w}_{A} ( k ) \qquad ( Equation 4 )$$

And Eve receives both of the following:

$${e}_{A} ( k ) = {g}_{A} {x}_{A} ( k ) + {w}_{E , A} ( k ) \qquad ( Equation 5 )$$

$${e}_{B} ( k ) = {g}_{B} {x}_{B} ( k ) + {w}_{E , B} ( k ) \qquad ( Equation 6 )$$

Here, all complex components of x_{A}(k), x_{B}(k), w_A (k), w_{B}(k), w_{E,A}(k) and w_{E,B} are i.i.d. circular complex Gaussian with zero mean and their variances denoted by p_{A}, p_{B},

$${σ}_{A}^{2} , {σ}_{B}^{2} , {σ}_{E , A}^{2} and {σ}_{E , B}^{2}$$

respectively.

For now, it is assumed that h_{A,B} is only known to Alice; h_{B,A} is only known to Bob; g_{A} and g_{B} are only known to Eve; h_{A,B} and h_{B,A} are jointly Gaussian with zero mean and the covariance matrix

$$[ \begin{matrix}1 & ρ \\ {ρ}^{*} & 1\end{matrix} ] Here ρ = E \{ {h}_{A , B} {h}_{B , A}^{*} \} and \vert ρ \vert < 1.$$

Also in this section, {h_{A,B}, h_{B,A}} is independent of {g_{A}, g_{B}}.

To apply MAC's bounds, let [symbol] ={ [symbol] ₁, h_{A,B}} with [symbol] ₁={X_{A}, Y_{A}} and Y_{A}={y_{A}(k), k=1, . . . , m_{B}}; [symbol] ={ [symbol] ₁, h_{B,A}} with [symbol] ₁={X_{B}, Y_{B}} and Y_{B}={y_{B}(k), k=1, . . . , m_{A}}; [symbol] ={ [symbol] ₁, g_{A}, g_{B}} with [symbol] ₁={E_{A}, E_{B}}, E_{A}={e_{A}(k), k=1, . . . , m_{A}} and E_{B}={e_{B}(k), k=1, . . . , m_{B}}.

Theorem 1: Based on the above model of { [symbol] , [symbol] , [symbol] }, MAC's bounds shown in MAC are governed by

$${C}_{A} = α + {m}_{B} {ξ}_{A , B} + {m}_{A} {γ}_{B , A} , \qquad ( Equation 7 )$$

$${C}_{B} = α + {m}_{A} {ξ}_{B , A} + {m}_{B} {γ}_{A , B} \qquad ( Equation 8 )$$

$${C}_{E} = α + {m}_{A} {ξ}_{B , A} + {m}_{B} {γ}_{A , B} \qquad ( Equation 9 )$$

$$where$$

$$α = - log ( 1 - {\vert ρ \vert}^{2} ) ,$$

$${ξ}_{B , A} = E \{ log ( 1 + \frac{{p}_{A} {\vert {h}_{B , A} \vert}^{2} / {σ}_{B}^{2}}{{p}_{A} {\vert {g}_{A} \vert}^{2} / {σ}_{E , A}^{2} + 1} ) \} \qquad ( Equation 10 )$$

$${γ}_{B , A} = E \{ log \frac{{p}_{A} {\vert {h}_{B , A} \vert}^{2} / {σ}_{B}^{2} + 1}{{p}_{A} {\vert {g}_{A} \vert}^{2} / {σ}_{E , A}^{2} + 1} \} \qquad ( Equation 11 )$$

and ξ_{A,B} and γ_{A,B} are defined accordingly by exchanging “A” and “B”. The proof is provided after the discussion shown next.

### Discussion of Theorem 1

The following will also be used:

$${ϕ}_{A , B} = \frac{{p}_{B} {\vert {h}_{A , B} \vert}^{2} / {σ}_{A}^{2}}{{p}_{B} {\vert {g}_{B} \vert}^{2} / {σ}_{E , B}^{2} + 1} \qquad ( Equation 12 )$$

$${ϕ}_{B , A} = \frac{{p}_{A} {\vert {h}_{B , A} \vert}^{2} / {σ}_{B}^{2}}{{p}_{A} {\vert {g}_{A} \vert}^{2} / {σ}_{E , A}^{2} + 1} \qquad ( Equation 13 )$$

so that ξ_{A,B}=E{log (1+ϕ_{A,B})} and ξ_{B,A}=E{log (1+ϕ_{B,A})}.

It is clear that ξ_{A,B}>0, ξ_{B,A}>0, γ_{A,B}<ξ_{A,B} and γ_{B,A}<ξ_{B,A}. Also γ_{B,A}>0 if and only if the probing channel from Alice to Bob is stronger than that from Alice to Eve, i.e.,

$${\vert {h}_{B , A} \vert}^{2} / {σ}_{B}^{2} > {\vert {g}_{A} \vert}^{2} / {σ}_{E , A} Similarly ,$$

γ_{A,B}>0 if and only if the probing channel from Bob to Alice is stronger than that from Bob to Eve, i.e.,

$${\vert {h}_{A , B} \vert}^{2} / {σ}_{A}^{2} > {\vert {g}_{B} \vert}^{2} / {σ}_{E , B}^{2} .$$

In the absence of the knowledge of whether Eve's channel is weak or not, we can guarantee C_{A}>0 by choose m_{A}=0. Similarly, we can guarantee C_{B}>0 by choose m_{B}=0. Furthermore, with m_{A}=0, we have C_{A}=C_{E} which is then C_{key}. And with m_{B}=0, we have C_{B}=C_{E} which is then C_{key}. Note that it follows from Equation (1) that max (C_{A}, C_{B})≤C_{key}≤C_{E}.

Corollary 1: MAC's lower and upper bounds for one-way channel probing coincide with each other. Specifically, if m_{A}>m_{B}=0,

$${C}_{key} = {C}_{B} = {C}_{E} = α + {m}_{A} {ξ}_{B , A} \qquad ( Equation 14 )$$

which is positive and increases linearly with m_{A}. Similarly, if m_{B}>m_{A}=0,

$${C}_{key} = {C}_{A} = {C}_{E} = α + {m}_{B} {ξ}_{A , B} \qquad ( Equation 15 )$$

which is positive and increases linearly with m.

Here m_{A}ξ_{B,A} in Equation (14) is the amount of secrecy achievable from m_{A} probing samples from Alice. So, we can refer to ξ_{B,A} as secrecy rate in bits per probing sample from Alice. Similarly, ξ_{A,B} can be referred to as secrecy rate in bits per probing sample from Bob.

It should be of interest to note that if the two-way channel probing scheme can be (and is) conducted in full-duplex (i.e., at the same frequency and the same time) subject to the same channel model at Eve (i.e., Equation (5) and Equation (6)), Corollary 1 with n_{E}=1 would coincide exactly with the lower bound of achievable secrecy rate shown in Proposition 1 in A. Khisti, “Interactive secret key generation over reciprocal fading channel,” Proc of 50th Annual Allerton Conference, pp. 1374-1381, UIUC, IL, October 2012. (subject to the pilot power being much larger than the power of the probing symbols). More specifically, with or without full-duplex, the first term a in Equations (14) and (15) represents the total secrecy contributed by the correlation between h_{A,B} and h_{B,A}. In the case of full-duplex, a is achieved using a single sampling interval for both public pilots from Alice and Bob. Also, for full-duplex two-way probing, the second terms in Equations (14) and (15) (under “mg=m and m_{A}=0” and “m_{A}=m and m_{B}=0” respectively) should be added together as an achievable secrecy due to the m sampling intervals for the random symbols from Alice and Bob. This is because under full-duplex two-way probing, the data sets [symbol] ={ [symbol] } collected by Alice, Bob and Eve can be partitioned as [symbol] ={ [symbol] } with [symbol] ={ [symbol] } and [symbol] ={ [symbol] }. Here (not counting the parts associated with public pilots), [symbol] is associated with the transmission from Alice, and [symbol] is associated with the transmission from Bob. Hence [symbol] is independent of [symbol] when conditioned on channel state information. More interestingly, this same reasoning along with Corollary 1 implies that the achievable lower bound shown in Proposition 1 in A. Khisti, “Interactive secret key generation over reciprocal fading channel,” Proc of 50th Annual Allerton Conference, pp. 1374-1381, UIUC, IL, October 2012 is also the achievable upper bound.

However, A. Khisti, “Interactive secret key generation over reciprocal fading channel,” Proc of 50th Annual Allerton Conference, pp. 1374-1381, UIUC, IL, October 2012, which focuses on SKG from a full-duplex SISO channel, this paper considers a half-duplex SISO (probing) channel, and our proof of secret-key capacity is based on the established MAC's bounds. We will not need to re-establish the correctness and/or tightness (or any asymptotical properties) of MAC's bounds. MAC's bounds are somewhat universal and applicable to the data sets [symbol] , [symbol] and [symbol] formed under each of our considered cases. Furthermore, this paper is not only about the achievable secrecy rate but also about a simple scheme called STEEP to be shown.

Because of Corollary 1 and the need to guarantee a positive secrecy rate under any conditions of Eve's channel, we will next focus on one-way channel probing for secret-message transmission. A goal in this paper is to present a simple method (simpler than the back-and-forth public communication scheme shown in U. Maurer, “Secret key agreement by public discussion from common information,” IEEE Trans. Information Theory, Vol. 39, No. 3, pp. 733-742, May 1993 to transmit a secret between Alice and Bob with the secrecy capacity approaching that shown in Corollary 1.

### Proof of Theorem 1

Starting with C_{A}=I( [symbol] ; [symbol] )−I( [symbol] ; [symbol] ) and analyze I( [symbol] ; [symbol] ) and ( [symbol] ) separately as follows.

1) Analysis of I( [symbol] ; [symbol] ). We know

$$I ( 𝒜 ; B ) = I ( {h}_{A , B} ; ℬ ) + I ( {A}_{1} ; ℬ \vert {h}_{A , B} ) = I ( {h}_{A , B} ; {h}_{B , A} ) + I ( {h}_{A , B} ; {ℬ}_{1} \vert {h}_{B , A} ) + I ( {𝒜}_{1} ; {h}_{B , A} \vert {h}_{A , B} ) + I ( {𝒜}_{1} ; {ℬ}_{1} \vert {h}_{B , A} , {h}_{A , B} ) . \qquad ( Equation 16 )$$

$$Here ,$$

$$Equation 17 )$$

$${I ( {h}_{B , A} ; {h}_{B , A} ) = h ( {h}_{A , B} ) - h ( {h}_{A , B} \vert {h}_{B , A} ) = log ( e π ) - log ( e π ( 1 - \vert ρ \vert}^{2} ) ) = - log ( 1 - {\vert ρ \vert}^{2} )$$

where 1−|ρ|² is the variance of h_{A,B} when conditioned on h_{B,A}. And

$$( Equation 18 )$$

$$I ( {h}_{A , B} ; ℬ \vert {h}_{A , B} ) = I ( {h}_{A , B} ; {Y}_{B} \vert {X}_{B} , {h}_{B , A} ) = h ( {Y}_{B} \vert {X}_{B} , {h}_{B , A} ) - h ( {Y}_{B} \vert {h}_{A , B} , {X}_{B} , {h}_{B , A} ) = h ( {Y}_{B} \vert {h}_{B , A} ) - h ( {Y}_{B} \vert {h}_{B , A} ) = 0.$$

By symmetry, also I( [symbol] ₁; h_{B,A}|h_{A,B})=0. For the 4th term in Equation (16), it can be written I( [symbol] ₁: [symbol] ₁|h_{B,A}, h_{A,B})=I( [symbol] ₁: [symbol] ₁|h_{T}). It follows that

$$( Equation 19 )$$

$$I ( {𝒜}_{1} ; {ℬ}_{1} \vert {h}_{T} ) = I ( {X}_{A} ; {ℬ}_{1} \vert {h}_{T} ) + I ( {Y}_{A} ; {ℬ}_{1} \vert {X}_{A} , {h}_{T} ) = I ( {X}_{A} ; {Y}_{B} \vert {h}_{T} ) + I ( {Y}_{A} ; {X}_{B} \vert {h}_{T} ) ,$$

where the independence between X_{A} and X_{B} is used. Furthermore,

$$( Equation 20 )$$

$$I ( 𝒜 ; {ℬ}_{1} \vert {h}_{T} ) = h ( {Y}_{B} \vert {h}_{T} ) - h ( {Y}_{B} \vert {X}_{A} , {h}_{T} ) + h ( {Y}_{A} \vert {h}_{T} ) - h ( {Y}_{A} \vert {X}_{B} , {h}_{T} ) = {m}_{A} 𝔼 ( log ( {p}_{A} {\vert {h}_{B , A} \vert}^{2} / {σ}_{B}^{2} + 1 ) \} + {m}_{B} 𝔼 ( log ( {p}_{B} {\vert {h}_{A , B} \vert}^{2} / {σ}_{A}^{2} + 1 ) \} .$$

Combining the above results in Equation (16) yields

$$I ( 𝒜 ; ℬ ) = - log ( 1 - {\vert ρ \vert}^{2} ) + {m}_{A E} \{ log ( {p}_{A} {\vert {h}_{B , A} \vert}^{2} / {σ}_{B}^{2} + 1 ) ∖ \} + {m}_{B E} \{ log ( {p}_{B} {\vert {h}_{A B} \vert}^{2} / {σ}_{A}^{2} + 1 ) \} \qquad ( Equation 21 )$$

2) Analysis of I( [symbol] ; [symbol] )

It follows that

$$l ( 𝒜 ; ε ) = I ( {𝒜}_{1} ; ε \vert {h}_{A , B} ) = I ( {𝒜}_{1} ; {ε}_{1} \vert {h}_{A , B} , {g}_{A} , {g}_{B} ) \qquad ( Equation 22 )$$

where applied is the independent between h_{A,B} and {g_{A}, g_{B}}. We will now write I( [symbol] ₁; [symbol] ₁|h_{A,B}, g_{A}, g_{B})=I( [symbol] ₁; [symbol] ₁|c_{A}). It follows that

$$\begin{matrix}I ( 𝒜 ; ε ) = I ( {𝒜}_{1} ; {ε}_{1} \vert {c}_{A} ) \\ = I ( {X}_{A} ; {ε}_{1} \vert {c}_{A} ) + I ( {X}_{A} ; {ε}_{1} \vert {X}_{A} , {c}_{A} ) \\ = I ( {X}_{A} ; {E}_{A} \vert {c}_{A} ) + I ( {X}_{A} ; {E}_{B} \vert {X}_{A} \text{?} {c}_{A} ) .\end{matrix} \qquad ( Equation 23 )$$

$$\text{?} \text{indicates text missing or illegible when filed}$$

where we have used the independence between X_{A} and E_{B}, and the independence between Y_{A} and E_{A}. Furthermore, I(Y_{A}; E_{B}|X_{A}, c_{A})=I(Y_{A}; E_{B}|c_{A}) due to independence between X_{A} and {Y_{A}, E_{B}}. It follows that

$$I ( 𝒜 ; ε ) = I ( {X}_{A} ; {E}_{A} \vert {c}_{A} ) + I ( {Y}_{A} ; {E}_{B} \vert {c}_{A} ) . \qquad ( Equation 24 )$$

$$Here$$

$$\begin{matrix}I ( {X}_{A} ; {E}_{A} \vert {c}_{A} ) = h ( {E}_{A} \vert {c}_{A} ) - h ( {E}_{A} \vert {X}_{A} , {c}_{A} ) \\ = {m}_{A} 𝔼 \{ log \vert {p}_{A} {g}_{A} {g}_{A}^{H} / {σ}_{E , A}^{2} + I \text{?} \vert \} \\ = {m}_{A} 𝔼 \{ log \vert {p}_{A} {‖ {g}_{A} ‖}^{2} / {σ}_{E , A}^{2} + 1 ) \} .\end{matrix}$$

$$and , with$$

$${D}_{A} = diag ( {σ}_{A}^{2} , {σ}_{E , B}^{2} , … {σ}_{E , B}^{2} , ) = diag ( {σ}_{A}^{2} , {σ}_{E , B}^{2 {I}_{{n}_{E}}} ) and {g}_{B}^{′} = {[ {h}_{B , A} , {g}_{A}^{T} ]}^{T} \qquad ( Equation 25 )$$

$$I ( {Y}_{A} ; {E}_{B} \vert {c}_{A} ) = h ( {E}_{B} \vert {c}_{A} ) - h ( {E}_{B} \vert {Y}_{A} , {c}_{A} ) = h ( {E}_{B} \vert {c}_{A} ) + h ( {Y}_{A} , {c}_{A} ) - h ( {E}_{B} \vert {Y}_{A} , {c}_{A} ) = {m}_{B} 𝔼 \{ log \vert {p}_{B} {g}_{B} {g}_{B}^{H} + {σ}_{E , A}^{2} + I \text{?} \vert \} + {m}_{B} 𝔼 \{ log \vert {p}_{B} ‖ {h}_{A , B} + {σ}_{A}^{2} ) - {m}_{B} 𝔼 \{ log \vert {p}_{B} {g}_{B}^{′} {g}_{B}^{′ H} + {D}_{A} \vert \} = {m}_{B} 𝔼 \{ log ( \text{?} ( {p}_{B} {‖ {g}_{B} ‖}^{2} / {σ}_{E , B}^{2} + 1 ) ) \} + {m}_{B} 𝔼 \{ log ( {σ}_{A}^{2} ( {p}_{B} {\vert {h}_{A , B} \vert}^{2} / {σ}_{A}^{2} + 1 ) ) - {m}_{B} 𝔼 \{ log ( {σ}_{A}^{2} σ \text{?} ( {p}_{B} {\vert {h}_{A , B} \vert}^{2} / {σ}_{A}^{2} + {p}_{B} {‖ {g}_{B} ‖}^{2} / {σ}_{E , B}^{2} + 1 ) ) \} = {m}_{B} 𝔼 \{ log ( {p}_{B} {‖ {g}_{B} ‖}^{2} / {σ}_{E , B}^{2} + 1 ) \} + {m}_{B} 𝔼 \{ log ( {p}_{B} {\vert {h}_{A , B} \vert}^{2} / {σ}_{A}^{2} + 1 ) - {m}_{B} 𝔼 \{ log ( {p}_{B} {\vert {h}_{A , B} \vert}^{2} / {σ}_{A}^{2} + {p}_{B} {‖ {g}_{B} ‖}^{2} / {σ}_{E , B}^{2} + 1 ) \} \qquad ( Equation 26 )$$

$$\text{?} \text{indicates text missing or illegible when filed}$$

Note that the following was used:

$$\vert {p}_{B} g \text{?} g + {D}_{A} \vert = \vert {D}_{A} \vert \vert {p}_{B} D \text{?} g \text{?} D \text{?} + I \text{?} \vert = \vert {D}_{A} \vert ( {p}_{B} g \text{?} D \text{?} g \text{?} + 1 ) .$$

$$\text{?} \text{indicates text missing or illegible when filed}$$

Combining the above results in Equation (24) yields

$$( Equation 27 )$$

$$I ( 𝒜 ; ε ) = {m}_{A} 𝔼 \{ log \vert {p}_{A} {‖ {g}_{A} ‖}^{2} / {σ}_{E , A}^{2} + 1 ) \} + {m}_{B} 𝔼 \{ log ( {p}_{B} {‖ {g}_{B} ‖}^{2} / {σ}_{E , B}^{2} + 1 ) \} + {m}_{B} 𝔼 \{ log ( {p}_{B} {‖ {h}_{A , B} ‖}^{2} / {σ}_{A}^{2} + 1 ) - {m}_{B} 𝔼 \{ log ( {p}_{B} {\vert {h}_{A , B} \vert}^{2} / {σ}_{A}^{2} + {p}_{B} {‖ {g}_{B} ‖}^{2} / {σ}_{E , B}^{2} 1 ) \} .$$

Combining Equations (21) and (27) yields Equation 7. By symmetry between “A” and “B”, Equation (8) follows from Equation (7).

3) Analysis of C_{E}: It is known

$$I ( 𝒜 ; ε ) = {m}_{A} 𝔼 \{ log \vert {p}_{A} {‖ {g}_{A} ‖}^{2} / {σ}_{E , A}^{2} + 1 ) \} + {m}_{B} 𝔼 \{ log ( {p}_{B} {‖ {g}_{B} ‖}^{2} / {σ}_{E , B}^{2} + 1 ) \} + {m}_{B} 𝔼 \{ log ( {p}_{B} {‖ {h}_{A , B} ‖}^{2} / {σ}_{A}^{2} + 1 ) - {m}_{B} 𝔼 \{ log ( {p}_{B} {\vert {h}_{A , B} \vert}^{2} / {σ}_{A}^{2} + {p}_{B} {‖ {g}_{B} ‖}^{2} / {σ}_{E , B}^{2} 1 ) \} . \qquad ( Equation 28 )$$

Here I(h_{A,B}; h_{B,A}) is given by Equation (17). The 2nd term in Equation (28) is I(h_{A,B}; [symbol] ₁|h_{B,A}, [symbol] )=I(h_{A,B}; Y_{B}| X_{B}, h_{B,A}, [symbol] )=h(Y_{B}|X_{B}, h_{B,A}, [symbol] )−h(Y_{B}|h_{A,B}, X_{B}, h_{B,A}, [symbol] )=h(Y_{B}|X_{B}, h_{B,A}, E_{A}, E_{B})−h(Y_{B}|h_{A,B}, X_{B}, h_{B,A}, E_{A}, E_{B})=h(Y_{B}|X_{B}, h_{B,A}, E_{A}, E_{B})−h(Y_{B}|X_{B}, h_{B,A}, E_{A}, E_{B})=0. Similarly, the 3rd term in Equation (29) is also zero.

Used is h_{T} to denote {h_{A,B}, h_{B,A}}, and c_{T} to denote {h_{A,B}, h_{B,A}, g_{A}, g_{B}}. Then the 4th term in Equation (28) is I( [symbol] ₁; [symbol] ₁|h_{T}, [symbol] )=I( [symbol] ₁; [symbol] ₁|h_{T}, g_{A}, g_{B}, [symbol] ₁)=I( [symbol] ₁; [symbol] ₁|c_{T}, [symbol] ₁). It follows that

$$I ( {𝒜}_{1} ; {ℬ}_{1} \vert {c}_{T} , ε ) = I ( {X}_{A} ; {ℬ}_{1} \vert {c}_{T} , {ε}_{1} ) + I ( {Y}_{A} ; {ℬ}_{1} \vert {X}_{A} , {c}_{T} , {ε}_{1} ) = I ( {X}_{A} ; {X}_{B} \vert {c}_{T} , {ε}_{1} ) + I ( {X}_{A} ; {X}_{B} \vert {X}_{B} , {c}_{T} , {ε}_{1} ) + I ( {X}_{A} ; {X}_{B} \vert {X}_{A} , {c}_{T} , {ε}_{1} ) + I ( {Y}_{A} ; {X}_{B} \vert {X}_{B} , {h}_{T} , {ε}_{1} ) = {T}_{1} + {T}_{2} + {T}_{3} + {T}_{4} . \qquad ( Equation 29 )$$

The first term in Equation (29) is

$${T}_{1} = h ( {X}_{A} \vert {c}_{T} , {ε}_{1} ) - h ( {X}_{A} \vert {X}_{B} , {c}_{T} , {ε}_{1} ) = h ( {ε}_{1} \vert {X}_{A} , {c}_{T} ) + h ( {X}_{A} \vert {c}_{T} ) - h ( {ε}_{1} \vert {c}_{T} ) - [ h ( {ε}_{1} \vert {X}_{A} , {X}_{B} , {c}_{T} ) - h ( {ε}_{1} \vert {X}_{B} , {c}_{T} ) - h ( {ε}_{1} \vert {X}_{B} , {c}_{T} ) ] = h ( {ε}_{1} \vert {X}_{A} , {c}_{T} ) - h ( {ε}_{1} \vert {c}_{T} ) - h ( {ε}_{1} \vert {X}_{A} , {X}_{B} , {c}_{T} ) + h ( {ε}_{1} \vert {X}_{B} , {c}_{T} ) ] \text{?} \qquad ( Equation 30 )$$

$$\text{?} \text{indicates text missing or illegible when filed}$$

where h( [symbol] ₁|X_{A}, c_{T})=h(E_{A}|X_{A}, c_{T})+h(E_{B}|E_{A}, X_{A}, c_{T})=h(E_{A}|X_{A}, c_{T})+h(E_{B}|C_{T}), h( [symbol] ₁|c_{T})=h(E_{A}|c_{T})+h(E_{B}|E_{A}, c_{T})=h(E_{A}|c_{T})+h(E_{B}|c_{T}), and h( [symbol] ₁|X_{B}, c_{T})=h(E_{A}|X_{B}, c_{T})+h(E_{B}|E_{A}, X_{B}, c_{T})=h(E_{A}|c_{T})+h(E_{B}|X_{B}, c_{T}). Hence,

$${T}_{1} = h ( {E}_{A} \vert {X}_{A} , {c}_{T} ) - h ( {ε}_{1} \vert {X}_{A} , {X}_{B} , {c}_{T} ) + h ( {E}_{B} \vert {X}_{B} , {c}_{T} ) = 0. \qquad ( Equation 31 )$$

Note that h( [symbol] ₁|X_{A}, X_{B}, c_{T})=h(E_{A}, E_{B}|X_{A}, X_{B}, c_{T})=h(E_{A}|X_{A}, X_{B}, c_{T})+h(E_{B}|X_{A}, X_{B}, c_{T})=h(E_{A}|X_{A}, c_{T})+h(E_{B}|X_{B}, c_{T}). Also note that [symbol] ₁ consists of the two components E_{A} and E_{B} that are functions of the independent X_{A} and X_{B} respectively.

The second term in Equation (29) is

$$( Equation 32 )$$

$${T}_{2} = I ( {X}_{A} ; {Y}_{B} \vert {c}_{T} , {E}_{A} ) = h ( {Y}_{B} \vert {c}_{T} , {E}_{A} ) - h ( {Y}_{B} \vert {X}_{A} , {c}_{T} , {E}_{A} ) = h ( {Y}_{B} \vert {E}_{A} , {c}_{T} ) - h ( {E}_{A} \vert {c}_{T} ) ] - h ( {Y}_{B} , {E}_{A} \vert {X}_{A} , {c}_{T} ) - h ( {E}_{A} \vert {X}_{A} , {c}_{T} ) ] = [ h ( {Y}_{B} {E}_{A} \vert {c}_{T} ) - h ( {Y}_{B} , {E}_{A} \vert {X}_{A} , {c}_{T} ) ] - h ( {E}_{A} \vert {X}_{A} , {c}_{T} ) ] = {m}_{A} 𝔼 \{ log ( {p}_{A} {g}_{A}^{′} {g}_{A}^{′ H} + {D}_{B} \vert {D}_{B}^{- 1} \vert \} - {m}_{A} 𝔼 \{ log \vert {p}_{A} {g}_{A} {g}_{A}^{H} / {σ}_{E , A}^{2} + I \text{?} \vert \} = {m}_{A} 𝔼 \{ log ( {p}_{A} {g}_{A}^{′ H} {D}_{B}^{- 1} {g}_{A}^{′} + 1 \vert \} - {m}_{A} 𝔼 \{ log ( {p}_{A} {‖ {g}_{A} ‖}^{2} / {σ}_{E , A}^{2} + 1 ) \} = {m}_{A} 𝔼 \{ log ( 1 + \frac{{p}_{A} {\vert {h}_{B , A} \vert}^{2} / {σ}_{B}^{2}}{{p}_{A} {‖ {g}_{A} ‖}^{2} / {σ}_{E , A}^{2} + 1} ) \} ,$$

$$where$$

$${g}_{A}^{′} = {[ {h}_{B , A} , {g}_{A}^{T} ]}^{T} and {D}_{B} = diag ( {σ}_{B}^{2} , {σ}_{E , B}^{2 {I}_{{n}_{E}}} ) .$$

$$\text{?} \text{indicates text missing or illegible when filed}$$

The third term T₃ in Equation (29) is symmetric with T₂ in terms of “A” and “B”.

The fourth term in Equation (29) is

$$( Equation 33 )$$

$$\begin{matrix}{T}_{4} = h ( {Y}_{A} \vert {X}_{B} , {X}_{A} , {h}_{T} , {ℰ}_{1} ) - h ( {Y}_{A} \vert {Y}_{B} , {X}_{B} , {X}_{A} , {h}_{T} , {ℰ}_{1} ) \\ = h ( {Y}_{A} , {ℰ}_{1} \vert {X}_{B} , {X}_{A} , {h}_{T} ) - h ( {ℰ}_{1} \vert {X}_{B} , {X}_{A} , {h}_{T} ) - \\ [ h ( {Y}_{A} , {X}_{B} , {ℰ}_{1} \vert {X}_{B} , {X}_{A} , {h}_{T} ) - h ( {X}_{B} , {ℰ}_{1} \vert {X}_{B} , {X}_{A} , {h}_{T} ) ] .\end{matrix}$$

Then,

$${T}_{4} = [ \text{} h ( {Y}_{A} , {E}_{B} \vert {X}_{B} , {h}_{T} ) + h ( {E}_{A} \vert {X}_{A} , {h}_{T} ) ] - [ \text{} h ( {E}_{A} \vert {X}_{A} , {h}_{T} ) + h ( {E}_{B} \vert {X}_{B} , {h}_{T} ) ] - [ h ( {Y}_{B} , {E}_{A} \vert {X}_{A} , {h}_{T} ) + h ( {Y}_{A} , {E}_{B} \vert {X}_{B} , {h}_{T} ) ] + [ \text{} h ( {Y}_{B} , {E}_{A} \vert {X}_{A} , {h}_{T} ) + h ( {E}_{B} \vert {X}_{B} , {h}_{T} ) ] = 0$$

Therefore, combining the above results into Equation (28) yields Equation (9). The proof of Theorem 1 is completed.

### Return Channel Transmission After One-Way Probing

As discussed in above, the secret-key capacity from one-way probing is always positive and increasing linearly with the number of probing symbols. Now probing is focused on.

We can now assume m_{A}>m_{B}=0 without loss of generality.

In this case, Bob receives y_{B}(k)=h_{B,A}x_{A}(k)+w_{B}(k) for k=1, . . . , m_{A} due to channel probing from Alice, and the secret-key capacity is given by C_{B} in Equation (14).

Pre-processing is used so that both Alice and Bob can obtain good estimates of a common vector. Following a similar strategy in Y. Hua, “Generalized channel probing and generalized pre-processing for secret key generation,” IEEE Transactions on Signal Processing, Vol. 71, pp. 1067-182 April 2023, Bob sends out r(k)=s(k)+y_{B}(k) over a return channel to Alice (and unavoidably another return channel to Eve) where s(k) is a random sequence generated by Bob. Assumed is that the signals received by Alice and Eve via the return channels are respectively

$$\begin{matrix}{r}_{A} ( k ) = r ( k ) + {υ}_{A} ( k ) \\ = s ( k ) + {h}_{B , A} {x}_{A} ( k ) + {w}_{B} ( k ) + {υ}_{A} ( k ) ,\end{matrix} \qquad ( Equation 34 )$$

$$\begin{matrix}{r}_{E} ( k ) = r ( k ) + {υ}_{E} ( k ) \\ = s ( k ) + {h}_{B , A} {x}_{A} ( k ) + {w}_{B} ( k ) + {υ}_{A} ( k ) .\end{matrix} \qquad ( Equation 35 )$$

Here s(k) for k=1, . . . , m_{A} are i.i.d.

$$𝒞𝒩 ( 0 , {σ}_{s}^{2} ) ,$$

v_{A}(k) for k=1, . . . , m_{A} are i.i.d. [symbol] (0, ϵ_{A}), and v_{E}(k) for k=1, . . . , m_{A} are i.i.d. [symbol] (0, ϵ_{E}). The secret information in s(k) is meant to be received by Alice.

Because of the transmission of r(k) by Bob, the new secret-key

$${C}_{key}^{′}$$

is likely to be different from C_{key}=C_{B}. To understand

$${C}_{key}^{′} ,$$

we let the renewed data sets at Alice, Bob and Eve be respectively

$${𝒜}^{′} = \{ {𝒜}_{1}^{′} , {h}_{A , B} \} = \{ {X}_{A} , {R}_{A} , {h}_{A , B} \} , {ℬ}^{′} = \{ {ℬ}_{1}^{′} , {h}_{B , A} \} = \{ {Y}_{B} , S , {h}_{B , A} \} and \\ {ℰ}^{′} = \{ {ℰ}_{1}^{′} , {g}_{A} , {g}_{B} \} = \{ {E}_{A} , {R}_{E} , {g}_{A} , {g}_{B} .$$

Here S={s(k), ∀, R_{A}={r_{A}(k), ∀ and R_{E}={r_{E}(k), ∀.

There is no need to consider

$${C}_{A}^{′}$$

as it satisfies

$${C}_{A}^{′} \leq {C}_{A}$$

(if the return channel is perfect and same for both Alice and Eve) and C_{A} (with m_{B}=0) is previously shown to be non-positive if Eve's channel from Alice during probing is no weaker than that from Alice to Bob.

We will next analyze

$${C}_{B}^{′} = I ( {𝒜}^{′} ; {ℬ}^{′} ) - I ( {ℬ}^{′} ; {ℰ}^{′} ) .$$

Theorem 2: For

$${ϵ}_{A} << {σ}_{B}^{′} {ϵ}_{E} << {σ}_{B} and η = \frac{{ϵ}_{E}}{{ϵ}_{B}} ,$$

it follows that

$${C}_{key}^{′} \geq {C}_{B}^{′} \geq {α}^{′} + {m}_{A} {ξ}_{B , A}^{′} + {m}_{A} log with \qquad ( Equation 36 )$$

$${α}^{′} = 𝔼 \{ log ( \frac{{‖ {x}_{A} ‖}^{2} / ( {σ}_{s}^{2} + {σ}_{B}^{2} ) + \frac{1}{1 - {\vert ρ \vert}^{2}}}{{‖ {x}_{A} ‖}^{2} / ( {σ}_{s}^{2} + {σ}_{B}^{2} ) + 1} ) \} , \qquad ( Equation 37 )$$

$${ξ}_{B , A}^{′} = 𝔼 \{ log ( 1 + \frac{{ϕ}_{B , A} {σ}_{s}^{2} / {σ}_{B}^{2} )}{1 + {ϕ}_{B , A} + {σ}_{s}^{2} / {σ}_{B}^{2} )} ) \} . \qquad ( Equation 38 )$$

Here x_{A}=[x_{A}(1), . . . , x_{A}(mₐ)]^{T} and ϕ_{B,A} is defined in Equation (13).

A discussion is shown next before the proof is given.

### Discussion of Theorem 2

It is clear that 0<α′<where the lower bound is approached when

$${\vert {x}_{A} \vert}^{2} / ( {σ}_{s}^{2} + {σ}_{B}^{2} ) >> \frac{1}{1 - {\vert ρ \vert}^{2}}$$

which includes the case of a sufficiently large m_{A}, and the upper bound is approached when

$${\vert {x}_{A} \vert}^{2} / ( {σ}_{s}^{2} + {σ}_{B}^{2} ) << 1$$

which includes the case of a sufficiently large

$${σ}_{s}^{2} .$$

Also,

$${ξ}_{B , A}^{′} \leq \overline{{ξ}_{B , A}} \leq {ξ}_{B , A}$$

with

$${\overline{ξ}}_{B , A} = 𝔼 \{ log ( 1 + {η}_{s} \frac{{p}_{A} {\vert {h}_{B , A} \vert}^{2} / {σ}_{B}^{2}}{{p}_{A} {‖ {g}_{A} ‖}^{2} / {σ}_{B , A}^{2} + 1} ) \} , \qquad ( Equation 39 )$$

where

$${η}_{s} = \frac{{σ}_{s}^{2} / {σ}_{B}^{2}}{{σ}_{s}^{2} / {σ}_{B}^{2} + 1} .$$

It is evident that

$${ξ}_{B , A}^{′} = \overline{{ξ}_{B , A}}$$

is achieved if

$${σ}_{s}^{2}$$

is so large that

$$( {σ}_{s}^{2} / {σ}_{B}^{2} + 1 ) ( {p}_{A} {‖ {g}_{A} ‖}^{2} / {σ}_{B , A}^{2} + 1 ) ≫ {p}_{A} {\vert {h}_{B , A} \vert}^{2} / {σ}_{B}^{2} . \qquad ( Equation 40 )$$

$$And \overline{{ξ}_{B , A}} = {ξ}_{B , A} if {σ}_{s}^{2} ≫ {σ}_{B}^{2} .$$

Furthermore, if η≤1 (i.e., Eve's return channel is no noisier than Alice's return channel),

$${C}_{B}^{′} \leq {C}_{B} = {C}_{key} .$$

For η≤1, there is no need to analyze explicitly

$${C}_{E}^{′} = I ( {𝒜}^{′} ; {ℬ}^{′} \vert {ℰ}^{′} )$$

since the upper bound of secret-key capacity cannot increase after any further processing over the public channels. Namely, we would expect that for

$$η \leq 1 , {C}_{E}^{′} \leq {C}_{E} = {C}_{key} .$$

Note that for the case of

$${σ}_{s}^{2} \to ,$$

S seems completely exposed to Eve. How could any secrecy in S be still protected?

To help answer this question, we will in the next section consider the case where Bob only relies on S={s(k), ∀ after R={r(k), ∀k has been sent.

### Proof of Theorem 2

Analysis of I( [symbol] ′; [symbol] ′)

$$1 ) Analysis of I ( {𝒜}^{′} , {ℬ}^{′} ) : It follows that$$

$$\begin{matrix}I ( {𝒜}^{′} ; {ℬ}^{′} ) = I ( {h}_{A , B} ; {ℬ}^{′} ) + I ( {𝒜}_{1}^{′} ; {ℬ}^{′} \vert {h}_{A , B} ) \\ = I ( {h}_{A , B} ; {h}_{B , A} ) + I ( {h}_{A , B} ; {ℬ}_{1}^{′} \vert {h}_{B , A} ) + \\ I ( {𝒜}_{1}^{′} ; {h}_{B , A} \vert {h}_{A , B} ) + I ( {𝒜}_{1}^{′} ; {ℬ}_{1}^{′} \vert {h}_{T} ) .\end{matrix} \qquad ( Equation 41 )$$

Here it's evident I(h_{A,B}; h_{B,A})=−log(1−|ρ|²). The 2nd term in Equation (41) is

$$\begin{matrix}I ( {h}_{A , B} ; {ℬ}_{1}^{′} \vert {h}_{B , A} ) = I ( {h}_{A , B} ; {Y}_{B} \vert S , {h}_{B , A} ) \\ = h ( {Y}_{B} \vert S , {h}_{B , A} ) - h ( {Y}_{B} \vert {h}_{A , B} , S , {h}_{B , A} ) \\ = h ( {Y}_{B} \vert {h}_{B , A} ) - h ( {Y}_{B} \vert {h}_{B , A} ) \\ = 0.\end{matrix} \qquad ( Equation 42 )$$

where R_{A}, when conditioned on h_{B,A}, is independent of h_{A,B}. Recall r_{A}(k)=s(k)+h_{B,A}x_{A}(k)+w_{B}(k)+v_{A}(k), or equivalently

$${r}_{A} = s + {h}_{B , {Ax}_{A}} + {w}_{B} + {v}_{A} \qquad ( Equation 43 )$$

with r_{A}≐[r_{A}(1), . . . , r_{A} (m_{A})]^{T}. Note that given h_{A,B}, h_{B,A} is Gaussian distributed with the variance 1−|\rho|\hat{ }2. So, the PDF of r_{A} given h_{B,A} and X_{A} is

$$C 𝒩 ( {h}_{B , {Ax}_{A}} , {R}_{r} ) with {R}_{r} = {g}_{{AI}_{{m}_{A}}} and {g}_{A} = {σ}_{s}^{2} + {σ}_{B}^{2} + {ϵ}_{A} .$$

And the PDF of r_{A} given h_{A,B} and X_{A} is

$$𝒞𝒩 ( , {R}_{r}^{′} ) with {R}_{r}^{′} = ( 1 - {\vert ρ \vert}^{2} ) {x}_{{Ax}_{A}^{H}} + {g}_{{AI}_{{m}_{A}}} .$$

Therefore,

$$\begin{matrix}I ( {𝒜}_{1}^{′} ; {h}_{B , A} \vert {h}_{A , B} ) = 𝔼 \{ log \vert {R}_{r}^{′} \vert - log \vert {R}_{r} \vert \} \\ = 𝔼 \{ log ( ( 1 - {\vert ρ \vert}^{2} ) {‖ {x}_{A} ‖}^{2} / {g}_{A} + 1 ) \} ,\end{matrix} \qquad ( Equation 45 )$$

which, unlike the second term in Equation (41), is not zero.

For the 4th term in Equation (41), we have

$$\begin{matrix}I ( {𝒜}_{1}^{′} ; {ℬ}_{1}^{′} \vert {h}_{T} ) = I ( {X}_{A} ; {ℬ}_{1}^{′} \vert {h}_{T} ) + I ( {R}_{A} ; {ℬ}_{1}^{′} \vert {X}_{A} , {h}_{T} ) \\ = I ( {X}_{A} ; {Y}_{B} \vert S , {h}_{T} ) + I ( {R}_{A} ; S \vert {X}_{A} , {h}_{T} ) + \\ I ( {R}_{A} ; {Y}_{B} \vert S , {X}_{A} , {h}_{T} ) ,\end{matrix} \qquad ( Equation 46 )$$

where I(X_{A}; S|h_{T})=0 is used. Furthermore,

$$I ( {X}_{A} ; {Y}_{B} \vert S , {h}_{T} ) = h ( {Y}_{B} \vert S , {h}_{T} ) - h ( {Y}_{B} \vert {X}_{A} , S , {h}_{T} ) = {m}_{A} 𝔼 \{ log ( 1 + {p}_{A} {\vert {h}_{B , A} \vert}^{2} / {σ}_{B}^{2} ) \} , \qquad ( Equation 47 )$$

$$I ( {R}_{A} ; S \vert {X}_{A} , {h}_{T} ) = h ( {R}_{A} \vert {X}_{A} , {h}_{T} ) - h ( {R}_{A} \vert S , {X}_{A} , {h}_{T} ) = {m}_{A} log ( 1 + {σ}_{s}^{2} / ( {σ}_{B}^{2} + {ϵ}_{A} ) ) , \qquad ( Equation 48 )$$

$$I ( {R}_{A} ; {Y}_{B} \vert S , {X}_{A} , {h}_{T} ) = h ( {R}_{A} \vert S , {X}_{A} , {h}_{T} ) - h ( {R}_{A} \vert {Y}_{B} , S , {X}_{A} , {h}_{T} ) = {m}_{A} log ( 1 + {σ}_{B}^{2} / {ϵ}_{A} ) . \qquad ( Equation 49 )$$

Using the above results in Equation (41), subject to

$${ϵ}_{A} ≪ {σ}_{B}^{2} ,$$

yields

$$I ( {𝒜}^{′} ; {ℬ}^{′} ) = 𝔼 \{ log ( \frac{{‖ {x}_{A} ‖}^{2}}{{σ}_{s}^{2} + {σ}_{B}^{2}} + \frac{1}{1 - {\vert ρ \vert}^{2}} ) \} + {m}_{A} 𝔼 \{ log ( 1 + {p}_{A} {\vert {h}_{B , A} \vert}^{2} / {σ}_{B}^{2} ) \} + {m}_{A} log ( 1 + {σ}_{s}^{2} / {σ}_{B}^{2} ) + {m}_{A} log ( {σ}_{B}^{2} + {ϵ}_{A} ) . \qquad ( Equation 50 )$$

Note that the last term does not converge as Σ_{A}→0. We will expect I( [symbol] ′; [symbol] ′) to have a similar term to “balance” it out.

2) Analysis of I( [symbol] ′; [symbol] ′): We will use g_{T} to denote {g_{A}, g_{B}}, and

$${c}_{T}^{′}$$

{h_{B,A}, g_{A}, g_{B}}.

It follows that

$$I ( {ℬ}^{′} ; {ℰ}^{′} ) = I ( {h}_{B , A} ; {ℰ}^{′} ) + I ( {ℬ}_{1}^{′} ; {ℰ}^{′} \vert {h}_{B , A} ) = I ( {h}_{B , A} ; {ℰ}_{1}^{′} \vert {g}_{T} ) + I ( {ℬ}_{1}^{′} ; {ℰ}_{1}^{′} \vert {c}_{T}^{′} ) . \qquad ( Equation 51 )$$

$$Here ,$$

$$I ( {h}_{B , A} ; {ℰ}_{1}^{′} \vert {g}_{T} ) = I ( {h}_{B , A} ; {R}_{E} \vert {E}_{A} , {g}_{T} ) = h ( {h}_{B , A} \vert {E}_{A} , {g}_{T} ) - h ( {h}_{B , A} \vert {R}_{E} , {E}_{A} , {g}_{T} ) . \qquad ( Equation 52 )$$

Recall r_{E}(k)=s(k)+h_{B,A}x_{A}(k)+w_{B}(k)+v_{E}(k), and e_{A}(k)=g_{A}x_{A}(k)+w_{E,A}. It follows that h(h_{B,A}|E_{A}, g_{T})=h(h_{B,A})=log(eπ). Furthermore,

$$h ( {h}_{B , A} \vert {R}_{E} , {E}_{A} , {g}_{T} ) \geq h ( {h}_{B , A} \vert {R}_{E} , {E}_{A} , {g}_{T} , {W}_{E , A} ) = h ( {h}_{B , A} \vert {R}_{E} , {X}_{A} ) \qquad ( Equation 53 )$$

where W_{E,A} consists of w_{E,A}(k) for all k. We can write

$${r}_{E} = {[ {r}_{E} ( 1 ) , … , {r}_{E} ( {m}_{A} ) ]}^{T} = s + {h}_{B , {Ax}_{A}} + {w}_{B} + {v}_{E} \qquad ( Equation 54 )$$

Given {R_{E}, X_{A}} (or equivalently {r_{E}, x_{A\}}), the PDF of h_{B,A} is

$$𝒞𝒩 ( , {ϵ}_{h} ) with {ϵ}_{h} = \frac{{g}_{E}}{{\vert {x}_{A} \vert}^{2} + {g}_{E}} and {g}_{E} = {σ}_{s}^{2} + {σ}_{B}^{2} + {ϵ}_{E} .$$

### Hence,

h(h_{B,A}|R_{E},E_{A},g_{T})≥log(eπ)+E{log ϵₙ} Equation 55)
and therefore the 1st term in Equation (51) is

$$I ( {h}_{B , A} ; {ℰ}_{1}^{′} \vert {g}_{T} ) \leq - E \{ log {ϵ}_{h} \} = E \{ log ( 1 + {\vert {x}_{A} \vert}^{2} / {g}_{E} ) \} . \qquad ( Equation 56 )$$

For the 2nd term in Equation (51), we can replace

$${c}_{T}^{′}$$

by (the simpler notation) c_{T} without affecting the result. We can further write that 2nd term as

$$I ( {ℬ}_{1}^{′} ; {ℰ}_{1}^{′} \vert {c}_{T} ) = I ( S ; {ℰ}_{1}^{′} \vert {c}_{T} ) + I ( {Y}_{B} ; {ℰ}_{1}^{′} \vert S , {c}_{T} ) = I ( S ; {E}_{A} \vert {c}_{T} ) + I ( S ; {R}_{E} \vert {E}_{A} , {c}_{T} ) + I ( {Y}_{B} ; {R}_{E} \vert S , {c}_{T} ) + I ( {Y}_{B} ; {E}_{A} \vert {R}_{E} , S , {c}_{T} ) . \qquad ( Equation 57 )$$

Here I(S; E_{A}|c_{T})=0. Also,

$$I ( S ; {R}_{E} \vert {E}_{A} , {c}_{T} ) = h ( {R}_{E} \vert {E}_{A} , {c}_{T} ) - h ( {R}_{E} \vert S , {E}_{A} , {c}_{T} ) = h ( {R}_{E} , {E}_{A} \vert {c}_{T} ) - h ( {E}_{A} \vert {c}_{T} ) - [ h ( {R}_{E} , {E}_{A} \vert S , {c}_{T} ) - h ( {E}_{A} \vert S , {c}_{T} ) ] = h ( {R}_{E} , {E}_{A} \vert {c}_{T} ) - h ( {R}_{E} , {E}_{A} \vert S , {c}_{T} ) , \qquad ( Equation 58 )$$

$$I ( {Y}_{B} ; {R}_{E} \vert S , {c}_{T} ) = h ( {R}_{E} \vert S , {c}_{T} ) - h ( {R}_{E} \vert {Y}_{B} , S , {c}_{T} ) = h ( {R}_{E} \vert S , {c}_{T} ) - h ( {R}_{E} , {Y}_{B} \vert S , {c}_{T} ) + h ( {Y}_{B} \vert S , {c}_{T} ) , \qquad ( Equation 59 )$$

$$I ( {Y}_{B} ; {E}_{A} \vert {R}_{E} , S , {c}_{T} ) = h ( {Y}_{B} \vert {R}_{E} , S , {c}_{T} ) - h ( {Y}_{B} \vert {E}_{A} , {R}_{E} , S , {c}_{T} ) = h ( {Y}_{B} , {R}_{E} \vert S , {c}_{T} ) - h ( {R}_{E} \vert S , {c}_{T} ) - h ( {Y}_{B} , {E}_{A} , {R}_{E} \vert S , {c}_{T} ) + h ( {E}_{A} , {R}_{E} \vert S , {c}_{T} ) . \qquad ( Equation 60 )$$

Using the above results, and h(Y_{B}|S, c_{T})=h(Y_{B}|c_{T}), in Equation (57) yields

$$I ( {ℬ}_{1}^{′} ; {ℰ}_{1}^{′} \vert {c}_{T} ) = h ( {R}_{E} , {E}_{A} \vert {c}_{T} ) + h ( {Y}_{B} \vert {c}_{T} ) - h ( {Y}_{B} , {E}_{A} , {R}_{E} \vert S , {c}_{T} ) . \qquad ( Equation 61 )$$

For h(R_{E}, E_{A}|c_{T}) in Equation (61), we recall r_{E} (k)=s(k)+h_{B,A}x_{A}(k)+w_{B}(k)+v_{E}(k) and e_{A} (k)=g_{A}x_{A} (k)+w_{E,A}(k). Also write

$${e}_{A}^{′} ( k ) ≐ {[ {r}_{E} ( k ) , {e}_{A}^{T} ( k ) ]}^{T} = {g}_{A}^{′} {x}_{A} ( k ) + {w}_{E , A}^{′} ( k ) \qquad ( Equation 63 )$$

with

$${g}_{A}^{′} = {[ {h}_{B , A} , {g}_{A}^{T} ]}^{T} and {w}_{E , A}^{′} ( k ) = {[ s ( k ) + {w}_{B} ( k ) + {v}_{E} ( k ) , {w}_{E , A}^{T} ]}^{T} .$$

### The PDF if

$${e}_{A}^{′} ( k )$$

given c_{T} is

$$𝒞𝒩 ( 0 , {p}_{{Ag}_{A}^{′} {g}_{A}^{′ H}} + {D}_{E}^{′} ) with {D}_{E}^{′} = diag ( {g}_{E} , {σ}_{E , A}^{2 {I}_{{n}_{E}}} ) and {g}_{E} = {σ}_{s}^{2} + {σ}_{B}^{2} + {ϵ}_{E} .$$

### So,

$$h ( {R}_{E} , {E}_{A} \vert {c}_{T} ) = {m}_{A} ( {n}_{E} + 1 ) log ( e π ) + {m}_{A} 𝔼 \{ log \vert {p}_{A} {g}_{A}^{′} {g}_{A}^{′H} + {D}_{E}^{′} \vert \} = {m}_{A} ( {n}_{E} + 1 ) log ( e π ) + {m}_{A} 𝔼 \{ log ( {g}_{E} {σ}_{E , A}^{2 {n}_{E}} [ {p}_{A} {\vert {h}_{B , A} \vert}^{2} / {g}_{E} + {p}_{A} {‖ {g}_{A} ‖}^{2} / {σ}_{E , A}^{2} + 1 ] ) \} . \qquad ( Equation 64 )$$

It is obvious that the 2nd term in Equation (61) is

$$h ( {Y}_{B} \vert {c}_{T} ) = {m}_{A} log ( e π ) + {m}_{AE} \{ log ( {p}_{A} {\vert {h}_{B , A} \vert}^{2} + {σ}_{B}^{2} ) .$$

For h(Y_{B}, E_{A}, R_{E}|S, c_{T}) in Equation (61), we let

$$y ( k ) \dot{=} [ \begin{matrix}{r}_{E} ( k ) - s ( k ) \\ {y}_{B} ( k ) \\ {e}_{A} ( k )\end{matrix} ] = {g}_{A}^{″} {x}_{A} ( k ) + {1}_{2} {w}_{B} ( k ) + {w}_{E , A}^{″} + {1}_{1} {v}_{E} ( k ) \qquad ( Equation 64 )$$

where

$${g}_{A}^{″} = {[ {h}_{B , A} , {h}_{B , A} , {g}_{A}^{T} ]}^{T} ,$$

1₂=[1, 1, 0, . . . , 0]^{T},

$${w}_{E , A}^{″} = {[ 0 , 0 , {w}_{E , A}^{T} ]}^{T} ,$$

and 1₁=[1, 0, . . . , 0]^{T}. It follows that the PDF of y(k) given {S, c_{T}} is [symbol] (*, R_{y}) with

$${R}_{y} = {p}_{A} {g}_{A}^{″} {g}_{A}^{″ H} + {σ}_{B}^{2} {1}_{2} {1}_{2}^{H} + {σ}_{E , A}^{2} {I}_{{n}_{B}}^{″} + {ϵ}_{E} {1}_{1} {1}_{1}^{H} \qquad ( Equation 65 )$$

where

$${I}_{{n}_{E}}^{″} = diag ( 0 , 0 , {I}_{{n}_{E}} ) .$$

Equivalently,

$${R}_{y} = [ \begin{matrix}{R}_{1 , 1} & {R}_{1 , 2} \\ {R}_{1 , 2}^{H} & {R}_{2 , 2}\end{matrix} ] \qquad ( Equation 66 )$$

$$where$$

$${R}_{1 , 1} = [ \begin{matrix}{g}_{1} + {ϵ}_{E} & {g}_{1} \\ {g}_{1} & {g}_{1}\end{matrix} ] \qquad ( Equation 67 )$$

$${R}_{1 , 2} = {p}_{A} {h}_{B , A} 1 {g}_{A}^{H} , \qquad ( Equation 68 )$$

$${R}_{2 , 2} = {p}_{A} {g}_{A} {g}_{A}^{H} + {σ}_{E , A}^{2} {I}_{{n}_{E}} \qquad ( Equation 69 )$$

$$with {g}_{1} = {p}_{A} {\vert {h}_{B , A} \vert}^{2} + {σ}_{B}^{2} . Then ,$$

$$\vert {R}_{y} \vert = \vert {R}_{1 , 1} \vert \cdot \vert {R}_{2 , 2} - {R}_{1 , 2}^{H} {R}_{1 , 1}^{- 1} {R}_{1 , 2} \vert = {g}_{1} {ϵ}_{E} \vert {p}_{A} {g}_{A} {g}_{A}^{H} + {σ}_{E , A}^{2} {I}_{{n}_{E}} - {p}_{A}^{2} {g}_{A} {\vert {h}_{B , A} \vert}^{2} {1}^{T} \frac{1}{{g}_{1} {ϵ}_{E}} [ \begin{matrix}{g}_{1} & - {g}_{1} \\ - {g}_{1} & {g}_{1} + {ϵ}_{E}\end{matrix} ] 1 {g}_{A}^{H} \vert = {g}_{1} {ϵ}_{E} \vert {g}_{2} {g}_{A} {g}_{A}^{H} + {σ}_{E , A}^{2} {1}_{{n}_{E}} \vert , \qquad ( Equation 70 )$$

$$with {g}_{2} = {p}_{A} - \frac{{\vert {h}_{B , A} \vert}^{2} {p}_{A}^{2}}{{g}_{1}} = \frac{{p}_{A} {σ}_{B}^{2}}{{g}_{1}} . Finally ,$$

$$\vert {R}_{y} \vert = {g}_{1} {ϵ}_{E} {σ}_{E , A}^{2 {n}_{E}} ( {g}_{2} {\vert {g}_{A} \vert}^{2} / {σ}_{E , A}^{2} + 1 ) \qquad ( Equation 71 )$$

Note that

$$h ( {Y}_{B} , {E}_{A} , {R}_{E} \vert S , {c}_{T} ) = ( {n}_{E} + 2 ) {m}_{A} log ( e π ) + E \{ log \vert {R}_{y} \vert \} \qquad ( Equation 72 )$$

Now combining the above results in Equation (61), subject to

$${ϵ}_{E} ≪ {σ}_{B}^{2} ,$$

yields

$$I ( {ℬ}_{1}^{′} ; {ℰ}_{1}^{′} \vert {c}_{T} ) = {m}_{A} 𝔼 \{ log ( {g}_{E} [ {p}_{A} {\vert {h}_{B , A} \vert}^{2} / {g}_{E} + {p}_{A} {‖ {g}_{A} ‖}^{2} / {σ}_{E , A}^{2} + 1 ] ) \} - {m}_{A} 𝔼 \{ log ( {ϵ}_{E} ( {g}_{2} {‖ {g}_{A} ‖}^{2} / {σ}_{E , A}^{2} + 1 ) ) \} . \qquad ( Equation 73 )$$

Here we notice the term −m_{A} log ϵ_{E} which would not converge if ϵ_{E}→0. But this term will “balance” out the term −m_{A} log ϵ_{A} in I( [symbol] ′; [symbol] ′).

3) Final form of

$${C}_{B}^{′} :$$

### For

$${ϵ}_{A} ≪ {σ}_{B}^{2} , {ϵ}_{B} ≪ {σ}_{B}^{2} , and \frac{{ϵ}_{E}}{{ϵ}_{A}} = ,$$

it is straightforward to verify from Equations (50), (51), (56) and (73) that

$${C}_{B}^{′} = I ( {𝒜}^{′} ; {ℬ}^{′} ) - I ( {ℬ}^{′} ; {ℰ}^{′} ) \geq {α}^{′} + {m}_{A} {ξ}_{B , A}^{′} + {m}_{A} log η , \qquad ( Equation 74 )$$

$$where$$

$${α}^{′} = 𝔼 \{ log ( \frac{{‖ {x}_{A} ‖}^{2} / ( {σ}_{s}^{2} + {σ}_{B}^{2} ) + \frac{1}{1 - {\vert ρ \vert}^{2}}}{{‖ {x}_{A} ‖}^{2} / ( {σ}_{s}^{2} + {σ}_{B}^{2} ) + 1} ) \} = 𝔼 \{ log ( 1 + \frac{{\vert ρ \vert}^{2}}{( 1 - {\vert ρ \vert}^{2} ) ( {‖ {x}_{A} ‖}^{2} / ( {σ}_{s}^{2} + {σ}_{B}^{2} ) + 1 )} ) \} \qquad ( Equation 75 )$$

$${ξ}_{B , A}^{′} = 𝔼 \{ log ( 1 + \frac{( {σ}_{s}^{2} / {σ}_{B}^{2} ) {ϕ}_{B , A}}{{ϕ}_{B , A} + {σ}_{s}^{2} / {σ}_{B}^{2} + 1} ) \} , \qquad ( Equation 76 )$$

and ϕ_{B,A} is defined in Equation (13). The proof of Theorem 2 is completed.

### Secret-Key Capacity Based on Pruned Set at Bob

A question regarding Theorem 2 is: how can

$${σ}_{s}^{2} \to$$

be the optimal choice? It is because the term h_{B,A}x_{A}(k) in h_{B,A}x_{A}(k)+s(k) (equivalently Y_{B} in S+Y_{B}) is still hidden from Eve when

$${σ}_{s}^{2} \to ?$$

To answer this question, we now restrict the data set to be used by Bob (after he has sent out R=S+Y_{B}) to be [symbol] ″={S, h_{B,A}} which is [symbol] ′ without Y_{B}. But Alice and Eve may still use respectively [symbol] ′={X_{A}, R_{A}, h_{A,B}} and [symbol] ′={E_{A}, R_{E}, g_{A}}.

Note that since m_{B}=0 and m_{A}>0 is chosen, then there is no E_{B}, and g_{B} is useless for Eve (subject to independence between {h_{A,B}, h_{B,A}} and {g_{A}, g_{B}}).

Thus,

$${C}_{B}^{″} = I ( {𝒜}^{′} ; {ℬ}^{″} ) - I ( {ℬ}^{″} ; {ℰ}^{′} ) .$$

$$Theorem 3 : For {ϵ}_{A} ≪ {σ}_{B}^{2} and {ϵ}_{E} ≪ {σ}_{B}^{2} ,$$

$${C}_{B}^{″} \geq {α}^{′} + {m}_{A} {ξ}_{B , A}^{′} \qquad ( Equation 77 )$$

where α′ and

$${ξ}_{B , A}^{′}$$

are the same as those is Theorem 2.

### Discussion of Theorem 3

Unlike

$${C}_{B}^{′} , {C}_{B}^{″}$$

is invariant to η subject to

$${ϵ}_{A} ≪ {σ}^{2} and {ϵ}_{E} ≪ {σ}_{B}^{2} .$$

Given the previous discussions of α′ and

$${ξ}_{B , A}^{′} ,$$

we have

$${C}_{B}^{″} \leq {C}_{B} = {C}_{key}$$

where the equality is approached if

$${σ}_{s}^{2}$$

is sufficiently large.

Once again, the optimal secret-key capacity is achieved by

$${σ}_{s}^{2} \to .$$

One explanation now is that although S under

$${σ}_{s}^{2} \to$$

is almost fully exposed to Eve over the return channel, Alice can always get a better estimate of S due to her knowledge of X_{A}. In the next section, we will provide such a comparison analytically.

Also note that, as discussed above, for a large m_{A}, α′ diminishes. In other words, as m_{A} increases, the secrecy contributed by the correlation between h_{A,B} and h_{B,A} becomes less and less significant.

### Proof of Theorem 3

1) Analysis of I( [symbol] ′; [symbol] ″): It is known

$$I ( {𝒜}^{′} ; {ℬ}^{″} ) = I ( {h}_{A , B} ; {ℬ}^{″} ) + I ( {𝒜}_{1}^{′} ; {ℬ}^{″} \vert {h}_{A , B} ) = I ( {h}_{A , B} ; {h}_{B , A} ) + I ( {h}_{A , B} ; S \vert {h}_{B , A} ) + I ( {𝒜}_{1}^{′} ; {h}_{B , A} \vert {h}_{A , B} ) + I ( {𝒜}_{1}^{′} ; S \vert {h}_{B , A} , {h}_{A , B} ) , \qquad ( Equation 78 )$$

where the first two terms are given by I(h_{A,B}; h_{B,A})=−log (1−|ρ|²) and I(h_{A,B}; S|h_{B,A})=0.

For the last two terms in Equation (78), recall r_{A}(k)=s(k)+h_{B,A}x_{A}(k)+w_{B}(k)+v_{A}(k), or equivalently,

$${r}_{A} = s + {h}_{B , {Ax}_{A}} + {w}_{B} + {v}_{A} ( k ) \qquad ( Equation 78 )$$

Then, the 3rd term in Equation (78) is

$$I ( {𝒜}_{1}^{′} ; {h}_{B , A} \vert {h}_{A , B} ) = I ( {R}_{A} ; {h}_{B , A} \vert {X}_{A} , {h}_{A , B} ) = h ( {R}_{A} \vert {X}_{A} , {h}_{A , B} ) - h ( {R}_{A} \vert {h}_{B , A} , {X}_{A} , {h}_{A , B} ) = 𝔼 \{ log \vert {R}_{1} \vert - log \vert {R}_{2} \vert \} = 𝔼 \{ log ( \frac{1 - {\vert ρ \vert}^{2}}{{σ}_{s}^{2} + {σ}_{B}^{2} + {ϵ}_{A}} {‖ {x}_{A} ‖}^{2} + 1 ) \} , \qquad ( Equation 80 )$$

where

$${R}_{1} = ( 1 - {\vert p \vert}^{2} ) {x}_{A {x}_{A}^{H}} + ( {σ}_{s}^{2} + {σ}_{B}^{2} + {ϵ}_{A} ) {I}_{{m}_{A}} , and {R}_{2} = ( {σ}_{s}^{2} + {σ}_{B A}^{2} + {ϵ}_{A} ) {I}_{{m}_{A}} .$$

The 4th term in Equation (78) is

$$\begin{matrix}I ( {𝒜}_{1}^{′} ; S \vert {h}_{B , A} , {h}_{A , B} ) = I ( {R}_{A} ; S \vert {X}_{A} , {h}_{B , A} , {h}_{A , B} ) \\ = h ( {R}_{A} \vert {X}_{A} , {h}_{T} ) - h ( {R}_{A} \vert S , {X}_{A} , {h}_{T} ) \\ = log [ ( {σ}_{s}^{2} + {σ}_{B}^{2} + {ϵ}_{A} ) {I}_{{m}_{A}} ] - \\ log [ ( {σ}_{B}^{2} + {ϵ}_{A} ) {I}_{{m}_{A}} ] \\ = {m}_{A} log ( 1 + \frac{{σ}_{s}^{2}}{{σ}_{B}^{2} + {ϵ}_{A}} ) .\end{matrix} \qquad ( Equation 81 )$$

Combining the above results in Equation (78) yields

$$\begin{matrix}I ( {𝒜}^{′} ; {ℬ}^{′′} ) = - log ( 1 - {\vert ρ \vert}^{2} ) + \\ 𝔼 \{ log ( \frac{1 - {\vert ρ \vert}^{2}}{{σ}_{s}^{2} + {σ}_{B}^{2} + {ϵ}_{A}} {‖ {x}_{A} ‖}^{2} + 1 ) \} + \\ {m}_{A} log ( 1 + \frac{{σ}_{s}^{2}}{{σ}_{B}^{2} + {ϵ}_{A}} ) \\ = 𝔼 \{ log ( \frac{{‖ {x}_{λ} ‖}^{2}}{{σ}_{s}^{2} + {σ}_{B}^{2} + {ϵ}_{A}} + \frac{1}{1 - {\vert ρ \vert}^{2}} ) \} + \\ {m}_{A} log ( 1 + \frac{{σ}_{s}^{2}}{{σ}_{B}^{2} + {ϵ}_{A}} ) .\end{matrix} \qquad ( Equation 82 )$$

2) Analysis of I( [symbol] ″; [symbol] ′): It follows that

$$\begin{matrix}I ( {ℬ}^{″} ; {ℰ}^{′} ) = I ( {h}_{B , A} ; {ℰ}^{′} ) + I ( S ; {ℰ}^{′} \vert {h}_{B , A} ) \\ = I ( {h}_{B , A} ; {ℰ}_{1}^{′} \vert {g}_{A} ) + I ( S ; {ℰ}_{1}^{′} \vert {h}_{B , A} , {g}_{A} ) .\end{matrix} \qquad ( Equation 83 )$$

where, as shown in Equation (56),

$$I ( {h}_{B , A} ; {ℰ}_{1}^{′} \vert {g}_{A} ) \leq E \{ log ( 1 + {\vert {x}_{A} \vert}^{2} / {g}_{E} ) \} .$$

Furthermore, the 2nd term in Equation (83) is

$$I ( S ; {ℰ}_{1}^{′} \vert {h}_{B , A} , {g}_{A} ) = h ( {E}_{A} , {R}_{E} \vert {h}_{B , A} , {g}_{A} ) - h ( {E}_{A} , {R}_{E} \vert S , {h}_{B , A} , {g}_{A} ) . \qquad ( Equation 84 )$$

Recall e_{A}(k)=g_{A}x_{A}(k)+w_{E,A} (k) and r_{E}(k)=s(k)+h_{B,A}x_{A}(k)+w_{B}(k)+v_{E}(k). Let

$${e}_{A}^{′} ( k ) = {[ {r}_{E} ( k ) , {e}_{A}^{T} ( k ) ]}^{T} = {g}_{A}^{′} {x}_{A} ( k ) {w}_{E , A}^{′} ( k ) \qquad ( Equation 85 )$$

where

$${g}_{A}^{′} = {[ {h}_{B , A} , {g}_{A}^{T} ]}^{T} , and {w}_{E , A}^{′} ( k ) = {[ s ( k ) + {w}_{B} ( k ) + {v}_{E} ( k ) , {w}_{E , A}^{T} ]}^{T} .$$

### Recall

$${g}_{E} = {σ}_{s}^{2} + {σ}_{B}^{2} + {ϵ}_{E} . Also let {g}_{E}^{′} = {σ}_{B}^{2} + {ϵ}_{E} .$$

It follows that

$$I ( S ; {ℰ}_{1}^{′} \vert {h}_{B , A} , {g}_{A} ) = {m}_{AE} \{ log \vert {R}_{1 , E} \vert - log \vert {R}_{2 , E} \vert \} with \qquad ( Equation 86 )$$

$$\begin{matrix}\vert {R}_{1 , E} \vert = \vert {p}_{A} {g}_{A}^{′} {g}_{A}^{′ H} + diag ( {g}_{E} , {σ}_{E , A}^{2} {I}_{{n}_{E}} ) \vert \\ {= {g}_{E} {σ}_{E , A}^{2 {n}_{E}} ( {p}_{A} \vert {h}_{B , A} \vert}^{2} / {g}_{E} + {p}_{A} {‖ {g}_{A} ‖}^{2} / {σ}_{E , A}^{2} + 1 ) .\end{matrix} \qquad ( Equation 87 )$$

$$\begin{matrix}\vert {R}_{2 , E} \vert = \vert {p}_{A} {g}_{A}^{′} {g}_{A}^{′ H} + diag ( {g}_{E}^{′} , {σ}_{E , A}^{2} {I}_{{n}_{E}} ) \vert \\ = {g}_{E}^{′} {σ}_{E , A}^{2 {n}_{E}} ( {p}_{A} {\vert {h}_{B , A} \vert}^{2} / {g}_{E}^{′} + {p}_{A} {‖ {g}_{A} ‖}^{2} / {σ}_{E , A}^{2} + 1 )\end{matrix} \qquad ( Equation 88 )$$

Hence, Equation (83) becomes

$$I ( {ℬ}^{′′} ; {ℰ}^{′} ) \leq 𝔼 \{ log ( 1 + {‖ {x}_{A} ‖}^{2} / {g}_{E} ) \} + {m}_{A} 𝔼 \{ log ( \frac{{g}_{E}}{{g}_{E}^{′}} \cdot \frac{{p}_{A} {\vert {h}_{B , A} \vert}^{2} / {g}_{E} + {p}_{A} {‖ {g}_{A} ‖}^{2} / {σ}_{E , A}^{2} + 1}{{p}_{A} {\vert {h}_{B , A} \vert}^{2} / {g}_{E}^{′} + {p}_{A} {‖ {g}_{A} ‖}^{2} / {σ}_{E , A}^{2} + 1} ) \} \qquad ( Equation 89 )$$

3) Final form of

$${C}_{B}^{′′} :$$

### Assume

$${σ}_{B}^{2} ≫ {ϵ}_{E} and {σ}_{B}^{2} ≫ {ϵ}_{A} .$$

Then, one can verify that

$${C}_{B}^{′′} = I ( {𝒜}^{′} ; {ℬ}^{′′} ) - I ( {ℬ}^{′′} ; {ℰ}^{′} ) \geq {α}^{′} + {m}_{A} {ℰ}_{B , A}^{′} , \qquad ( Equation 90 )$$

where

$${α}^{′} and {ξ}_{B , A}^{′}$$

are the same as in

$${C}_{B}^{′} .$$

The proof of Theorem 3 is completed.

### Optimal Estimation of S

In this section, we show that for a large m_{A}, the optimal estimation of S by Alice is always better than that by Eve even if h_{B,A} is known to Eve but unknown to Alice. Note that once Alice has a good estimate of S, both Alice and Bob can follow a standard procedure for SKG, i.e., quantization, reconciliation, and privacy amplification.

But in the next two sections we will show a new way of looking at the return signals from Bob, which allows the application of WTC based methods (over effective return channels from Bob to Alice and Eve) to achieve the optimal secrecy.

### Optimal Estimation of S at Alice

Recall that after Bob sends the return signal R=S+Y_{B} over a return channel, Alice has [symbol] ′={R_{A}, X_{A}, h_{A,B}}. Also we can write

$${r}_{A} ≐ {[ {r}_{A} ( 1 ) , … , {r}_{A} ( {m}_{A} ) ]}^{T} = s + {h}_{B , {Ax}_{A}} + {w}_{B} + {v}_{A} . \qquad ( Equation 91 )$$

Note that r_{A} conditional on h_{A,B} and x_{A} is Gaussian while the unconditional PDF of r_{A} is not.

Let

$$= {ρ}^{*} {h}_{A , B} and {r}_{A}^{′} = {r}_{A} - = s + Δ {h}_{B , {Ax}_{A}} + {w}_{B} + {v}_{A} .$$

### The PDF of

$${r}_{A}^{′} ,$$

conditioned on h_{A,B} and x_{A}, is

$$𝒞𝒩 ( 0 , {R}_{r}^{′} ) with {R}_{r}^{′} = ( 1 - {\vert ρ \vert}^{2} ) {x}_{{Ax}_{A}^{H}} + {g}_{{AI}_{{m}_{A}}} and {g}_{A} = {σ}_{s}^{2} + {σ}_{B}^{2} + {ϵ}_{A} .$$

The minimum-mean-squared-error (MMSE) estimate of s by Alice from {r_{A}, X_{A}, h_{A,B}} is

$$\begin{matrix}{\overline{s}}_{A} = 𝔼 \{ s \vert {r}_{A} , {x}_{A} , {h}_{A , B} \} \\ = 𝔼 \{ {{sr}_{A}^{′}}^{H} \vert {x}_{A} , {h}_{A , B} \} {( 𝔼 \{ {r}_{A}^{′} {{r}_{A}^{′}}^{H} \vert {x}_{A} , {h}_{A , B} \} )}^{- 1} {r}_{A}^{′}\end{matrix} . \qquad ( Equation 92 )$$

$$Here$$

$$𝔼 \{ {sr}_{A}^{H} \vert {x}_{A} , {h}_{A , B} \} = {σ}_{s}^{2} {I}_{{m}_{A}} , \qquad ( Equation 93 )$$

$$𝔼 \{ {r}_{A}^{′} {{r}_{A}^{′}}^{H} \vert {x}_{A} , {h}_{A , B} \} = ( 1 - {\vert ρ \vert}^{3} ) {x}_{A} {x}_{A}^{H} + {g}_{A} {I}_{{m}_{A}} \qquad ( Equation 94 )$$

$$and {g}_{A} = {σ}_{s}^{2} + {σ}_{B}^{2} + {ϵ}_{A} . Hence ,$$

$$\begin{matrix}{\hat{s}}_{A} = {{σ}_{s}^{2} ( ( 1 - {\vert ρ \vert}^{2} ) {x}_{A} {x}_{A}^{H} + {g}_{A} {I}_{{m}_{A}} )}^{- 1} {r}_{A}^{′} \\ = \frac{{σ}_{s}^{2}}{{g}_{A}} ( {I}_{{m}_{A}} - \frac{( 1 - {\vert ρ \vert}^{2} ) / {g}_{A}}{( 1 - {\vert ρ \vert}^{2} ) {‖ {x}_{A} ‖}^{2} / {g}_{A} + 1} {x}_{A} {x}_{A}^{H} ) {r}_{A}^{′}\end{matrix} . \qquad ( Equation 95 )$$

The covariance matrix of s conditional on {r_{A}, X_{A}, h_{A,B}} is the MSE matrix of ŝ conditional on {r_{A}, X_{A}, h_{A,B}}, which is

$$\begin{matrix}{R}_{Δ s , A \vert x} = {σ}_{s}^{2} {I}_{{m}_{A}} - {{σ}_{s}^{4} [ ( 1 - {\vert ρ \vert}^{2} ) {x}_{A} {x}_{A}^{H} + {g}_{A} {I}_{{m}_{A}} ]}^{- 1} \\ = {σ}_{s}^{2} ( ( 1 - {σ}_{s}^{2} / {g}_{A} ) {I}_{{m}_{A}} + \frac{\frac{{σ}_{s}^{3}}{{g}_{A}} \frac{( 1 - {\vert ρ \vert}^{2} )}{{g}_{A}}}{1 + \frac{1 - {\vert ρ \vert}^{2}}{{g}_{A}} {‖ {x}_{A} ‖}^{2}} {x}_{A} {x}_{A}^{H} )\end{matrix} \qquad ( Equation 96 )$$

Since the entries of x_{A} are i.i.d. [symbol] (0, p_{A}), we can write

$$\begin{matrix}𝔼 \{ {R}_{Δ s , A \vert x} \} = {σ}_{s}^{2} 𝔼 \{ ( 1 - {σ}_{s}^{2} / {g}_{A} ) \\ + \frac{\frac{{σ}_{s}^{3}}{{g}_{A}} \frac{( 1 - {\vert ρ \vert}^{2} )}{{g}_{A}}}{1 + \frac{1 - {\vert ρ \vert}^{2}}{{g}_{A}} {‖ {x}_{A} ‖}^{2}} \frac{{‖ {x}_{A} ‖}^{2}}{{m}_{A}} \} {I}_{{m}_{A}}\end{matrix} . \qquad ( Equation 97 )$$

$$If \frac{1 - {\vert ρ \vert}^{2}}{{g}_{A}} {\vert {x}_{A} \vert}^{2} ≫ 1 and {σ}_{B}^{2} ≫ {ϵ}_{A} ,$$

$$\begin{matrix}𝔼 \{ {R}_{Δ s , A \vert x} \} = {σ}_{s}^{2} ( ( 1 - {σ}_{s}^{2} / {g}_{A} ) + \frac{{σ}_{s}^{2} / {g}_{A}}{{m}_{A}} ) {I}_{{m}_{A}} \\ = {σ}_{s}^{2} ( \frac{1}{{σ}_{s}^{2} / {σ}_{B}^{2} + 1} + \frac{1}{{m}_{A}} \frac{{σ}_{s}^{2} / {σ}_{B}^{2}}{{σ}_{s}^{2} / {σ}_{B}^{2} + 1} ) {I}_{{m}_{A}}\end{matrix} . \qquad ( Equation 98 )$$

A large m, i.e.,

$${m}_{A} ≫ {σ}_{s}^{2} / {σ}_{B}$$

is seen,

$$𝔼 \{ {R}_{Δ s , A \vert x} \} = {\overline{r}}_{Δ s , A \vert x} {I}_{{m}_{A}} \qquad ( Equation 99 )$$

$$Where \overline{{r}_{Δ s , A \vert x = {σ}_{s}^{2} / ( {σ}_{s}^{2} / {σ}_{B}^{2} + 1 )}} .$$

### Optimal Estimation of S at Eve

Recall

$${ε}^{′} = \{ {E}_{A} , {R}_{E} , {g}_{A} \} . Also recall {e}_{A} ( k ) = {g}_{A} {x}_{A} ( k ) + {w}_{E , A} ( k ) \qquad ( Equation 101 )$$

and r_{E}(k)=s(k)+h_{B,A}x_{A}(k)+w_{B}(k)+v_{E}(k). Now we assume σ_B\hat{ }2>>ϵ_E, and write r_E(k)=s(k)+h_{B,A}x_A(k)+w_B(k). Equivalently, by stacking up all r_{E}(k) into a vector r_{E}, the following can be written

$${r}_{E} = s + {h}_{B , {Ax}_{A}} + {w}_{B} . \qquad ( Equation 101 )$$

The MMSE estimate of x_{A}(k) for all k from e_{A}(k) for all k by Eve is

$$\begin{matrix}( k ) = {{p}_{{{Ag}_{A}^{H}}_{}} ( {{p}_{Ag}}_{{{Ag}_{A}^{H}}_{}} + {σ}_{E , A}^{2 {I}_{{n}_{E}}} )}^{- 1 {e}_{A}} ( k ) \\ = {{p}_{A} ( {p}_{A} {\vert {g}_{A} \vert}^{2} + {σ}_{E , A}^{2} )}^{- 1 {g}_{A}^{{He}_{A}}} ( k )\end{matrix} \qquad ( Equation 102 )$$

$$and the MSE of ( k ) is$$

$$\begin{matrix}{r}_{Δ {x}_{A}} = {p}_{A} - {p}_{A}^{2} {{g}_{A}^{H} ( {p}_{A} {g}_{A} {g}_{A}^{H} + {σ}_{E , A}^{2} {I}_{{n}_{E}} )}^{- 1} {g}_{A} \\ = {p}_{A} - {{p}_{A}^{2} ( {p}_{A} {‖ {g}_{A} ‖}^{2} + {σ}_{E , A}^{2} )}^{- 1} {‖ {g}_{A} ‖}^{2} \\ = \frac{{p}_{A} {σ}_{E , A}^{2}}{{p}_{A} {‖ {g}_{A} ‖}^{2} + {σ}_{E , A}^{2}} \\ = \frac{{p}_{A}}{{p}_{A} {‖ {g}_{A} ‖}^{2} / {σ}_{E , A}^{2} + 1}\end{matrix} . \qquad ( Equation 103 )$$

Equivalently, the MMSE estimate of

$${x}_{A}^{T} = [ {x}_{A} ( 1 ) , … , {x}_{A} ( {m}_{A} ) ]$$

from E_{A}=[e_{A}(1), . . . , e_{A}(m_{A})] is

$${\hat{x}}_{A}^{T} = {{p}_{A} ( {p}_{A} {\vert {g}_{A} \vert}^{2} + {σ}_{E , A}^{2} )}^{- 1 {g}_{A}^{{HE}_{A}}} \qquad ( Equation 104 )$$

and the MSE matrix of \hat{x}_{A} is

$${R}_{Δ {x}_{A}} = {r}_{Δ {x}_{A} {I}_{{m}_{A}}} \qquad ( Equation 105 )$$

If Eve also knows h_{B,A}, the MMSE estimate of s from {r_{E}, E_{A}, g_{A}, h_{B,A}} by Eve is

$${\hat{s}}_{E} = {{σ}_{s}^{2} ( {σ}_{s}^{2} + {\vert {h}_{B , A} \vert}^{2} {r}_{Δ {x}_{A}} + {σ}_{B}^{2} )}^{- 1} ( {r}_{E} - {h}_{B , A {\hat{x}}_{A}} ) \qquad ( Equation 106 )$$

and the MSE matrix of ŝ_{E} is

$${R}_{Δ {s}_{E}} = {r}_{Δ s , {EI}_{{m}_{A}}} with \qquad ( Equation 107 )$$

$$\begin{matrix}{r}_{Δ s , E} = {σ}_{s}^{2} ( 1 - {{σ}_{s}^{2} ( {σ}_{s}^{2} + {\vert {h}_{B , A} \vert}^{2} {r}_{Δ {x}_{A}} + {σ}_{B}^{2} )}^{- 1} ) \\ = {σ}_{s}^{2} \frac{{\vert {h}_{B , A} \vert}^{2} {r}_{Δ {x}_{A}} + {σ}_{B}^{2}}{{σ}_{s}^{2} + {\vert {h}_{B , A} \vert}^{2} {r}_{Δ {x}_{A}} + {σ}_{B}^{2}} \\ = {σ}_{s}^{2} \frac{{r}_{Δ {x}_{A}} {\vert {h}_{B , A} \vert}^{2} / {σ}_{B}^{2} + 1}{{σ}_{s}^{2} / {σ}_{B}^{2} + {r}_{Δ {x}_{A}} {\vert {h}_{B , A} \vert}^{2} / {σ}_{B}^{2} + 1} \\ = {σ}_{s}^{2} \frac{\frac{{p}_{A} {\vert {h}_{B , A} \vert}^{2} / {σ}_{B}^{2}}{{p}_{A} {‖ g ‖}^{2} / {σ}_{E , A}^{2} + 1} + 1}{{σ}_{s}^{2} / {σ}_{B}^{2} + \frac{{p}_{A} {\vert {h}_{B , A} \vert}^{2} / {σ}_{B}^{2}}{{p}_{A} {‖ g ‖}^{2} / {σ}_{E , A}^{2} + 1} + 1} > \\ {σ}_{s}^{2} \frac{1}{{σ}_{s}^{2} / {σ}_{B}^{2} + 1} \\ = {\overline{r}}_{Δ s , A} .\end{matrix} \qquad ( Equation 108 )$$

Recall Equation (13). Then,

$${r}_{Δ s , E} = {σ}_{s}^{2} \frac{{ϕ}_{B , A} + 1}{{σ}_{s}^{2} / {σ}_{B}^{2} + {ϕ}_{B , A} + 1} , \qquad ( Equation 109 )$$

which increases with ϕ_{B,A}. It is clear that

$${ϕ}_{B , A} \leq \frac{{\vert {h}_{B , A} \vert}^{2} / {σ}_{B}^{2}}{{\vert g \vert}^{2} / {σ}_{E , A}^{2}} = \overline{{ϕ}_{B , A}} \qquad ( Equation 110 )$$

where the equality is approached if

$${p}_{A} {\vert g \vert}^{2} / {σ}_{E , A}^{2} ≫ 1.$$

The upper bound of ϕ_{B,A} is a ratio of the strength of users' probing channel over that of Eve's probing channel. If users' probing channel and Eve's probing channel have an identical and high SNR, i.e.,

$${p}_{A} {\vert {h}_{B , A} \vert}^{2} / {σ}_{B}^{2} = {p}_{A} {\vert g \vert}^{2} / {σ}_{E , A}^{2} ≫ 1 , then \overline{{ϕ}_{B , A}} = 1.$$

If Eve's probing channel has a low SNR, i.e.,

$${p}_{A} {\vert g \vert}^{2} / {σ}_{E , A}^{2} ≪ 1 , then {ϕ}_{B , A} = {p}_{A} {\vert {h}_{B , A} \vert}^{2} / {σ}_{B}^{2}$$

In this case, if the users' probing channel also has a low SNR, then

$${ϕ}_{B , A} = {p}_{A} {\vert {h}_{B , A} \vert}^{2} / {σ}_{B}^{2} ≪ 1$$

### Comparison of MSEs of Estimated S

Let

$${η}_{A , E} = \frac{\overline{{r}_{Δ s , A}}}{{r}_{Δ s , E}}$$

which is the ratio of the MSE of the estimated S at Alice over that at Eve subject to

$${m}_{A} ≫ {σ}_{s}^{2} / {σ}_{B}^{2 ∖}$$

and h_{B,A} being known to Eve but unknown to Alice. Then, it follows that

$${η}_{A , E} = \frac{{σ}_{s}^{2} / {σ}_{B}^{2} + {ϕ}_{B , A} + 1}{( {σ}_{s}^{2} / {σ}_{B}^{2} + 1 ) ( {ϕ}_{B , A} + 1 )} \qquad ( Equation 111 )$$

which is a decreasing function of

$${σ}_{s}^{2} .$$

### Furthermore,

$$\frac{1}{{ϕ}_{B , A} + 1} < {η}_{A , E} < 1 \qquad ( Equation 112 )$$

where the lower bound is approached if

$${σ}_{s}^{2} / {σ}_{B}^{2} ≫ {ϕ}_{B , A} + 1 ,$$

and the upper bound (which is undesirable) is approached if

$${σ}_{s}^{2} \to$$

0 during probing is either weaker or stronger than that for Bob.

Thus, the optimal estimation of S by Alice is always better than that by Eve, and the gap is maximized (i.e., η_{A,E} is minimized) when

$${σ}_{s}^{2} \to .$$

Example 1: If

$${p}_{A} {\vert {h}_{B , A} \vert}^{2} / {σ}_{B}^{2} = {p}_{A} {\vert g \vert}^{2} / {σ}_{E , A}^{2} ≫ 1 ,$$

then ϕ_{B,A}=1. If in addition

$${σ}_{s}^{2} / {σ}_{B}^{2} ≫ 2 , then {η}_{A , E} = \frac{1}{2} .$$

Example 2: If

$${p}_{A} {\vert {h}_{B , A} \vert}^{2} / {σ}_{B}^{2} = \frac{1}{2} {p}_{A} {\vert g \vert}^{2} / {σ}_{E , A}^{2} ≫ 1 , then {ϕ}_{B , A} = \frac{1}{2} .$$

If in addition

$${σ}_{s}^{2} / {σ}_{B}^{2} ≫ 1.5 , then {η}_{A , E} = \frac{2}{3} .$$

In both examples,

$$\frac{\text{?}}{{σ}_{s}^{2}} = ( 1 - {σ}_{s}^{2} / {g}_{A} ) = \frac{σ \text{?}}{σ \text{?}} .$$

$$\text{?} \text{indicates text missing or illegible when filed}$$

### STEEP for Analog Channels

Now, the previous insights are combined to formulate a scheme “secret-message transmission by echoing encrypted probes (STEEP)” for analog probing and return channels. A potential application of STEEP is illustrated in FIG. 1 where Eve's channel 20 during probing 60 is allowed to be stronger than Bob's channel 10.

With reference to FIG. 1, a flow diagram illustrates one embodiment of a potential application of STEEP where the channel strength for Eve.

Recall that after channel probing, Bob 30 and Eve 40 receive respectively

$${y}_{B} ( k ) = {h}_{B , A} {x}_{A} ( k ) + {w}_{B} ( k ) \qquad ( Equation 113 )$$

$${e}_{A} ( k ) = {g}_{A} {x}_{A} ( k ) + {W}_{E , A} ( k ) \qquad ( Equation 114 )$$

with k=1, . . . , m_{A}.

Now assumed is that Bob 30 has sent the complete information of h_{B,A} to Alice 50 (via feedback) so that h_{B,A} is known to both Alice and Eve. But g_{A} is only known to Eve.

Then Bob sends out r (k)=y_{B}(k)+s(k) over return channels so that Alice and Eve receive respectively

$${y}_{A , B} ( k ) = r ( k ) + {v}_{A} ( k ) = s ( k ) + {h}_{B , A} {x}_{A} ( k ) + {w}_{B} ( k ) + {v}_{A} ( k ) \qquad ( Equation 115 )$$

$${y}_{E , B} ( k ) = r ( k ) + {v}_{E} ( k ) = s ( k ) + {h}_{B , A} {x}_{A} ( k ) + {w}_{B} ( k ) + {v}_{E} ( k ) \qquad ( Equation 116 )$$

Assumed is that

$${σ}_{B}^{2} ≫ {ϵ}_{A} and {σ}_{B}^{2} ≫ {ϵ}_{E} ,$$

So that v_{A}(K) and v_{E}(k) in the above can be dropped.
Effective Return Channel from Bob to Alice

The MMSE estimate of s(k) from {x_{A}(k), y_{A,B}(k), h_{B,A}, ∀k} can be written as

$$( k ) = E \{ s ( k ) \vert {x}_{A} ( k ) , {y}_{A , B} ( k ) , {h}_{B , A} \} = E \{ s ( k ) \vert {t}_{A} ( k ) \} \qquad ( Equation 117 )$$

where

$${t}_{A} ( k ) ≐ {y}_{A , B} ( k ) - {h}_{B , A} {x}_{A} ( k ) = s ( k ) + {w}_{B} ( k ) + {v}_{A} ( k ) \qquad ( Equation 118 )$$

Here tᵣ(k) is the sufficient statistics at Alice for s(k). The expression of Equation 118 is an effective return channel from Bob to Alice, which is an additive white Gaussian noise (AWGN) channel. The SNR of this channel

$$( for {σ}_{B}^{2} ≫ {ϵ}_{A} )$$

is

$$S N {R}_{A \vert B} = \frac{{σ}_{s}^{2}}{{σ}_{B}^{2}} \qquad ( Equation 119 )$$

Effective Return Channel from Bob to Eve

The MMSE estimate of s(k) from {e_{A} (k), y_{E,B} (k), h_{B,A}, g_{A}, ∀k} is

$${s}_{E} ( k ) = E \{ s ( k ) \vert {e}_{A} ( k ) , {y}_{E , B} ( k ) , {h}_{B , A} , {g}_{A} , ∀ k \} = E \{ s ( k ) \vert {t}_{E} ( k ) \} \qquad ( Equation 120 )$$

$$where$$

$${t}_{E} ( k ) ≐ {y}_{E , B} ( k ) - {h}_{B , A} ( k ) = s ( k ) + {h}_{B , A} Δ {x}_{A} ( k ) + {w}_{B} ( k ) + {v}_{E} ( k ) \qquad ( Equation 121 )$$

Here x_{A}(k) is the MMSE estimate of x_{A}(k) from {e_{A}(k), g_{A}, ∀k}, and Δx_{A}(k)=x_{A}(k)− [symbol] (k) is the MMSE estimation error of x_{A}(k). Specifically, the MSE of Δx_{A}(k) is given by r_{Δx}_{_{A}} in Equation (103).

Equation (121) represents an effective (AWGN) return channel from Bob to Eve where the channel SNR

$$( for {σ}_{B}^{2} ≫ {ϵ}_{E} )$$

is

$${SNR}_{E \vert B} = \frac{{σ}_{s}^{2}}{{\vert {h}_{B , A} \vert}^{2} {r}_{Δ {x}_{A}} + {σ}_{B}^{2}} = \frac{{σ}_{s}^{2} / {σ}_{B}^{2}}{{ϕ}_{B , A} + 1} < {SNR}_{A \vert B} \qquad ( Equation 122 )$$

where ϕ_{B,A} is given in Equation 13. We also see that SNR_{E|B} is a decreasing function of p_{A}. If

$${p}_{A} {\vert {g}_{A} \vert}^{2} / {σ}_{E , A}^{2} ≫ 1 and {\vert {h}_{B , A} \vert}^{2} / {σ}_{B}^{2} = {\vert {g}_{A} \vert}^{2} / {σ}_{E , A}^{2} , then {SNR}_{E \vert B} = \frac{1}{2} {SNR}_{A \vert B}$$

Also note that w_{B}(k) is a common noise component in both the legitimate return channel and Eve's return channel. But this feature does not change the achievable secrecy rate [symbol] (in bits per sample) of the WTC from Bob to Alice and Eve. This is because

$$= I ( s ( k ) ; {t}_{A} ( k ) ) - I ( s ( k ) ; {t}_{E} ( k ) ) \qquad ( Equation 123 )$$

It can be seen that whether a noise component in t_{A} (k) is shared in t_{E} (k) does not matter since I(s(k); t_{A}(k)) and I(s(k); t_{E} (k)) are computed separately. It follows that

$$\begin{matrix}= log ( 1 + {SNR}_{A \vert B} ) - log ( 1 - {SNR}_{E \vert B} ) \\ = log \frac{1 + {σ}_{s}^{2} / {σ}_{B}^{2}}{1 + \frac{{σ}_{s}^{2} / {σ}_{B}^{2}}{{σ}_{B , A} + 1}} \\ = log ( 1 + \frac{{ϕ}_{B , A} {σ}_{s}^{2} / {σ}_{B}^{2}}{{σ}_{s}^{2} / {σ}_{B}^{2} + 1 + {ϕ}_{B , A}} ) \\ \leq log ( 1 + {ϕ}_{B , A} ) ,\end{matrix} \qquad ( Equation 124 )$$

where the upper bound is approached if

$${σ}_{s}^{2} / {σ}_{B}^{2} ≫ 1 + {ϕ}_{B , A} .$$

Also note that the expectation of [symbol] over the distributions of the probing channels equals to

$${ξ}_{B , A}^{′}$$

shown in Equation (38).

Hence for a large σₛ²,

$$E \{ = E \{ log ( 1 + {ϕ}_{B , A} ) \} \qquad ( Equation 125 )$$

which is also the upper bound of the secret-key capacity from the original data sets immediately following the channel probing.

It is clear that ϕ_{B,A} in Equations (125) and (13) is

$$\frac{{SNR}_{B , A}}{1 + {SNR}_{E , A}}$$

shown in Equation (2) where

$${SNR}_{B , A} = {p}_{A} {\vert {h}_{B A} \vert}^{2} / {σ}_{B}^{2} {SNR}_{E , A} = {p}_{A} {\vert {g}_{A} \vert}^{2} / {σ}_{E , A}^{2} .$$

### a Remark on Implementation

It is seen that Equations (118) and (121) represent an effective AWGN WTC model from Bob to Alice where the effective eavesdropping channel from Bob to Eve is always weaker than the effective main channel from Bob to Alice. A best way to utilize this model for a finite m_{A} is perhaps what is shown in W. Yang, R. F. Schaefer, and H. V. Poor, “Wiretap channels: nonasymptotic fundamental limits,” IEEE Trans. Information Theory, Vol. 65, No. 7, pp. 4069-493 July 2019, which transmits a secret (at a rate close to [symbol] ) directly from Bob to Alice over the effective WTC model.

Alternatively, one can use a channel coding method that allows a reliable transmission of S from Bob to Alice at a rate (in bits per sample of s(k)) close to log (1+SNR_{A|B}). After this transmission is completed, Alice and Bob will apply a hash function to compress S to a key of size no larger than m_{A} [symbol] bits per realization of X_A. Here [symbol] is a known (positive) lower bound of [symbol] . The last step of using a hash function is also known as privacy amplification.

The classic channel coding methods are available in S. Lin and D. J. Costello, Error Control Coding, Pearson Prentice Hall, 2004. A latest development of channel coding is shown in K. R. Duffy and M. Medard, “Guessing random additive noise decoding with soft detection symbol reliability information—SGRAND,” 57^{th} Annual Conference on Information Sciences and Systems, Baltimore, MD, March 2023. For hash functions, see D. R. Stinson, “Universal hashing and authentication codes,” Designs, Codes and Cryptography, 4, 369-380 (1994).

Both of the above approaches are asymptotically optimal (i.e., as the packet length increases). But for finite-length packets, the second approach may have a drawback. Namely, if the transmission rate over the effective return channel is not close enough to log (1+SNR_{A|B}) and falls below log (1+SNR_{A|B}), the secrecy could be compromised (as Eve could have a more powerful decoder than Alice).

### Power Consumption

Using STEEP over analog channels, the return signal sent by Bob is r(k)=y_B(k)+s(k) which consumes the power equal to (strictly speaking proportional to)

$${p}_{r} \dot{=} {\vert {h}_{B , A} \vert}^{2} {p}_{A} + {σ}_{B}^{2} + {σ}_{s}^{2} = {σ}_{B}^{2} ( {σ}_{s}^{2} / {σ}_{B}^{2} + {\vert {h}_{B , A} \vert}^{2} {p}_{A} / {σ}_{B}^{2} + 1 ) .$$

In order for [symbol] to be close to its upper bound (see Equation (124)), we need

$${σ}_{s}^{2} / {σ}_{B}^{2} ≫ 1 + {ϕ}_{B , A} , i . e . , {σ}_{s}^{2} / {σ}_{B}^{2} ≫ 1 + \frac{{p}_{A} {\vert {h}_{B , A} \vert}^{2} / {σ}_{B}^{2}}{{p}_{A} {\vert {g}_{A} \vert}^{2} / {σ}_{E , A}^{2} + 1} ,$$

which becomes invariant to p_{A} if

$${p}_{A} {\vert {g}_{A} \vert}^{2} / {σ}_{E , A}^{2} ≫ 1$$

(i.e., Eve's probing channel has a high SNR). Subject to the above (mild) condition, we have

$${p}_{r} = {\vert {h}_{B , A} \vert}^{2} {p}_{A} + {σ}_{s}^{2}$$

where both terms (after a required power amplification) must be much larger than the power of the noise in the return channel from Bob to Alice. Also, both h_{B,A}x_{A}(k) and s(k) insider(k) are important signal components to be received by Alice. Hence, a reasonable choice of

$${σ}_{s}^{2}$$

is such that

$${\vert {h}_{B , A} \vert}^{2} {p}_{A} = {σ}_{s}^{2}$$

and then

$${p}_{r} = 2 {σ}_{s}^{2}$$

(i.e., 3 dB beyond

$${σ}_{s}^{2} ) .$$

The power consumption is primarily an issue at the physical layer. If the probing channels and return channels are at the link layer or above, then all symbols are digital. As shown next, the extra 3 dB power consumption is no longer necessary.

### STEEP for Digital Channels

The previous discussions are all focused on analog probing and return channels. However the same principle of STEEP applies to digital probing and return channels as well.

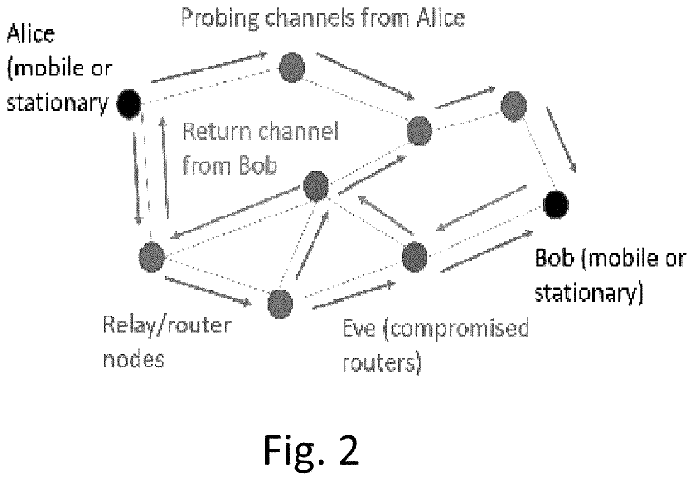

With reference to FIG. 2 a diagrammatic potential application of STEEP in multihop digital networks is shown.

It is assumed that every channel is digital. A digital channel between two nodes in a network could be of one or multiple hops. Also a channel probing session can be generalized to include multiple locations of mobile Alice and/or Bob and/or Eve in the network so that different networking routes may be explicitly or implicitly used during the probing session. See FIG. 2. At the network layer, a packet is often either received or lost. If it is received, then all bits in the packet are known to the receiver and transmitter. If it is lost, then each bit in the transmitted packet has an error rate at ½. After a channel probing session is completed, Alice and Bob can apply a common function to randomize the ordering of all received as well as lost bits. Then each bit in the entire sequence of bits has an effective bit error rate less (usually much less) than ½. We assume that Eve and Bob apply the same process to reorder their bits.

Note that in this paper we assume that Alice and Bob can authenticate the data received from each other, and Eve is unable to destroy the data authentication process. In applications, authentication itself may require a secret key between two parties. In this case, the use of STEEP can help to refresh and/or generate new secret keys while a pre-existing secret key is used for current authentication purpose (before it expires or becomes exposed).

It can now be assumed that for every bit b_{A} (k) transmitted by Alice (which is an i.i.d. binary symmetric sequence only known to Alice), Bob and Eve receive respectively

$${b}_{B , A} ( k ) = {b}_{A} ( k ) ⊕ {W}_{B , A} ( k ) \qquad ( Equation 126 )$$

$${b}_{E , A} ( k ) = {b}_{A} ( k ) ⊕ {W}_{E , A} ( k ) \qquad ( Equation 127 )$$

Here, all quantities are binary, ⊕ is Exclusive-OR, and k=1, . . . , m_{A} is the current index/position of a bit. The bit error rate of the probing channel from Alice to Bob is P_{B,A}=Prob(b_{B,A} (k)≠b_{A} (k))=Prob (w_{B,A} (k)=1), and that from Alice to Eve is P_{E,A}=Prob (b_{E,A} (k)≠b_{A} (k))=Prob (w_{E,A}=1). For STEEP to have a positive secrecy that increases with m_{A}, we will need P_{E,A}>0.

We will drop the index k for simpler notations. Then, over a return channel to Alice (and another return channel to Eve), Bob sends bᵣ=bₛ ⊕b_{B,A} (for all k) where bₛ is an i.i.d. binary symmetric sequence only known to Bob. Hence, Alice and Eve receive

$${b}_{A , B} = {b}_{r} ⊕ {w}_{A , B} = {b}_{s} ⊕ {b}_{B , A} ⊕ {w}_{A , B} = {b}_{s} ⊕ {b}_{A} ⊕ {w}_{B , A} ⊕ {w}_{A , B} \qquad ( Equation 128 )$$

$${b}_{E , B} = {b}_{r} ⊕ {w}_{E , B} = {b}_{s} ⊕ {b}_{B , A} ⊕ {w}_{E , B} = {b}_{s} ⊕ {b}_{A} ⊕ {w}_{B , A} ⊕ {w}_{E , B} \qquad ( Equation 129 )$$

where the return channel error rate for Alice is P_{A,B}=Prob {w_{A,B}=1}, and that for Eve is P_{E,B}=Prob {w_{E,B}=1}.

Note that Alice can compute

$$\overline{{b}_{A , B}} \dot{=} {b}_{A , B} ⊕ {b}_{A} = {b}_{s} ⊕ {w}_{B , A} ⊕ {w}_{A , B} \qquad ( Equation 130 )$$

and Eve can compute

$$\overline{{b}_{E , B}} \dot{=} {b}_{E , B} ⊕ {b}_{E , A} = {b}_{s} ⊕ {w}_{E , A} ⊕ {w}_{B , A} ⊕ {w}_{E , B} \qquad ( Equation 131 )$$

Assume that the return channels from Bob to Alice and Eve are much less noisy than the probing channel from Alice to Bob, i.e., P_{A,B}<<P_{B,A}<½ and P_{E,B}<<P_{B,A}<½. Then it follows that the effective error rate at Alice about bₛ is

$${P}_{A \vert B \dot{=} Prob ( \overline{{b}_{A , B}} \neq {b}_{s} ) = {P}_{B , A}} \qquad ( Equation 132 )$$

and that at Eve about bₛ is

$$( Equation 133 )$$

$${P}_{E \vert B \dot{=} Prob ( \overline{{b}_{E , B}} \neq {b}_{s} ) = 1 - {P}_{B , A} {P}_{E , A} - ( 1 - {P}_{B , A} ) ( 1 - {P}_{E , A} ) = {P}_{B , A} + {P}_{E , A} ( 1 - 2 {P}_{B , A} ) > {P}_{A \vert B}} .$$

The effective return channel for Alice (represented by Equation (130)) is stronger than that for Eve (represented by Equation (131)). The secrecy capacity (in bits per return sample) of the effective WTC model is

$$\begin{matrix}ξ \dot{=} I ( {b}_{s} ; {\overline{b}}_{A , B} ) - I ( {b}_{s} ; {\overline{b}}_{E , B} ) \\ = H ( {\overline{b}}_{E , B} \vert {b}_{s} ) - H ( {\overline{b}}_{A , B} \vert {b}_{s} ) \\ = f ( {P}_{E \vert B} ) - f ( {P}_{A \vert B} ) ,\end{matrix} \qquad ( Equation 134 )$$

with f(p)=−p log p−(1−p) log (1−p). Here we have used

$$H ( \overline{{b}_{A , B}} ) = H ( \overline{{b}_{E , B}} ) = 1.$$

The (binary) uniform distribution of bₛ makes each of

$$\overline{{b}_{A , B}} and \overline{{b}_{E , B}}$$

(binary) uniformly distributed. It is clear that subject to P_{E|B}<½, we have ξ>0 because of P_{E|B}>P_{A|B}.

There is no loss of secrecy in the above WTC based treatment of the return channels.

After the channel probing from Alice to Bob, the data sets at Alice, Bob and Eve are [symbol] ={b_{A}(k), ∀k}, [symbol] ={b_{B} (k), ∀k}, and [symbol] ={b_{E,A} (k), ∀k}. Then according to MAC's bounds in Equation (1), the secret-key capacity in bits per sample is lower bounded by

$$\begin{matrix}{ξ}_{L} \dot{=} \frac{1}{{m}_{A}} {C}_{B} = I ( {b}_{A} ; {b}_{B} ) - I ( {b}_{B} ; {b}_{E , A} ) \\ = H ( {b}_{E , A} \vert {b}_{B} ) - H ( {b}_{B} \vert {b}_{A} ) \\ = f ( {P}_{E \vert B} ) - f ( {P}_{A \vert B} ) ,\end{matrix} \qquad ( Equation 135 )$$

where it was used: H(b_{E,A})=H (b_{B})=1. The justification of H (b_{E,A}|b_{B})=f (P_{E|B}) is that b_{E,A}=b_{A} ⊕w_{E,A}=b_{B} ⊕w_{B,A} ⊕w_{E,A}. Here Prob (b_{E,A}≠b_{B})=Prob (w_{B,A} ⊕w_{E,A}=1)=P_{E|B}.

Also according to MAC's bounds, the secret-key capacity in bits per sample is upper bound by

$${ξ}_{U} \dot{=} \frac{1}{{m}_{A}} {C}_{E} = I ( {b}_{A} ; {b}_{B} \vert {b}_{E , A} ) = H ( {b}_{B} \vert {b}_{E , A} ) - H ( {b}_{B} \vert {b}_{A} , {b}_{E , A} ) \qquad ( Equation 136 )$$

Here H (b_{B}|b_{E,A})=H (_{E,A}|b_{B})+H (b_{B})−H (b_{E,A})=H (b_{E,A}|b_{B})=f(P_{E|B}). For H(b_{B}|b_{A}, b_{E,A}), recall b_{B}=b_{A} ⊕w_{B,A} and b_{E,A}=b_{A} ⊕w_{E,A}, i.e., b_{E,A} is independent of b_{B} when conditioned by b_{A}. Hence, H(b_{B}|b_{A},b_{E,A})=H (b_{B}|b_{A})=f(P_{A|B}). So

$${ξ}_{U} = f ( {P}_{E \vert B} ) - f ( {P}_{A \vert B} ) \qquad ( Equation 137 )$$

Hence, ξ_{U}=ξ_{L}=. Namely, after the channel probing from Alice to Bob, the WTC treatment of the equivalent return channel from Bob to Alice is optimal.

Unlike the case of using analog channels, using digital channels does not cause additional power consumption to establish an effective WTC model such that the effective main channel is guaranteed to be stronger than the effective eavesdropping channel.

Note that for digital channels, Equation (2) should be replaced by ξ_{STEEP,DC}=ξ=f(P_{E|B})−f(P_{A|B}).

### a Remark on Implementation

The effective WTC model is discrete and memoryless, for which the method in Equation (2) is directly applicable to securely transmit a secret (at a rate close to ξ) from Bob to Alice.

However, one can also use a channel coding method to reliably transmit {bₛ(k), ∀k} (at a rate close to I(bₛ; b_{A,B})=1−f(P_{A|B})) over the effective return channel from Bob to Alice. After this transmission is completed, both Alice and Bob apply a hash function to compress the information in {bₛ(k), ∀k} to a key of a size no larger than ξ.

Similar to an earlier comment, the second approach can not guarantee the secrecy if the actual transmission rate from Bob to Alice falls below I(bₛ; b_{E,B})=1−f(P_{E|B}).

In conclusion, as a further development from the prior work, the above description has focused on SISO probing channels between users, and presented important new insights into MAC's bounds. These insights have led to the formulation of STEEP, which has attractive properties for real-world applications. Provided that Eve is unable to receive the exact probes sent by Alice during channel probing, STEEP guarantees a positive secrecy rate (in bits per sample) via any high-quality return channel. This is the case even if the probing channel state information of the users is public. STEEP is applicable to all layers of networks, and it is built on a foundation supported by MAC's bounds for SKG, and the established methods and theory for.

### Unification of Secret Key Generation and Wiretap Channel Transmission

This section presents further embodiments. A legitimate wireless channel between a multi-antenna user (Alice) and a single-antenna user (Bob) in the presence of a multi-antenna eavesdropper (Eve) is focused on. STEEP does not require full-duplex, channel reciprocity or Eve's channel state information, but is able to yield a positive secrecy rate in bits per channel use between Alice and Bob in every channel coherence period as long as Eve's receive channel is not noiseless. This secrecy rate does not diminish as coherence time increases. Various statistical behaviors of STEEP's secrecy capacity due to random channel fading are also illustrated.

Establishing a secret key between two (or more) nodes in a network is crucial for wide ranges of security applications, including authenticity, confidentiality and integrity for subsequent communications between the nodes. Secret keys are also important for security in artificial intelligence and machine learning. A crucial key-generation tool heavily relied upon by our Internet-based society is known as public key infrastructure (PKI), which is based on pair of public and private (asymmetric) keys generated by each node, and which is known to be not information-theoretically (IT). It remains possible that advanced computing algorithms and/or devices developed in the future could be capable of destroying PKI. It is therefore important for us as researchers to develop IT-secure methods for key generations and distributions.

To be able to transmit a secret (including secret key, secret message or secret information) from Alice to Bob in the presence of an eavesdropper (Eve) in any channel coherence period, the prior art wiretap channel theory requires that the main channel (i.e., from Alice to Bob) is stronger than Eve's channel (i.e., from Alice to Eve). For wireless fading channels, one can take the advantage of the situations where the main channel may become stronger than Eve's channel in some random time intervals. However, the main channel is never stronger than Eve's channel in any coherence period, then none of the prior schemes based on wiretap channel model yields a positive secrecy rate.

To be able to generate a secret key between Alice and Bob regardless of the strength of Eve's channel, many efforts have been made by researchers to exploit the reciprocal nature of (some) wireless. But the secret-key capacity based on reciprocal channels is limited by channel coherence time. In other words, the secret-key capacity is inversely proportional to the channel coherence time. In most practical situations such as applications in Internet-of-Things where the coherence time is relatively long, the secret-key capacity based on reciprocal channels is very limited.

The limitation from reciprocal channels has driven researchers to explore alternative approaches. For example, proposed is the use of random pilots of a long length to probe a reciprocal channel with the hope that their approaches would yield a secret-key rate not limited by the channel coherence time. Those proposals motivated the recent contributions where the lower and upper bounds on secret-key capacity established by Maurer, Ahlswede and Csiszar (MAC) in U. Maurer, “Secret key agreement by public discussion from common information,” IEEE Trans. Information Theory, Vol. 39, No. 3, pp. 733-742, May 1993. and R. Ahlswede and I. Csiszar, “Common randomness in information theory and cryptography, Part I: secret sharing,” IEEE Trans. Information Theory, Vol. 39, pp. 1121-1132 July 1993 are applied to the data sets collected from MIMO channels driven by random probes. The secure degree of freedom (i.e., degree of freedom of secret-key capacity) of prior approaches is no different from the prior approaches based on reciprocal channel responses. Furthermore, if and only if Alice or Bob has more antennas than Eve, the secure degree of freedom (in bits per probing sample interval per doubling of power) is positive.

If Alice and Bob each have a single antenna, then their secure degree of freedom against Eve (with one or more antennas) relative to transmitted power is zero. This result however does not provide the complete picture of the secret-key capacity achievable from a SISO channel against Eve. More recently, it is shown that the secret-key capacity (in bits per probing sample) based on the data sets from a SISO (non-reciprocal) channel driven by random probes is

$${C}_{key} = \text{?} \{ log ( 1 + \frac{{SNR}_{\text{?}}}{1 + {SNR}_{\text{?}}} ) \} \qquad ( Equation 138 )$$

$$\text{?} \text{indicates text missing or illegible when filed}$$

where SNRₘ is the signal-to-noise ratio (SNR) at the receiver of the SISO main channel during channel probing, and SNRₑ is the corresponding SNR at (multi-antenna) Eve. This capacity is always positive provided that SNRₘ>0 and SNRₑ<∞.

Furthermore, a subsequent transmission scheme assisted by the data sets collected from channel probing allows the application of any established wiretap channel transmission scheme to achieve secrecy.

In this embodiment, further insights into STEEP are shown with focus on a wireless network consisting of multi-antenna Alice, single-antenna Bob and multi-antenna Eve. In addition to analytical insights, this paper also shows useful observations from computer simulations. It is further demonstrated that STEEP is capable to yield a positive secrecy rate within each channel coherence period even if Eve's receive channel is stronger at all times than the main/legitimate channel. This property of STEEP is not available from any prior wiretap-channel schemes or reciprocal-channel based schemes. The impact of random channel fading on the performance of STEEP is also shown with comparison to a conventional half-duplex two-way scheme subject to the same power allocations.

### The Principle of STEEP

As described above, the principle of STEEP consists of two phases of interdependent operations: phases 1 and 2.

In phase 1, a node (Alice) sends random probing symbols (also called probes) over a probing channel to another node (Bob). In this phase, Bob obtains some estimates of the probes, which could be noisy. While the estimates of the probes by Eve cannot be noiseless, they are allowed to be less noisy than those by Bob.

In phase 2, Bob echoes back his estimated probes encrypted by a secret message meant for Alice via a return channel. Since Alice knows the exact probes, the effective wiretap channel system from Bob to Alice and Eve, relative to the secret message from Bob, is such that the effective return channel from Bob to Alice is stronger than that from Bob to Eve subject to a sufficient amount of power from Bob.

For a SISO probing channel and a high-quality return channel, the secrecy capacity of STEEP is given by Equation (138). Next, we consider an application of STEEP to a MISO wireless channel between Alice and Bob.

### Application of STEEP to MISO Wireless Channel

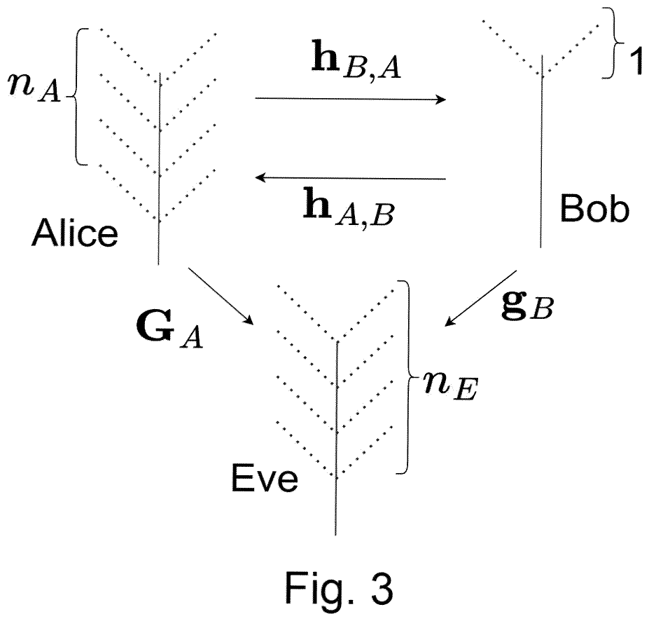

A MISO wireless channel is very common between a base station (or access point) and a mobile node (or user equipment), which is illustrated in FIG. 3. The downlink (from Alice to Bob) is treated as the probing channel, and the uplink (from Bob to Alice) as the return channel. We will assume that the channel responses between Alice and Bob are known to both of them, and all channel responses in the network are known to Eve.

It is important to note that the channel probing should always be applied from the node with more antennas to the node with less antennas. In this way, the highest secure degree of freedom is achieved. Specifically, if (independent and identically distributed or i.i.d.) random probing symbols are transmitted from Alice with n_{A} antennas to Bob with n_{B} antennas over m_{A}≥n_{A} probing sample intervals, and also another set of random probing symbols are transmitted from Bob to Alice over additional m_{B}≥n_{B} probing sample intervals, then the secure degree of freedom of the secret-key capacity (in bits per probing sample interval) based on the data sets collected from the channel probing is

$$SDoF = \frac{1}{{m}_{A} + {m}_{B}} \{ min ( {n}_{B} , {( {n}_{A} - {n}_{E} )}^{\text{?}} ) ( {m}_{A} - {n}_{A} ) + min ( {n}_{A} , {( {n}_{B} - {n}_{\text{?}} )}^{\text{?}} ) ( {m}_{B} - {n}_{B} ) + {n}_{A} {n}_{B} δ \} \qquad ( Equation 139 )$$

$$\text{?} \text{indicates text missing or illegible when filed}$$

where n_{E} is the number of antennas on Eve, (x)⁺=max (0, x), δ=1 if the channel is perfectly reciprocal, and δ=0 if there is no perfectly reciprocal channel response parameter.

The above SDoF does not change if the probes from Alice during n_{A} probing sample intervals are public and the probes from Bob during n_{B} probing sample intervals are public.

So, if m_{A}+m_{B} is fixed and n_{A}>n_{B}, then the SDoF is maximized by maximizing m_{A} and minimizing m_{B} (i.e., choosing m_{B}=n_{B}), which is equivalent to one-way random channel probing from Alice to Bob. In the sequel, we use n_{B}=1.

In phase 1 of STEEP, Alice sends random probes, denoted by the matrix \sqrt{P_{A}/n_{A}X_{A}}ϵCⁿ^{_{A}}^{×m} with X_{A}=[x_{A} (1), . . . , x_{A}(m)]. Here m is the total number of random probing sample intervals, and all entries in X_{A} are i.i.d. (complex circular Gaussian) CN(0,1) random variables. Consequently, the signals received by Bob and Eve in phase 1 can be written as

$${y}_{B}^{T} = \sqrt{{P}_{A} / {n}_{A} {h}_{B , A}^{{TX}_{A}}} + {w}_{B}^{T} ∈ \qquad ( Equation 140 )$$

$${Y}_{E , A} = \sqrt{{P}_{A} / {n}_{A} {G}_{{AX}_{A}}} + {W}_{E , A} ∈ {C}^{{n}_{E} \times m} \qquad ( Equation 141 )$$

Here h_{B,A} is the channel vector from Alice to Bob, G_{A} is the channel matrix from Alice to Eve, and

$${w}_{B}^{T}$$

and W_{E,A} are the noises. We will let the entries in

$${w}_{B}^{T}$$

be i.i.d.

$$CN ( 0 , {σ}_{B}^{2} )$$

and those in W_{E,A} be i.i.d.

$$CN ( 0 , {σ}_{E , A}^{2} ) .$$

In phase 2 of STEEP, Bob echoes back the probes encrypted by a secret message for Alice. Here we consider the (not optimized) signal sent by Bob:

$$\sqrt{{P}_{B}^{′}} ( {s}^{T} + \sqrt{{n}_{A} / {P}_{A} {y}_{B}^{T}} )$$

with s^{T}=[s(1), . . . , s(m)] containing the secret message for Alice. We will assume that all entries in s^{T} are i.i.d. CN(0,1).

Note that while P_{A} is a fair representation of the transmission power by Alice in phase 1,

$${P}_{B}^{′}$$

is only a “reference power” used by Bob in phase 2. The actual power consumed by Bob is

$${P}_{B} = {P}_{B}^{′} + {P}_{B}^{′} {\vert {h}_{B , A} \vert}^{2} + \frac{{n}_{A}}{{P}_{A}} {σ}_{B}^{2} \qquad ( Equation 142 )$$

Since h_{B,A} is assumed to be public, it can be assumed that P_{A},

$${P}_{B}^{′}$$

and P_{B} are all public.

Then the signals received by Alice and Eve via the return channels in phase 2 can be written as

$${Y}_{A} = \sqrt{{P}_{B}^{′} {h}_{A , B}} ( {s}^{T} + \sqrt{{n}_{A} / {P}_{A} {y}_{B}^{T}} ) + {W}_{A} ∈ {C}^{{n}_{A} \times m} \qquad ( Equation 143 )$$

$${Y}_{E , B} = \sqrt{{P}_{B}^{′} {g}_{B}} ( {s}^{T} + \sqrt{{n}_{A} / {P}_{A} {y}_{B}^{T}} ) + {W}_{E , B} ∈ {C}^{{n}_{E} \times m} \qquad ( Equation 144 )$$

Here h_{A,B} is the channel vector from Bob to Alice, g_{B} is the channel vector from Bob to Eve, and W_{A} and W_{E,B} are the noises. We will let the entries of W_{A} be i.i.d.

$$CN ( 0 , {σ}_{A}^{2} )$$

and those of W_{E,B} be i.i.d.

$$CN ( 0 , {σ}_{E , B}^{2} ) .$$

### Analysis of the Signals Received by Alice

Since Alice knows

$$\sqrt{{n}_{A} {P}_{B}^{′} / {P}_{A} {h}_{A , {Bh}_{B , A}^{T {X}_{A}}}} ,$$

subtracting it from Y_{A} yields

$${Y}_{A}^{′} = \sqrt{{P}_{B}^{′} {h}_{A , {Bs}^{T}}} + {W}_{A}^{′} \qquad ( Equation 145 )$$

with

$${W}_{A}^{′} = \sqrt{{n}_{A} {P}_{B}^{′} / {P}_{A} {h}_{A , {Bw}_{B}^{T}}} + {W}_{A}$$

The kth column of

$${Y}_{A}^{′}$$

is written as

$${y}_{A}^{′} ( k ) = \sqrt{{P}_{B}^{′} {h}_{A , B}} s ( k ) + {w}_{A}^{′} ( k ) \qquad ( Equation 146 )$$

and the sufficient statistic from y′_{A}(k) for s(k) is

$${r}_{A} ( k ) ≐ \frac{1}{\sqrt{{P}_{B}^{′}} {\vert {h}_{A , B} \vert}^{2}} {h}_{A , B}^{{Hy}_{A}^{′}} ( k ) = s ( k ) + {v}_{A} ( k ) \qquad ( Equation 147 )$$

with

$$v\_A ( k ) = \sqrt{{n}_{A} / {P}_{A}} {w}_{B} ( k ) + \frac{{h}_{A , B}^{{Hw}_{A}} ( k )}{\sqrt{{P}_{B}^{′}} {\vert {h}_{A , B} \vert}^{2}}$$

which, conditioned on h_{A,B}, is

$$C N ( 0 , {σ}_{v , A}^{2} )$$

with

$${σ}_{v , A}^{2} = \frac{{n}_{A}}{{P}_{A}} {σ}_{B}^{2} + \frac{{σ}_{A}^{2}}{{P}_{B}^{′} {\vert {h}_{A , B} \vert}^{2}} \qquad ( Equation 148 )$$

### Analysis of the Signals Received by Eve

Note that conditioned on the channel responses, the columns of Y_{E,A} are independent of each other. The same is true for Y_{E,B}. Let the kth column of Y_{E,A} and that of Y_{E,B} be written as

$${y}_{E , A} ( k ) = \sqrt{{P}_{A} / {n}_{A} {G}_{{Ax}_{A}}} ( k ) + {w}_{E , A} ( k ) \qquad ( Equation 149 )$$

$$( Equation 150 )$$

$${y}_{E , B} ( k ) = {P}_{B}^{′1 / 2} {g}_{B} ( s ( k ) + {( {n}_{A} / {P}_{A} )}^{1 / 2} {y}_{B} ( k ) ) + {w}_{E , B} ( k ) = {P}_{B}^{′1 / 2} {g}_{B} s ( k ) + {P}_{B}^{′1 / 2} {g}_{B} {h}_{B , A}^{T} {\hat{x}}_{A} ( k ) + {w}_{E , B}^{′} ( k )$$

$$with$$

$${w}_{E , B}^{′} ( k ) = \sqrt{{P}_{B}^{′} {g}_{{Bh}_{B , A}^{T}}} Δ {x}_{A} ( k ) + \sqrt{{n}_{A} {P}_{B}^{′} / {P}_{A} {g}_{B}} {w}_{B} ( k ) + {w}_{E , B} ( k ) \qquad ( Equation 151 )$$

Here \hat{x}_{A}(k)+Δx_{A}(k)=x_{A} (k), and \hat{x}_{A}(k) is the minimum mean squared error (MMSE) estimate of x_{A}(k) from y_{E,A}(k). It follows that

$$( Equation 152 )$$

$${R}_{Δ x} ≐ E \{ Δ {x}_{A} ( k ) Δ {{x}_{A} ( k )}^{H} \} = {I}_{{n}_{A}} - \frac{{P}_{A}}{{n}_{A}} {{G}_{A}^{H} ( \frac{{P}_{A}}{{n}_{A}} {G}_{{AG}_{A}^{H}} + {σ}_{E , A}^{2 {I}_{{n}_{E}}} )}^{- 1 {G}_{A}} = {( \frac{{P}_{A}}{{n}_{A} {σ}_{E , A}^{2}} {G}_{A}^{{HG}_{A}} + {I}_{{n}_{A}} )}^{- 1}$$

Then the sufficient statistic from \hat{x}_{A} (k) and y_{E,B}(k) for s(k) is (a more rigorous treatment is in an upcoming paper):

$${r}_{E} ( k ) ≐ \frac{1}{\sqrt{{P}_{B}^{′}} \vert {g}_{B} {\vert}^{2}} {g}_{B}^{H} ( {y}_{E , B} ( k ) - \sqrt{{P}_{B}^{′} {g}_{Bh \begin{matrix}T {\hat{x}}_{A} \\ B , A\end{matrix}}} ( k ) ) = s ( k ) + {v}_{E} ( k ) \qquad ( Equation 153 )$$

$$with$$

$${v}_{E} ( k ) = {h}_{B , A}^{T} Δ {x}_{A} ( k ) + \sqrt{\frac{{n}_{A}}{{P}_{A}}} {w}_{B} ( k ) + \frac{{g}_{B}^{{Hw}_{E , B}} ( k )}{\sqrt{{P}_{B}^{′}} {\vert {g}_{B} \vert}^{2}} \qquad ( Equation 154 )$$

which (conditioned on channel responses) is

$$C N ( 0 , {σ}_{v , E}^{2} )$$

with

$${σ}_{v , E}^{2} = {h}_{B , A}^{{TR}_{Δ {xh}_{B , A}^{*}}} + \frac{{n}_{A}}{{P}_{A}} {σ}_{B}^{2} + \frac{{σ}_{E , B}^{2}}{{P}_{B}^{′} {\vert {g}_{B} \vert}^{2}} \qquad ( Equation 155 )$$

### Analysis of the Secrecy Rate of the Effective Return Channels

The above described STEEP forms effective return channels from Bob to Alice and Eve. Hence the achievable secrecy capacity based on the effective wiretap channel model (with a long coherence time) is known to be

$$\overline{{C}_{STEEP}} ≐ {( {C}_{S T E E P} )}^{+}$$

with

$${C}_{STEEP} = log ( 1 + \frac{1}{{σ}_{v , A}^{2}} ) - log ( 1 + \frac{1}{{σ}_{v , E}^{2}} ) \qquad ( Equation 156 )$$

Strictly speaking, this secrecy capacity holds if and only if Alice and Bob know both

$${σ}_{v , A}^{2} and {σ}_{v , E}^{2} . If {σ}_{v , E}^{2}$$

is unknown to Alice and Bob, a meaningful measure of secrecy is an outage probability for a given secrecy rate Rₛ>0, i.e.,

$${O}_{STEEP} ( {R}_{s} ) \approx Prob ( \overline{{C}_{STEEP}} \leq {R}_{s} ) = Prob ( {C}_{STEEP} \leq {R}_{s} ) \qquad ( Equation 157 )$$

1) The case of large P_{B}: If Bob applies a large power P_{B} (or P_{B′}) such that

$$\frac{{n}_{A}}{{P}_{A}} {σ}_{B}^{2} >> \frac{{σ}_{A}^{2}}{{P}_{B}^{′} {\vert {h}_{A , B} \vert}^{2}} and \frac{{n}_{A}}{{P}_{A}} {σ}_{B}^{2} >> \frac{{σ}_{E , B}^{2}}{{P}_{B}^{′} {\vert {g}_{B} \vert}^{2}}$$

(or equivalently if

$${σ}_{v , A}^{2} \approx \frac{{n}_{A}}{{P}_{A}} {σ}_{B}^{2} and {σ}_{v , E}^{2} \approx {h}_{B , A}^{T} {R}_{△ x} {h}_{B , A}^{*} + \frac{{n}_{A}}{{P}_{A}} {σ}_{B}^{2} ) ;$$

then

$$( Equation 158 )$$

$${C}_{STEEP} \approx log ( 1 + \frac{{P}_{A}}{{n}_{A} {σ}_{B}^{2}} ) - log ( 1 + \frac{{P}_{A}}{{n}_{A} {σ}_{B}^{2}} \cdot \frac{1}{1 + \frac{{P}_{A}}{{n}_{A} {σ}_{B}^{2}} {h}_{B , A}^{{TR}_{Δ x {h}_{B , A}^{*}}}} ) = log ( 1 + \frac{α}{1 + \frac{1 + \frac{1}{α}}{β}} ) > 0$$

with

$$α = \frac{{P}_{A}}{{n}_{A} {σ}_{B}^{2}}$$

and

$$β = {h}_{B , A}^{T} {R}_{△ x} {h}_{B , A}^{*} \qquad ( Equation 159 )$$

A larger P_{B} relative to P_{A} means a higher quality channel from Bob to Alice than from Alice to Bob. In this case, we see that the secrecy capacity C_{STEEP} stays positive as long as β>0. Note that for a sufficiently large P_{B}, Equation (158) holds for both static and block-fading channels even if Eve's channels from Alice and Bob are stronger (due to n_{E}>n_{A} for example) than the main channels between Alice and Bob.

2) The case of n_{A}>n_{E}: In this case, the eigenvalue decomposition of

$${G}_{A}^{H} {G}_{A}$$

is QΛQ^{H} with Q being a n_{A}×n_{A} unitary matrix and Λ=diag(λ₁, . . . , Δₙ_{_{E}}, 0, . . . ,0). Then

$$β = {{h}_{B , A}^{T Q} ( {α}^{′} Λ + {I}_{{n}_{A}} )}^{- 1 {Q}^{H {h}_{B , A}^{*}}} \qquad ( Equation 160 )$$

with

$${α}^{′} = \frac{{P}_{A}}{{n}_{A} {σ}_{E , A}^{2}} .$$

For a large P_{A},

$$β \approx {\vert {h}_{B , A}^{T {Q}_{1}} \vert}^{2} \qquad ( Equation 161 )$$

Where Q₁ consists of the last n_{A}−n_{E} columns of Q, and hence β is invariant to large P_{A}. In this case, the degree of freedom of C_{STEEP} in Equation (158) relative to log P_{A} equals one, i.e.,

$${lim}_{{P}_{A} \to ∞} \frac{{C}_{STEEP}}{log {P}_{A}} = 1.$$

(Note that α is proportional to P_{A}.) This is consistent with Equation (139) with m_A>n_{A}>n_{E} and m_{B}=n_{B}=1.

Note that if the channel probing was conducted from Bob (with one antenna) to Alice (with n_{A}≥1 antenna), the corresponding contribution of degree of freedom of secrecy (against Eve with n_{E}≥1 antennas) would be zero.

3) The case of n_{A}≤n_{E}: In this case, Δ=diag (λ₁, . . . , λₙ_{_{E}})>0. For a large P_{A}, we have β≈0 but

$$\begin{matrix}αβ \approx = \frac{{σ}_{E , A}^{2}}{{σ}_{B}^{2}} {h}_{B , A}^{T} Q {Λ}^{- 1} {Q}^{H} {h}_{B , A}^{*} \\ = \frac{{σ}_{E , A}^{2}}{{σ}_{B}^{2}} {{h}_{B , A}^{T} ( {G}_{A}^{H} {G}_{A} )}^{- 1} {h}_{B , A}^{*} > 0.\end{matrix} \qquad ( Equation 162 )$$

Namely, αβ stays positive and invariant to large P_{A} while β and 1/α converge to zero as P_{A} increases. In this case, for large P_{A}, C_{STEEP} in Equation (158) becomes

$${C}_{STEEP} \approx log ( 1 + \frac{{σ}_{E , A}^{2}}{{σ}_{B}^{2}} {{h}_{B , A}^{T} ( {G}_{A}^{H} {G}_{A} )}^{- 1} {h}_{B , A}^{*} ) > 0 \qquad ( Equation 163 )$$

which is invariant to P_{A}. In this case of n_{A}≤n_{E}, the degree of freedom of C_{STEEP} relative to log P_{A} is zero, which is expected according to Equation (139).

4) The case of arbitrary P_{B}: In this case, in order for C_{STEEP} in Equation (156) to be non-positive, we must have

$${σ}_{v , A}^{2} \geq {σ}_{v , E}^{2}$$

or equivalently

$$\frac{{σ}_{A}^{2}}{{\vert {h}_{A , B} \vert}^{2}} - \frac{{σ}_{E , B}^{2}}{{\vert {g}_{B} \vert}^{2}} \geq {P}_{B}^{′} \qquad ( Equation 164 )$$

This condition is referred to as the natural outage. It is clear that

$$A \dot{=} \frac{{σ}_{A}^{2}}{{\vert {h}_{A , B} \vert}^{2}}$$

is the (normalized) return channel attenuation for users (from Bob to Alice) while

$$E \dot{=} \frac{{σ}_{E , B}^{2}}{{\vert {g}_{B} \vert}^{2}}$$

is the (normalized) return channel attenuation for Eve (from Bob to Eve). If A is no larger than E, the natural outage does not happen. We also see that for any given A and E, there is a finite threshold for

$${P}_{B}^{′}$$

beyond which the natural outage does not happen.

Since g_{B} is unknown to users, so is E in general. Since G_{A} is unknown to users, so is β in general. Therefore, the natural outage for any given P_{A} and P_{B} is in general a random event. The probability of the natural outage along with other more general properties will be discussed below.

### A Conventional Half-Duplex Two-Way Scheme

For comparison purpose, let us now consider a conventional half-duplex two-way scheme where Alice sends a secret to Bob in phase 1, and Bob sends another secret to Alice in phase 2. We will use the same power consumptions by Alice and Bob and the same channel parameters as used for STEEP.

In phase 1, the optimal waveform to be transmitted is known to be

$$\sqrt{{P}_{A}} \frac{{h}_{B , A}^{*}}{\vert {h}_{B , A} \vert} {s}_{A} ( k ) {withs}_{A} ( k )$$

being i.i.d. CN(0,1). Then the SNRs at Bob and Eve are

$${SNR}_{B} = \frac{{P}_{A} {\vert {h}_{B , A} \vert}^{2}}{{σ}_{B}^{2}} \qquad ( Equation 165 )$$

### and the SNR at Eve is

$${SNR}_{E , A} = \frac{{P}_{A} {\vert {g}_{A} \vert}^{2}}{{σ}_{E , A}^{2}} \qquad ( Equation 166 )$$

with

$${g}_{A} = {G}_{A} \frac{{h}_{B , A}^{*}}{\vert {h}_{B , A} \vert} .$$

The secrecy capacity in phase 1 is C̅₁̅=(C₁)⁺ with

$${C}_{1} = log ( 1 + {SNR}_{B} ) - log ( 1 + {SNR}_{E , A} ) \qquad ( Equation 167 )$$

It is obvious that C̅₁̅=0 for any

$${P}_{A} if \frac{{\vert {g}_{A} \vert}^{2}}{{σ}_{E , A}^{2}} \geq \frac{{\vert {h}_{B , A} \vert}^{2}}{{σ}_{B}^{2}} .$$

In phase 2, the optimal waveform to be transmitted by Bob is \sqrt{P_{B}}s_{B}(k) with s_{B}(k) being i.i.d. CN(0,1) (and also independent of s_{A}(k)). The signal received by Alice is \sqrt{P_{B}h_{A,B}}s_{B}(k)+w_{A}, from which a sufficient statistic is obtained by multiplying it from the left by

$$\frac{{h}_{A , B}^{H}}{\vert {h}_{A , B} \vert} .$$

The SNR of the resulting signal is

$${SNR}_{A} = \frac{{P}_{B} {\vert {h}_{A , B} \vert}^{2}}{{σ}_{A}^{2}} \qquad ( Equation 168 )$$

Similarly, the signal received by Eve is \sqrt{P_{B}g_{B}}s_{B}(k)+w_{E,B}, and the SNR of a corresponding sufficient statistic of this signal is

$${SNR}_{E , B} = \frac{{P}_{B} {\vert {g}_{B} \vert}^{2}}{{σ}_{E , B}^{2}} \qquad ( Equation 169 )$$

The secrecy capacity in phase 2 is C̅₂̅=(C₂)⁺ with

$${C}_{2} = log ( 1 + {SNR}_{A} ) - log ( 1 + {SNR}_{E , B} ) \qquad ( Equation 170 )$$

Similar to C̅₁̅, we see that C̅₂̅=0 for any

$${P}_{B} if \frac{{\vert {g}_{B} \vert}^{2}}{{σ}_{E , B}^{2}} \geq \frac{{\vert {h}_{A , B} \vert}^{2}}{{σ}_{A}^{2}} .$$

The sum secrecy capacity of the conventional scheme is

$$\overline{{C}_{conv}} = \overline{{C}_{1}} + \overline{{C}_{2}} \qquad ( Equation 171 )$$

Note that C̅_̅{̅c̅o̅n̅v̅}̅≠(C₁+C₂)⁺. In fact, C̅_̅{̅c̅o̅n̅v̅}̅≥(C₁+C₂)⁺. Next is to compare C̅_̅{̅c̅o̅n̅v̅}̅ with C̅_̅{̅S̅T̅E̅E̅P̅}̅ under random realizations of channel responses. More specifically, we will compute the distribution of the improvement or gain of the secrecy capacity from the conventional to STEEP:

$${G}_{s} ≐ \overline{{C}_{STEEP}} - \overline{{C}_{conv}} 2 \qquad ( Equation 172 )$$

Note that both C̅_̅{̅c̅o̅n̅v̅}̅ and C̅_̅{̅S̅T̅E̅E̅P̅}̅ measure the achievable number of secret bits established between Alice and Bob per each sample interval for transmission from Alice to Bob and another sample interval for transmission from Bob to Alice.

Since the SNRs at Eve are generally unknown to Alice and Bob, we will also compare O_{STEEP}(Rₛ) defined in Equation (157) with the following outage probability for the conventional scheme:

$${O}_{conv} ( {R}_{s} ) ≐ Prob ( \overline{{C}_{conv}} \leq {R}_{s} ) \qquad ( Equation 169 )$$

It is useful to note that O_{conv}(Rₛ)≠Prob(C₁+C₂≤Rₛ). In fact, O_{conv}(Rₛ)≤Prob(C₁+C₂≤Rₛ).

### Simulation Results

In this section, we use simulation to illustrate the secrecy capacity of STEEP shown in Equation 152 for some given values of P_{A} and P_{B} and subject to random h_{B,A}, h_{A,B}=γh_{B,A}+(1−γ)w, g_{B} and G_{A} where 0<γ<1. More specifically, we let all entries of h_{B,A}, w, g_{B} and G_{A} follow i.i.d. CN(0,1). We also assume

$${σ}_{B}^{2} = {σ}_{A}^{2} = {σ}_{E , A}^{2} = {σ}_{E , B}^{2} = 1 .$$

With the above assumptions of the channel responses, |h_{A,B}| and |g_{B}| in Equation (164) are independent and Chi-square distributed with degrees 2n_{A} and 2n_{E} respectively. But the distribution of β in Equation (164) or equivalently in Equation (159) is more complicated. Also for 0<γ<1, there is a correlation between h_{A,B} and h_{B,A}, and β is also correlated with |h_{A,B}|². The statistical analysis of C_{STEEP} in Equation (156) for any given P_{A} and P_{B} under the above conditions remains a challenge. In the following, we will present further insights into C_{STEEP} based on computer simulations. We will use γ=0.2 and 10⁵ independent realizations of all above stated random parameters.

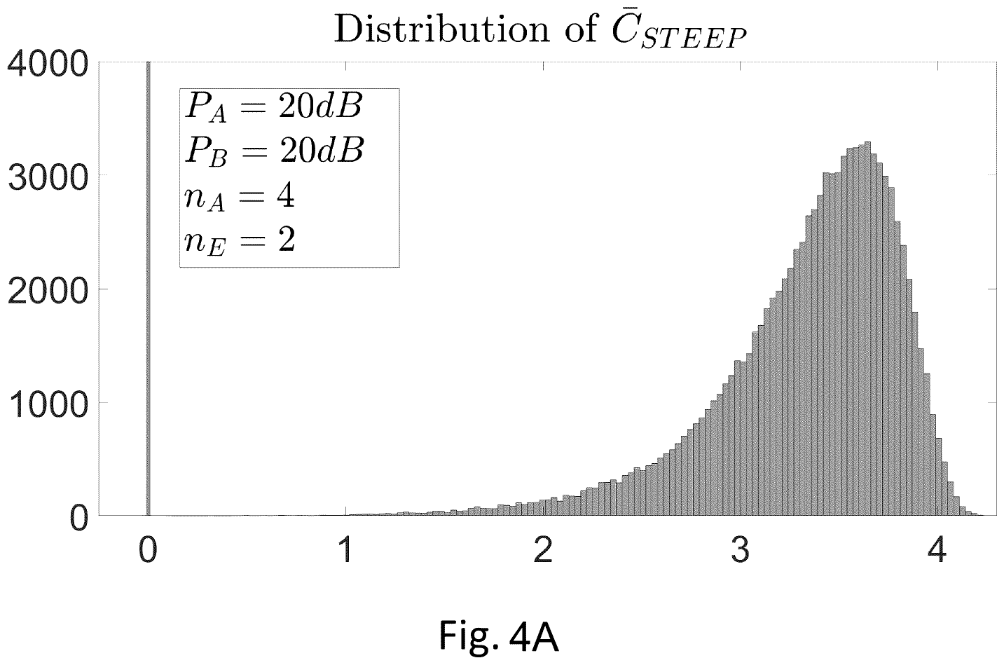

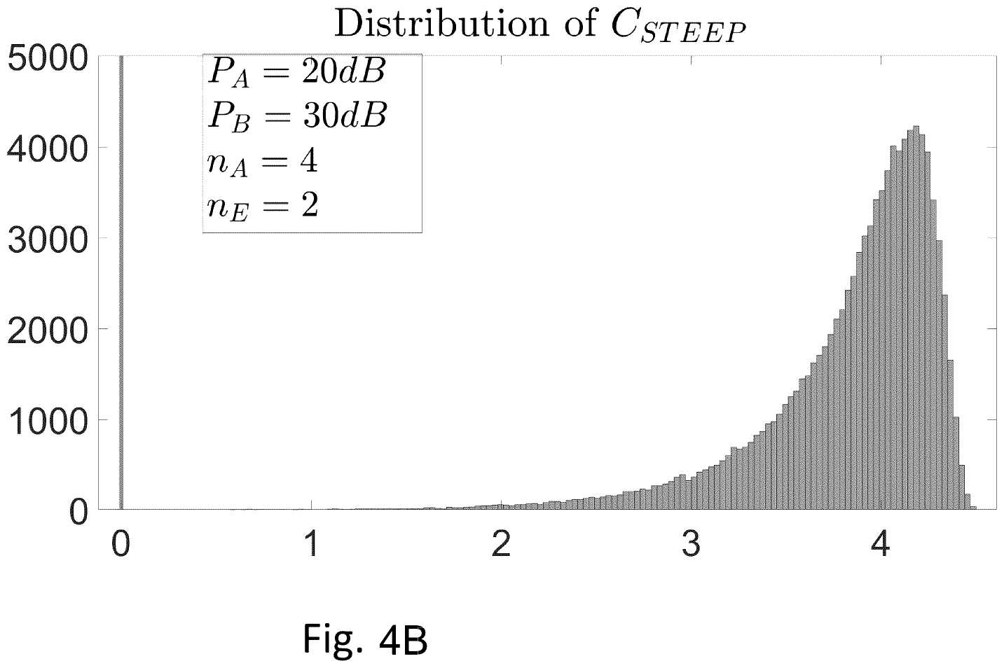

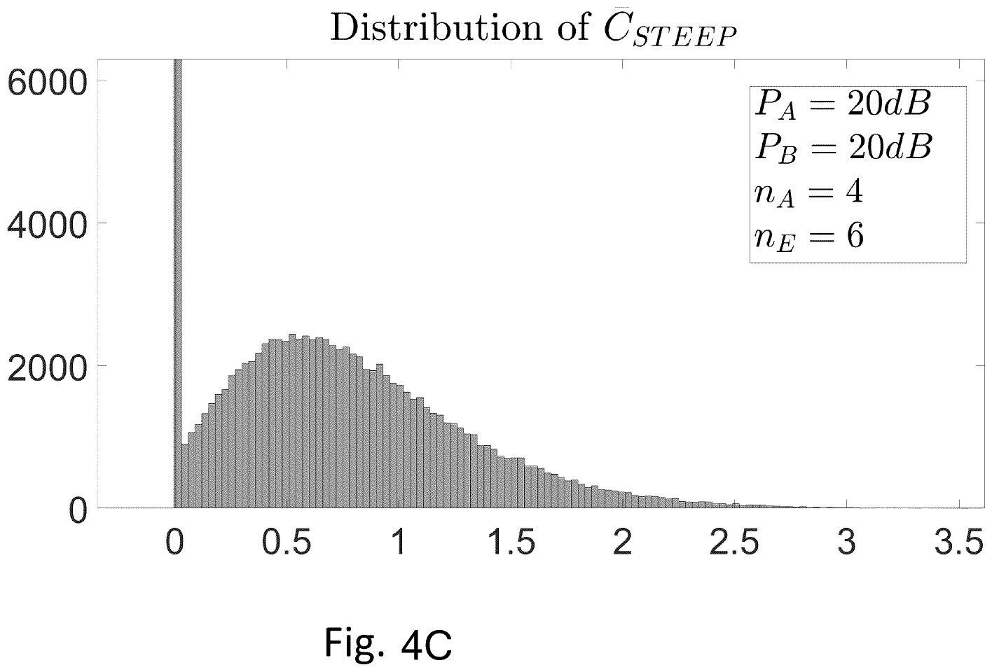

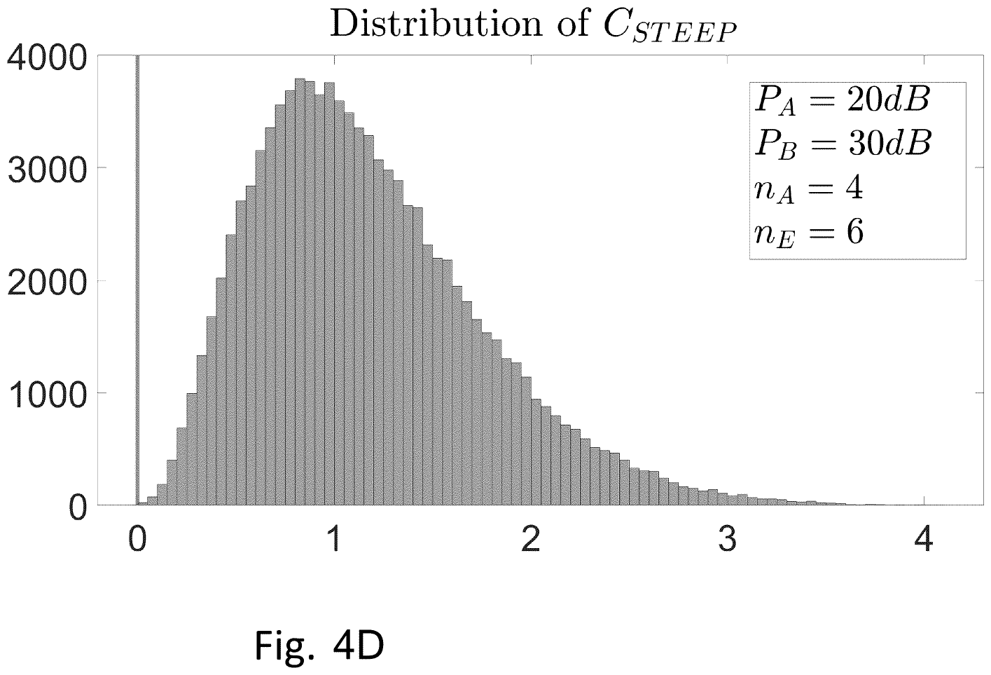

In FIGS. 4A-4D, shown are the distributions (i.e., histograms) of C̅_̅{̅S̅T̅E̅E̅P̅}̅ subject to n_{A}=4 and P_{A}=20 dB. The upper two plots are for n_{E}=2, and the lower two plots are for n_{E}=6. The left two plots are for P_{B}=20 dB, and the right two plots are for P_{B}=30 dB. For a larger P_{B}, the probability for the natural outage (i.e., O_{STEEP}(0)=Prob(C̅_̅{̅S̅T̅E̅E̅P̅}̅=0)=Prob (C_{STEEP}≤0)) tends to become much smaller (if not zero), which is justified by the analysis discussed herein.

It is also somewhat expected that for a larger n_{E}, the distribution of C̅_̅{̅S̅T̅E̅E̅P̅}̅ moves to the left. However, it is important to see that for the case of n_{A}=, N_{E}=, P_{A}=20 dB and P_{B}=30 dB (see FIG. 4D), the probability of the natural outage for STEEP is still extremely small.

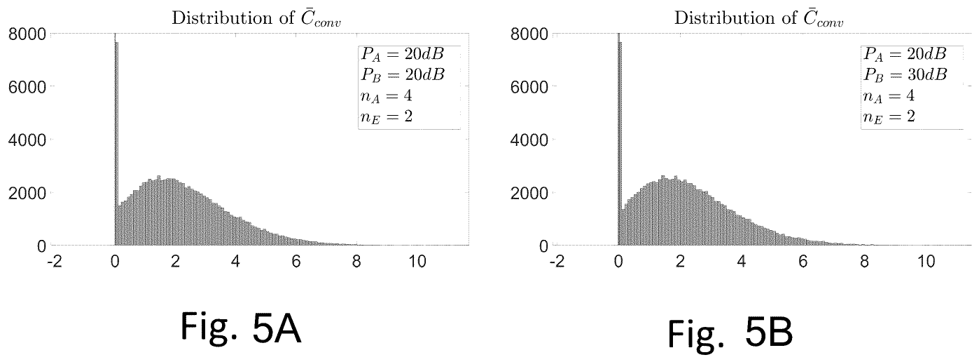

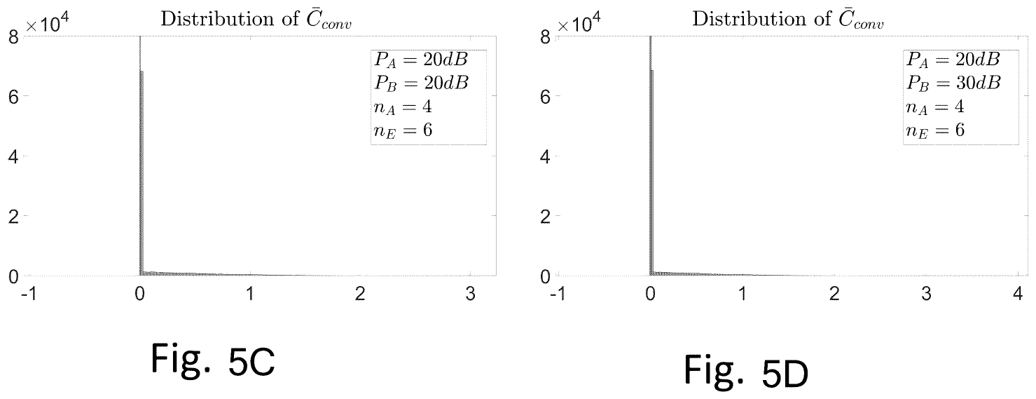

Under the exactly same conditions as FIGS. 4A-4D, FIGS. 5A-5D show the distributions of C̅_̅{̅c̅o̅n̅v̅}̅. FIGS. 5A & 5B are for n_{E}=2, which show a significant probability of natural outage (i.e., O_{conv}(0)=Prob (C̅_̅{̅c̅o̅n̅v̅}̅=0)). FIGS. 4C and 4D are for n_{E}=6, which show the natural outage reaching near 100%.

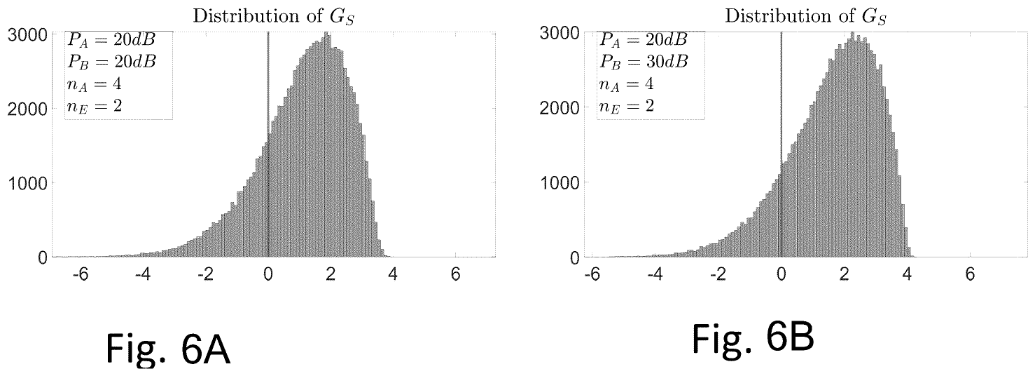

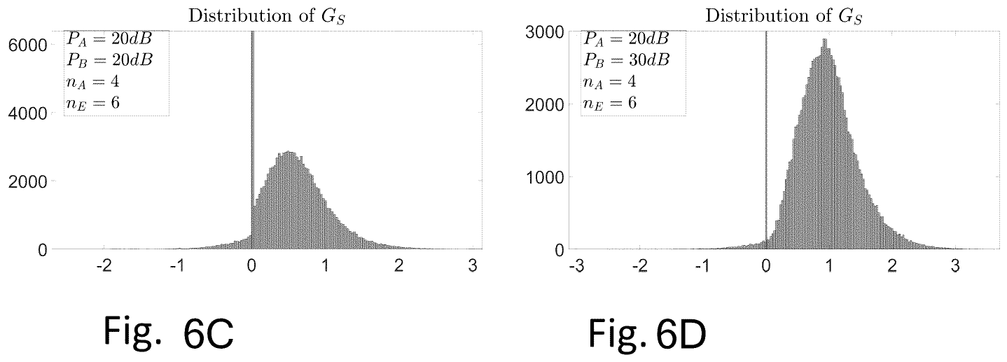

FIGS. 6A-6D shows the distributions of the secrecy capacity gain Gₛ of STEEP for n_{A}=4 and P_{A}=20 dB. This gain is mostly positive as expected from the previous analyses. This is true especially for a large P_{B} and a large n_{E}. But we also see that there is a (small or not) probability that Gₛ is negative. This is because when Eve's channel is in deep fade, the conventional scheme yields a positive secrecy in both directions of transmissions while STEEP does not take that advantage. However, this deep fade of Eve's channel has a low probability if Eve has a significant number of antennas. See FIGS. 6C and 6D where n_{E}=6. Also, since Eve's channel is generally unknown to users, it seems infeasible for the conventional scheme to exploit Eve's deep fade.

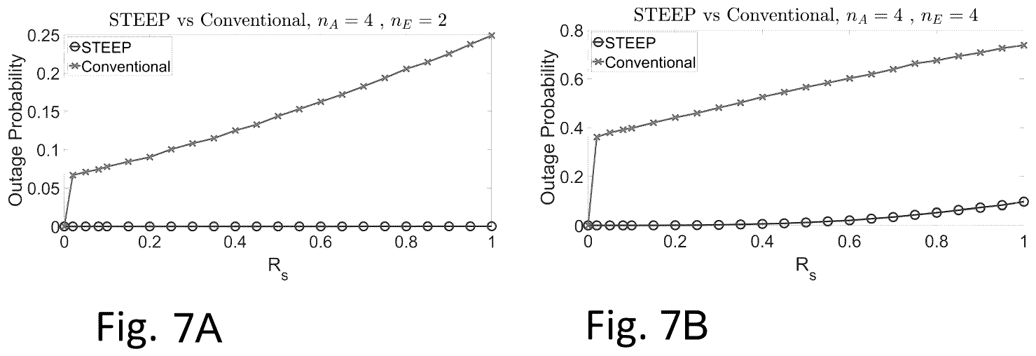

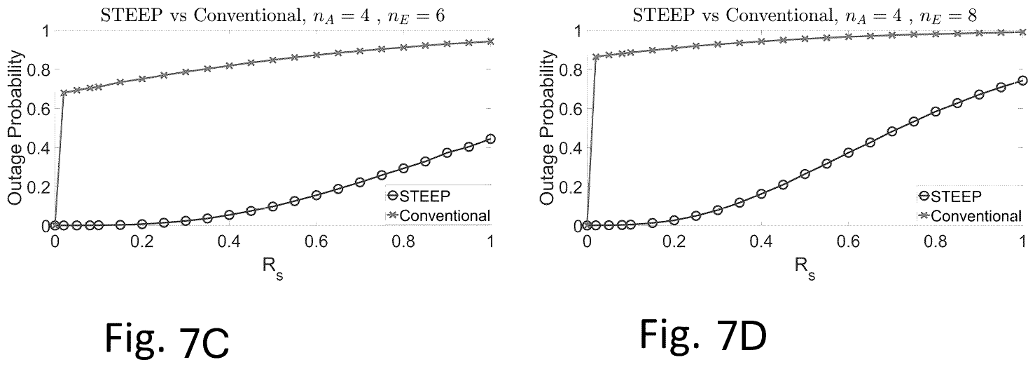

FIGS. 7A-7D compare the outage probabilities of STEEP and the conventional as functions of the target secrecy rate Rₛ (i.e., O_{STEEP}(Rₛ) and O_{conv}(Rₛ)) where n_{A}=4, P_{A}=20 dB and P_{B}=30 dB. We see that for all the cases of n_{E}=2, 4, 6, 8 and 0<Rₛ<1, STEEP has much smaller outage probabilities than the conventional scheme.

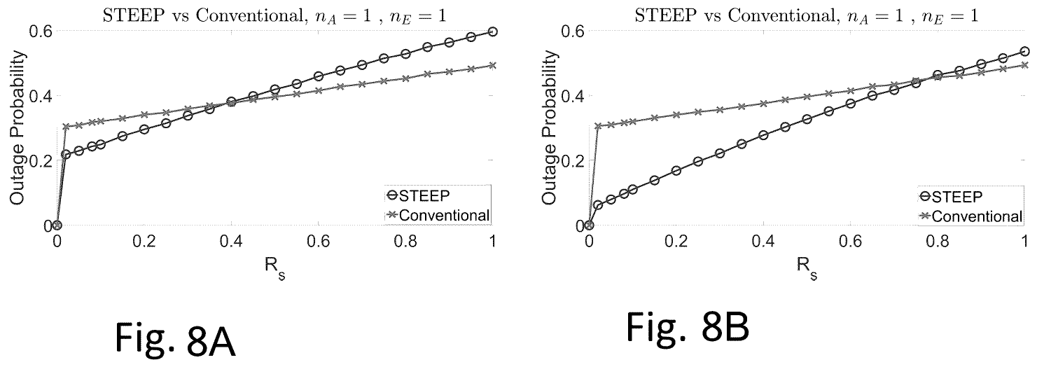

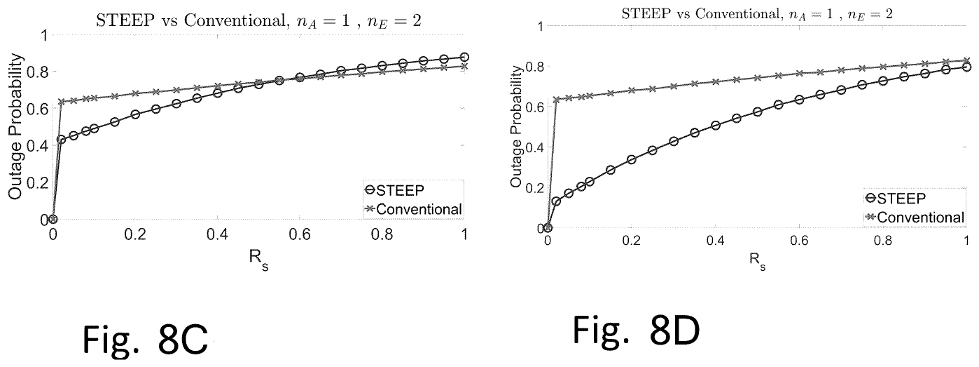

Finally, shown is the case of n_{A}=1 in FIGS. 8A-8D with P_{A}=20 dB. In this case, the channel between Alice and Bob is highly vulnerable due to fading, and there is no antenna diversity. Because of that, we see from FIG. 8A that STEEP and the conventional scheme do not have a large difference in terms of outage performance when P_{B} is 30 dB. But with P_{B}=40 dB, the gap of outage performances in the lower end of Rₛ becomes significantly larger (see FIG. 8B). A similar trend can be seen in FIGS. 8C and 8D where n_{E}=2.

In this embodiment, further insights into STEEP have been provided. The secrecy capacity of STEEP is once again shown to be robust against the strength of Eve's channels, which opens a new door for secure communications.

### A Method for Low-Latency Secure Multiple Access

This is yet another embodiment an application of “secret-message transmission by echoing encrypted probes (STEEP)” to multiple access (MA) between users' equipment (UEs) and an access point (AP). This method, referred to as MA-STEEP, allows all UEs to take advantage of a common sequence of probes broadcasted by AP, which helps to meet the low-latency requirement. The secrecy capacity of MA-STEEP from each UE to AP is shown to be positive with high probability (subject to a power condition) and robust against the number M of UEs. A total secrecy capacity of MA-STEEP increases with M, unlike a common-nonce method.

For applications such as Virtual Reality, Artificial Intelligence, federated learning, autonomous driving, etc., next generation networks must allow low-latency secure multiple access. Multiple access is necessary to provide local wireless connections for massive numbers of devices with limited spectral resources. Security and privacy are among the major requirements from network designers and consumers alike. Low latency is essential to ensure the feasibility of any real-time networked control systems and to provide high-quality consumer experiences.

This embodiment provides method and system of physical layer security to achieve a combined goal of multiple access, security and low-latency.

Multiple access has been an active research topic for many decades. There are orthogonal multiple access schemes such as TDMA, FDMA and OFDMA, as well as non-orthogonal multiple access schemes such as CDMA, random access and successive interference cancellation. In this paper, we will focus on orthogonal multiple access which is highly efficient in both computation and spectral usage for users with similar powers.

Secure multiple access can be realized if there is always a strong secret key between an access point (AP) and each user equipment (UE). A secret key used repeatedly in general loses its secrecy due to, for example, plain-text.

The traditional methods for key generation and management are costly. The use of nonce at the networking layer for communications between AP and each UE can be effective for privacy but is not spectrally efficient or of low latency. To reduce the spectral usage or latency of the transmissions between AP and all UEs, a common nonce could be broadcasted by AP and later be used by all UEs for uplink. In this case, however, any of the UEs could eavesdrop on the transmissions from other UEs.

A secret key between AP and each UE can be locally generated by the two nodes exploiting the wireless channel between them. This has been a research topic for decades, and a vast majority of the prior methods for secret key generation (SKG) require a reciprocal wireless channel. But the secret-key rate based on this approach is very limited when the channel environment is, for example, static. Many efforts to produce a positive secret-key rate with or without channel reciprocity in static environment have failed until the recent works. It is now established that regardless of channel reciprocity, one node can effectively send a secret key to another node with a positive secret-key rate even if eavesdropper's channel is stronger than that between the two nodes. This paper aims to extend parts of the discoveries shown in those works to the area of secure multiple access.

To achieve low latency and information security between two nodes, there have been recent papers on short-packet theory for wiretap channel (WTC) system. These works essentially follow the traditional WTC theory while also considering the loss of secrecy rate due to finite or short length of a packet. But just like the long-packet case, the secrecy rate of the short-packet scheme shown in those works is always zero whenever eavesdropper's channel is stronger than the channel between the legitimate users. The applicability of the short-packet theory to multiple access is another major hurdle which was unresolved.

The secrecy capacity region of multi-access WTC system is still a poorly understood subject. Fundamentally different others where “feedback” from AP is used, the method described herein in this embodiment uses “probing” from AP. Note that “feedback” follows a message transmission while “probing” precedes the message transmission.

The method called secret-message transmission by echoing encrypted probes (STEEP) is described above. The extension of STEEP in embodiment to multiple access (MA) will be referred to as MA-STEEP. There is a similarity between MA-STEEP and the common-nonce method, but there are also crucial differences explained below.

The similarity between the two methods is that before each UE transmits its message, AP sends a signal to all UEs; and this signal is then used by all UEs for privacy purposes. This is also where the similarity ends. In the common-nonce method, all UEs are required to receive the common nonce with no error, and hence unfortunately they can all eavesdrop on each other. In MA-STEEP, a sequence of random probing symbols are transmitted from AP to all UEs in phase 1 (also called probing phase), but no Eve or UE is allowed to estimate the probes exactly. This can be realized by power control at AP. In phase 2 (also called echoing phase), each UE sends back its estimated probes encrypted by (or mixed with) its secret message. At AP, the secret message from each UE can be then detected with a reliability always higher than at Eve or any eavesdropping UE. In other words, MA-STEEP transforms the physical multi-access WTC system from UEs to AP into a virtual or effective multi-access WTC system where the latter always disadvantages any eavesdropping node. MA-STEEP takes advantage of the independent noises at all nodes in the physical layer to yield an almost always positive secrecy rate for each UE in uplink. With this effective WTC system, all established coding methods for WTC can be then applied.

### Basic Principle of STEEP

For a two-user channel, STEEP described above is a round-trip transmission scheme between two nodes, which uses channel probing and echoing of encrypted probes to effectively or virtually degrade eavesdropper's channel. The two-way scheme described above for a binary symmetric channel turns out to be a special case of STEEP. A predecessor of STEEP, called iSAT, is also described above.

More specifically, in order for node B to transmit a secret message to node A, node A first transmits probing symbols to node B in what we call a “probing” phase (phase 1). The estimated probing symbols (or estimated effective probes) obtained by node B are then encrypted with the secret message and echoed back to node A in what we call an “echoing” phase (phase 2). Since node A knows the exact probing symbols while Eve only knows a noisy version of the probes, node A almost always has an advantage over Eve in detecting the secret message from node B. This results in a positive secrecy rate as long as Eve's receive channel from node A is not infinitely stronger than node B's receive channel from node A, which is the case if Eve's channel is not noiseless.

In this embodiment, STEEP has a role for multiple access (or multi-user) applications. Given an access point (AP) and multiple users' equipment (UEs), a trivial application of STEEP would be to apply STEEP between AP and each UE in a completely orthogonal fashion, e.g., AP sends a separate sequence of probes to each of the UEs using an orthogonal channel in the probing phase, and then each UE performs its operation as described above using an orthogonal channel in the echoing phase. But in this paper, we consider a MA-STEEP where AP first broadcasts a single sequence of probes to all UEs in the probing phase, and only in the echoing phase an orthogonal channel is used for each UE to transmit to AP a secret message encrypted with the UE's estimate of its effective sequence of the same probes.

If we want to further reduce the spectral usage, or equivalently the latency, we could also consider non-orthogonal multiple access by the UEs in the echoing phase. But in this embodiment we only consider orthogonal multiple access in phase 2.

### MA-STEEP and Its Secrecy Capacity

Consider an access point (AP) with n_{A} antennas and M single-antenna users' equipment (UEs). The broadcast channel from AP to UE; in baseband is modelled by

$${y}_{i} = {h}_{i}^{T {x}_{A}} + {w}_{i} \qquad ( Equation 170 )$$

where x_{A}∈ [symbol] is a vector transmitted by AP, hᵢ∈ [symbol] is the channel vector, yᵢ and wᵢ are the received signal and noise at UEᵢ. If there are interferences such as jamming noises from (full-duplex) Eve, then wᵢ also includes them.

The channels from UEs to AP are assumed to be orthogonal (such as TDMA, FDMA and OFDMA), i.e., the channel from UEs to AP can be modelled as

$${y}_{A , i} = {h}_{A , i} {x}_{i} + {w}_{A , i} \qquad ( Equation 171 )$$

where xᵢ is a symbol transmitted by UEᵢ, h_{A,i}∈ [symbol] is the channel vector from UEᵢ to AP, and y_{A,i} and w_{A,i} are the received signal and noise at AP. Like wᵢ in Equation (170), W_{A,i} in Equation (171) includes noise and all noise-like interferences.

In the probing phase (phase 1), AP broadcasts a sequence of i.i.d. probing vectors. Each of the vectors can be represented by

$$\sqrt{\frac{{p}_{A}}{{n}_{A}} x}$$

with [symbol] {|x|²}=n_{A}. Then the corresponding signal received by UEᵢ for each of i=1, . . . , M is

$${y}_{i} = \sqrt{\frac{{p}_{A}}{{n}_{A}} {h}_{i}^{T x}} + {w}_{i} \qquad ( Equation 172 )$$

where

$$ℰ \{ {\vert {w}_{i} \vert}^{2} \} = {σ}_{i}^{2} .$$

Also, write

$${y}_{i} = \{ \begin{matrix}\sqrt{{p}_{A}} {h}_{i} {p}_{i} + {w}_{i} , & {n}_{A} = 1 ; \\ \sqrt{\frac{{p}_{A}}{{n}_{A}}} ‖ {h}_{i} ‖ {p}_{i} + {w}_{i} , & {n}_{A} \geq 2 ;\end{matrix} with \qquad ( Equation 173 )$$

$${p}_{i} = \{ \begin{matrix}x , & {n}_{A} = 1 ; \\ {\overline{h}}_{i}^{T} x , & {n}_{A} \geq 2.\end{matrix} \qquad ( Equation 174 )$$

Here x=x and hᵢ=h for n_{A}=, and

$${\overline{h}}_{i} = \frac{1}{\vert {h}_{i} \vert} {h}_{i} .$$

pᵢ is called the effective probing symbol from AP to UEᵢ, which is always known to AP if n_{A}=1. For n_{A}≥2, AP also knows pᵢ if AP receives the feedback of h̅ᵢ from UEᵢ. For secrecy analysis, we will assume that h̅ᵢ is publicly known. In fact, we will also assume that all channel parameters between AP and UEs are known to Eve.

In the echoing phase (phase 2), UEᵢ for i=1, . . . , M transmits

$$\sqrt{\frac{{p}_{B}}{2}} ( + {s}_{i} ) to AP ,$$

where sᵢ is a secret symbol of unit variance from UEᵢ, and [symbol] is the MMSE estimate of pᵢ by UEᵢ using yᵢ. Here each UE knows its receive channel.

Note that the above

$$\sqrt{\frac{{p}_{B}}{2}} ( + {s}_{i} )$$

also corresponds to

$$\sqrt{\frac{{p}_{B}}{2}} ( ( k ) + {s}_{i} ( k ) )$$

if k denotes the kth probing symbol interval and the kth echoed symbol interval for UEᵢ.

We will also assume that x, wᵢ and sᵢ for all i are circular complex Gaussian of zero mean. Then it can be shown that

$$= \frac{\sqrt{\frac{{p}_{A}}{{n}_{A}}} \vert {h}_{i} \vert}{\frac{{p}_{A}}{{n}_{A}} {\vert {h}_{i} \vert}^{2} + {σ}_{i}^{2}} {y}_{i} = \frac{\sqrt{{s}_{i}}}{{S}_{i} + 1} \frac{1}{{σ}_{i}} {y}_{i} \qquad ( Equation 175 )$$

with

$${S}_{i} = \frac{{p}_{A}}{{n}_{A} {σ}_{i}^{2}} {\vert {h}_{i} \vert}^{2}$$

which is the signal-to-noise ratio (SNR) of yᵢ. We will also use

$${c}_{i} \dot{=} {σ}_{2}^{} \dot{=} ℰ \{ {\vert \vert}^{2} \} = \frac{{S}_{i}}{{S}_{i} + 1} \qquad ( Equation 176 )$$

$${σ}_{Δ {p}_{i}}^{2} \dot{=} ℰ \{ {\vert - {p}_{i} \vert}^{2} \} = \frac{1}{{S}_{i} + 1} = 1 - {c}_{i} \qquad ( Equation 177 )$$

Effective Return Channel from UEᵢ to AP

The corresponding signal vector received by AP from UEₜ in phase 2 of MA-STEEP is

$${y}_{A , i} = \sqrt{\frac{{p}_{B}}{2}} ( + {s}_{i} ) {h}_{A , i} + {w}_{A , i} \qquad ( Equation 178 )$$

It can be shown that the MMSE estimate of sᵢ by AP from y_{A,j} for all j=1, . . . , M is

$$= \frac{\frac{{p}_{B}}{2}}{\frac{{p}_{B}}{2} ( {σ}_{2}^{} {σ}_{Δ {p}_{i}}^{2} + 1 ) {\vert {h}_{A , i} \vert}^{2} + {σ}_{A , i}^{2}} {h}_{A , i}^{H} Δ {y}_{A , i} \qquad ( Equation 179 )$$

$$with Δ y {\vert}_{A , i} = {y}_{A , i} - \{ {y}_{A , i} \vert x \} = {y}_{A , i} - \sqrt{\frac{{p}_{B}}{2}} {h}_{A , i} {σ}_{{p}_{i}}^{2} {p}_{i} is$$

$${σ}_{Δ {s}_{i}}^{2} \dot{=} \{ \vert {\hat{s}}_{i} - {s}_{i} {‖}^{2} \} = \frac{{σ}_{{\hat{p}}_{i}}^{2} {σ}_{Δ {p}_{i}}^{2} {S}_{A , i} + 1}{( 1 + {σ}_{{\hat{p}}_{i}}^{2} {σ}_{Δ {p}_{i}}^{2} ) {S}_{A , i} + 1} \qquad ( Equation 180 )$$

$$with {S}_{A , i} = \frac{{p}_{B} {\vert {h}_{A , i} \vert}^{2}}{2 {σ}_{A , i}^{2}} .$$

Hence the effective return channel capacity from UEᵢ to AP (relative to sᵢ) is

$${C}_{A \vert i} = log \frac{1}{{σ}_{Δ {s}_{i}}^{2}} = log ( 1 + \frac{{S}_{A , i}}{\frac{{S}_{i} {S}_{A , i}}{{( {S}_{i} + 1 )}^{2}} + 1} ) \qquad ( Equation 181 )$$

This capacity is achievable when UEᵢ knows Sᵢ as well as S_{A,i}.

Note that if p_{B} is so large that

$$\frac{{S}_{i} {S}_{A , i}}{{( {S}_{i} + 1 )}^{2}} ≫ 1 ,$$

then

$${C}_{A \vert i = log ( 1 + \frac{{( {S}_{i} + 1 )}^{2}}{{S}_{i}} )}$$

and p_{A} is so small that

$$\frac{{S}_{i} {S}_{A , i}}{{( {S}_{i} + 1 )}^{2}} ≪ 1 ,$$

then

$${C}_{A \vert i = log ( 1 + {S}_{A , i} )}$$

Effective Return Channel from UEᵢ to Eve

The signals received by Eve during both phases of MA-STEEP are

$${y}_{E , A} = \sqrt{\frac{{p}_{A}}{{n}_{A}} {G}_{Ax}} + {W}_{E , A} \qquad ( Equation 182 )$$

$${y}_{E , i} = \sqrt{\frac{{p}_{B}}{2} {g}_{i}} ( + {s}_{i} ) + {w}_{E , i} \qquad ( Equation 183 )$$

for all i=1, . . . , M. Here [symbol] for every i depends on x. Also note that s₁, . . . , s_{M} (from different UEs) are independent of each other.

A special case of the above is that one of the users is Eve. If user m is Eve, then n_{E}=1, G_{A}=hₘ and gᵢ=g_{m,i} is the channel gain from UEᵢ to UEₘ.

It can be shown that the MSE of the MMSE estimate of sᵢ by Eve using

$${y}_{E} \dot{=} {[ {y}_{E , 1}^{T} , … , {y}_{E , M}^{T} , {y}_{E , A}^{T} ]}^{T}$$

is

$${σ}_{Δ {s}_{i , E}}^{2} = 1 - {r}_{i}^{{HR}^{- 1 r} i} \qquad ( Equation 184 )$$

where

$${r}_{i}^{H} = ℰ \{ {s}_{{iy}_{E}^{H}} \} and R = ℰ \{ {y}_{{Ey}_{E}^{H}} \} .$$

With no loss of generality, we can now focus on i=1. Then, we can write

$${r}_{1} = {[ \sqrt{\frac{{p}_{B}}{2} {g}_{1}^{T}} , {0}_{{n}_{E} M}^{T} ]}^{T} \\ and \qquad ( Equation 185 )$$

$$R = [ \begin{matrix}{R}_{1 , 1} & ⋯ & {R}_{1 , M + 1} \\ ⋯ & ⋯ & ⋯ \\ {R}_{M + 1 , 1} & ⋯ & {R}_{M + 1 , M + 1}\end{matrix} ] \qquad ( Equation 186 )$$

Here 0ₘ is a zero vector of m elements, and

$${R}_{i , j} = {R}_{j , i}^{H}$$

for all i and j. For 1≤j≤M, 1≤j≤M and i≠j,

$${R}_{i , i} = ( 1 + {σ}_{2}^{} ) \frac{{p}_{B}}{2} {g}_{{ig}_{i}^{H}} + {σ}_{E , i}^{2 {I}_{{n}_{E}}} \qquad ( Equation 187 )$$

$${R}_{i , j} = {ϵ}_{i , j} \frac{{p}_{B}}{2} {g}_{{ig}_{j}^{H}} \qquad ( Equation 188 )$$

$${R}_{i , M + 1} = \sqrt{\frac{{p}_{A} {p}_{B}}{2 {n}_{A}} {g}_{{ir}_{x , i}^{{HG}_{A}^{H}}}} \qquad ( Equation 189 )$$

$${R}_{M + 1 , M + 1} = \frac{{p}_{A}}{{n}_{A}} {G}_{{AG}_{A}^{H}} + {σ}_{E , A}^{2 {I}_{{n}_{E}}} \qquad ( Equation 190 )$$

where

$${ϵ}_{i , j} = ε \{ \} and {r}_{x , i} = ε \{ x \} .$$

It can be shown that

$${r}_{x , i} = σ \frac{2}{} {q}_{i} \qquad ( Equation 191 )$$

with

$${q}_{i} = {\overline{h}}_{i}^{*} .$$

Furthermore, one can verify that for i≠j,

$${ϵ}_{i , j} = \frac{{S}_{i} {S}_{j}}{( {S}_{i} + 1 ) ( {S}_{j} + 1 )} {ϕ}_{i , j} = σ \frac{2}{} σ \frac{2}{} {ϕ}_{i , j} \qquad ( Equation 192 )$$

$$with$$

$${ϕ}_{i , j} = {q}_{i}^{H {q}_{j}} = {\overline{h}}_{i}^{T {\overline{h}}_{j}^{*}} for {n}_{A} \geq 2 , and {ϕ}_{i , j} = 1 for {n}_{A} = 1 .$$

Let Equation (186) be rewritten as

$${R}^{- 1} = [ \begin{matrix}{( {R}_{1 , 1} - {\overline{R}}_{1} {\overline{R}}_{1 , 1}^{- 1} {\overline{R}}_{1}^{H} )}^{- 1} & ⋆ \\ ⋆ & *\end{matrix} ] \qquad ( Equation 194 )$$

where R_{1,1} is the same n_{E}×n_{E} upper-left block of R in Equation (186). Then

$${σ}_{Δ {s}_{1 , E}}^{2} = 1 - \frac{{p}_{B}}{2} {{g}_{1}^{H} ( {R}_{1 , 1} - {\overline{R}}_{1} {\overline{R}}_{1 , 1}^{- 1} {\overline{R}}_{1}^{H} )}^{- 1} {g}_{1} \qquad ( Equation 195 )$$

where * denotes matrix blocks of no importance. Hence, Equation (184) with i=1 becomes

$${σ}_{Δ {s}_{1 , E}}^{2} = 1 - \frac{{p}_{B}}{2} {{g}_{1}^{H} ( {R}_{1} - {\overline{R}}_{1} {\overline{R}}_{1 , 1}^{- 1} {\overline{R}}_{1}^{H} )}^{- 1} {g}_{1} \qquad ( Equation 195 )$$

$$Recall {R}_{1 , 1} = ( 1 + σ \frac{2}{} ) \frac{{p}_{B}}{2} {g}_{1 {g}_{1}^{H}} + {σ}_{E , 1}^{2 {I}_{{n}_{E}}}$$

$$and$$

$${\overline{R}}_{1} = \sqrt{\frac{{p}_{B}}{2} {g}_{1 {c}_{1}^{H}}}$$

$$with$$

$${c}_{1}^{H} = [ {ϵ}_{1 , 2} \sqrt{\frac{{p}_{B}}{2}} {g}_{2}^{H} , … , {ϵ}_{1 , M} \sqrt{\frac{{p}_{B}}{2}} {g}_{M}^{H} , \sqrt{\frac{{p}_{A}}{{n}_{A}}} {r}_{x , 1}^{H} {G}_{A}^{H} ] \qquad ( Equation 196 )$$

$$Hence$$

$${\overline{R}}_{1} {\overline{R}}_{1 , 1}^{- 1} {\overline{R}}_{1}^{H} = \frac{{p}_{B}}{2} {g}_{1} {c}_{1}^{H} {\overline{R}}_{1 , 1}^{- 1} {c}_{1} {g}_{1}^{H} . \qquad ( Equation 197 )$$

$$Let$$

$${γ}_{1} = 1 + {σ}_{{\hat{p}}_{1}}^{2} - {c}_{1}^{H} {\overline{R}}_{1 , 1}^{- 1} {c}_{1} . \qquad ( Equation 198 )$$

Thus,

$$σ \frac{2}{} > {γ}_{1} - 1 > 0 .$$

Here γ₁−1 is the MSE of the MMSE estimate of [symbol] by Eve using

$${y}_{E \vert 1} ≐ {[ {y}_{E , 2}^{T} , … , {y}_{E , M}^{T} , {y}_{E , A}^{T} ]}^{T} .$$

It follows from Equation (195) that

$$\begin{matrix}{σ}_{Δ {s}_{1 , E}}^{2} = 1 - \frac{{p}_{B}}{2} {{g}_{1}^{H} ( \frac{{p}_{B}}{2} {γ}_{1} {g}_{1} {g}_{1}^{H} + {σ}_{E , 1}^{2} {I}_{{n}_{E}} )}^{- 1} {g}_{1} \\ = \frac{( {γ}_{1} - 1 ) {S}_{E , 1} + 1}{{γ}_{1} {S}_{E , 1} + 1} ,\end{matrix} \qquad ( Equation 199 )$$

$$with$$

$${S}_{E , 1} = \frac{{p}_{B} {\vert {g}_{1} \vert}^{2}}{2 {σ}_{E , 1}^{2}} .$$

The capacity of the effective return channel from UE_{I} to AP relative to s₁ is

$${C}_{E \vert 1 = log} \frac{1}{{σ}_{Δ {s}_{1 , E}}^{2}} = log ( 1 + \frac{{S}_{E , 1}}{( {γ}_{1} - 1 ) {S}_{E , 1} + 1} ) \qquad ( Equation 200 )$$

With similar definitions of notations, it can be written

$${C}_{E \vert i = log ( 1 + \frac{{S}_{E , i}}{( {γ}_{1} - 1 ) {S}_{E , i} + 1} )}$$

with

$${S}_{E , i} = \frac{{p}_{B}}{2 {σ}_{E , i}^{2}} {\vert {g}_{i} \vert}^{2} .$$

Similar to γ₁, we know γᵢ>1 for all i.

### Secrecy Capacity of MA-STEEP

Theorem 1: For MA-STEEP, the secrecy capacity of the effective wiretap channel from UE to AP (in bits per return symbol) is

$${\overline{C}}_{s , 1} = {( {C}_{A \vert 1} - {C}_{E \vert 1} )}^{+} = {[ log ( 1 + \frac{{S}_{A , 1}}{\frac{{S}_{1} {S}_{A , 1}}{{( {S}_{1} + 1 )}^{2}} + 1} ) - log + ( 1 + \frac{{S}_{E , 1}}{( {γ}_{1} - 1 ) {S}_{E , 1} + 1} ) ]}^{+} . \qquad ( Equation 201 )$$

Here only γ₁ is affected by all UEs, which in fact depends on S₁ and

$${S}_{E , i} = \frac{{p}_{B} {\vert {g}_{i} \vert}^{2}}{2 {σ}_{E , i}^{2}}$$

for all 2≤i≤M.

Proof: The effective return channel from UE₁ to AP and the effective return channel from UE₁ to Eve constitute an effective wiretap-channel (eWTC) system (relative to s₁) whose secrecy capacity is (C^{∀|ι}−C^{E|ι})+. The property of γ₁ follows from (Equation 196).

Analysis of the Special Case of n_{A}=1

Theorem 2: Assume n_{A}=1 and hence G_{A} reduces to a vector g_{A}. Recall the SNRs

$${S}_{i} = \frac{{p}_{A} {\vert {h}_{i} \vert}^{2}}{{n}_{A} {σ}_{i}^{2}} , {S}_{A , i} = \frac{{p}_{B} {\vert {h}_{A , i} \vert}^{2}}{2 {σ}_{A , i}^{2}} and {S}_{E , i} = \frac{{p}_{B} {\vert {g}_{i} \vert}^{2}}{2 {σ}_{E , i}^{2}} .$$

### Also let

$${S}_{E , A} = \frac{{p}_{A} {\vert {g}_{A} \vert}^{2}}{{σ}_{E , A}^{2}} , {α}_{i} = \frac{{S}_{E , A}}{{S}_{i}} and {β}_{i} = \frac{{S}_{E , i}}{{S}_{A , i}} .$$

Here αᵢ is the ratio of Eve's receive strength from Alice over UEᵢ's, and βᵢ is the ratio of Eve's receive strength from UEᵢ over AP's.

Then

$${γ}_{1} - 1 = \frac{{S}_{1}}{{( {S}_{1} + 1 )}^{2}} ( 1 + \frac{{S}_{1}}{{α}_{1} {S}_{1} + 1} ( 1 - \frac{{t}_{1 , M}}{{α}_{1} {S}_{1} + 1} ) ) \qquad ( Equation 202 )$$

where t_{1,M}=0 for M=1, and t_{1,M} for M≥2 is a function of S_{E,A} and S_{E,i} for all i≠1, i.e.,

$${t}_{1 , M} = {v}_{M}^{H} {B}_{M}^{- 1} {v}_{M} \qquad ( Equation 203 )$$

$$with$$

$${v}_{M}^{H} = [ {c}_{2 {\tilde{g}}_{2}^{H}} , … , {c}_{M - 1 {\tilde{g}}_{M - 1}^{H}} \vert {c}_{M {\tilde{g}}_{M}^{H}} ] = [ {v}_{M - 1}^{H} \vert {c}_{M {\tilde{g}}_{M}^{H}} ] \qquad ( Equation 204 )$$

$${B}_{M} = [ \begin{matrix}{B}_{M - 1} & {C}_{M - 1} \\ {C}_{M - 1}^{H} & ( 1 + \frac{{c}_{M}^{2}}{{S}_{E , A} + 1} ) {\tilde{g}}_{M} {\tilde{g}}_{M}^{H} + I\end{matrix} ] \qquad ( Equation 205 )$$

and

$${C}_{M - 1} = \frac{{c}_{M}}{{S}_{E , A} + 1} {v}_{M - 1 {\tilde{g}}_{M}^{H}} and {\tilde{g}}_{i} = \sqrt{\frac{{p}_{B}}{2 {σ}_{E , i}^{2}} {g}_{i}} .$$

Furthermore, for M≥2, t_{1,M}<min(M−1, α₁S₁+1). Consequently, for all
if and only if

$${S}_{A , 1} > ( 1 - \frac{1}{{β}_{1}} ) \frac{{( {S}_{1} + 1 )}^{2} ( {α}_{1} {S}_{1} + 1 )}{{S}_{1}^{2} ( 1 - \frac{{t}_{1 , M}}{{α}_{1} {S}_{1} + 1} )} ≐ {\tilde{S}}_{A , 1} \qquad ( Equation 206 )$$

Proof: Our simulations have validated the above stated bound on t_{1,M} for M≥2. The above result says that for any M≥1, there is a finite threshold [symbol] such that the secrecy capacity C̅_̅{̅s̅,̅1̅}̅ for is positive if and only if

$${S}_{A , 1} = \frac{{p}_{B} {\vert {h}_{A , 1} \vert}^{2}}{2 {σ}_{A , 1}^{2}} > .$$

Again UE₁ is effectively any of the M UEs.

### Total Secrecy Capacity of MA-STEEP

A total secrecy capacity of MA-STEEP can be expressed as

$${\overline{C}}_{s} = {\overline{C}}_{s , 1} + {\overline{C}}_{s , 2 \vert 1} + … + {\overline{C}}_{s , M \vert 1 , … , M - 1} \qquad ( Equation 207 )$$

Here

$$\overline{{C}_{s , i \vert 1 , … , i - 1 \geq 0}}$$

denotes the secrecy capacity from UEᵢ to AP subject to s₁, . . . , sᵢ₋₁ being known to Eve, the details of which are omitted. Assuming i.i.d. conditions of UEs, C̅_̅{̅s̅,̅i̅|̅1̅,̅ .̅ .̅ .̅ ,̅ i̅-̅1̅}̅ is expected to be statistically larger than

$$\overline{{C}_{s , i + 1 \vert 1 , … , i}} .$$

### Discussion on Implementation of MA-STEEP

Now discussed are some of the implementation issues of MA-STEEP.

Before the probing phase, each of the UEs could send a pilot to AP so that AP can estimate its receive channel vectors h_{A,i} for all i. Each of the pilots should also include necessary information (such as an initial shared key) for AP to perform authentication.

In the probing phase (phase 1), the packet broadcasted by AP should have a header which allows each UE to authenticate the legitimacy of the packet from AP. The header should also include a pilot to allow each UE to perform channel estimation and to obtain its receive channel SNR, i.e., UEᵢ now knows Sᵢ. The header should also include S_{A,i} for all i. The payload in the packet should contain uncoded random probing symbols, i.e., the entries of x(k)∈ [symbol] for probing instant k=1, . . . , m. Since UEᵢ now knows Sᵢ, it also knows the MSE cᵢ of its MMSE estimate of its effective probe. Equivalently, UEᵢ now knows the capacity C_{A,i} for the effective channel from UE to AP, which allows UEᵢ to encode its message for reliable transmission to AP.

In the echoing phase (phase 2), each UE applies orthogonal multiple access to AP (such as OFDMA-a good option for low latency). The header of the packet from each UE should allow AP to conduct authentication. The payload of the packet from UE; now contains a sequence of encrypted probes, i.e., [symbol] (k)+sᵢ(k) with k=1, . . . , m. Here sᵢ(k) should be encoded for reliable reception at AP, which should be guided by the knowledge of C_{A,i}. The detection of the message in sᵢ(k) should be done optimally at AP (for example using a convolutional encoder and Viterbi's decoder). In this way, the detection performance at any eavesdropping node (Eve) is always worse than that at AP even if Eve is much closer to AP than each (legitimate) UE is. Since the message from each UE is received by AP with a positive secrecy, it can also be used for secret-key update needed for future packet authentication.

Any existing encryption method (which may not be strong enough) can still be used. MA-STEEP simply adds a new layer of security, which is a strong physical layer security. How to exactly integrate MA-STEEP with a real-life multiple access system remains a future topic of research.

### Numerical Illustrations

For all the simulation results, we assume that the noises are i.i.d. circular complex Gaussian with zero mean and unit variance, i.e., [symbol] (0,1), and all channel parameters are also i.i.d. [symbol] (0,1). Each of the statistical distributions is based on 10⁴ independent realizations.

### Illustration of Per-User Secrecy Capacity C̅_̅{̅s̅,̅1̅}̅

The secrecy capacity of STEEP (for M=1) approaches the secret-key capacity based on the data sets collected in the probing phase if the users' channel in the echoing phase is relatively noiseless compared to the user's channel in the probing phase. Since the secret-key capacity is almost always positive, so is the secrecy capacity of STEEP subject to the above conditions.

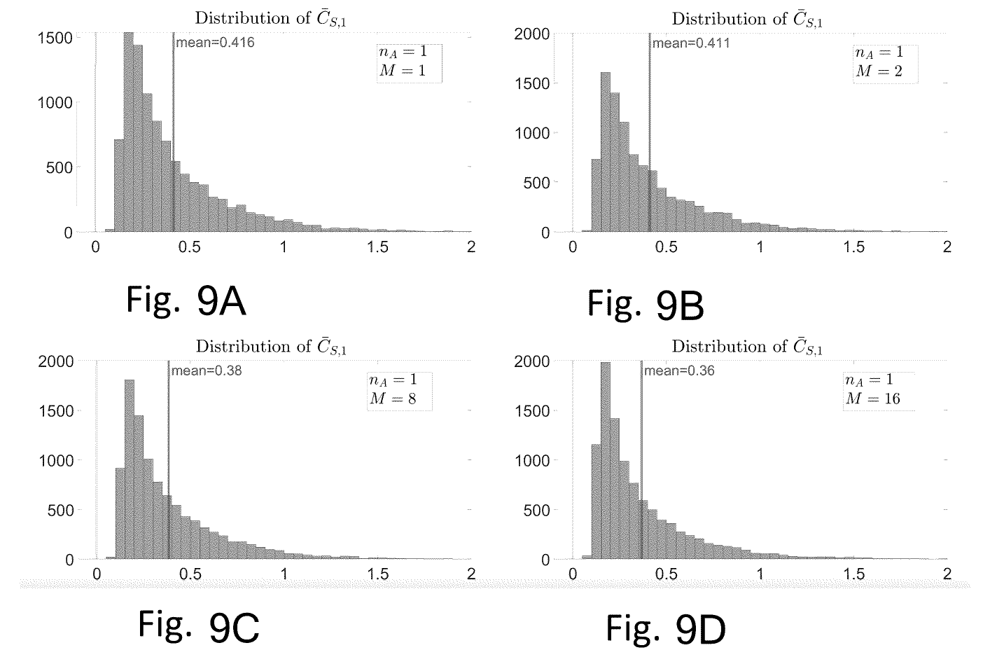

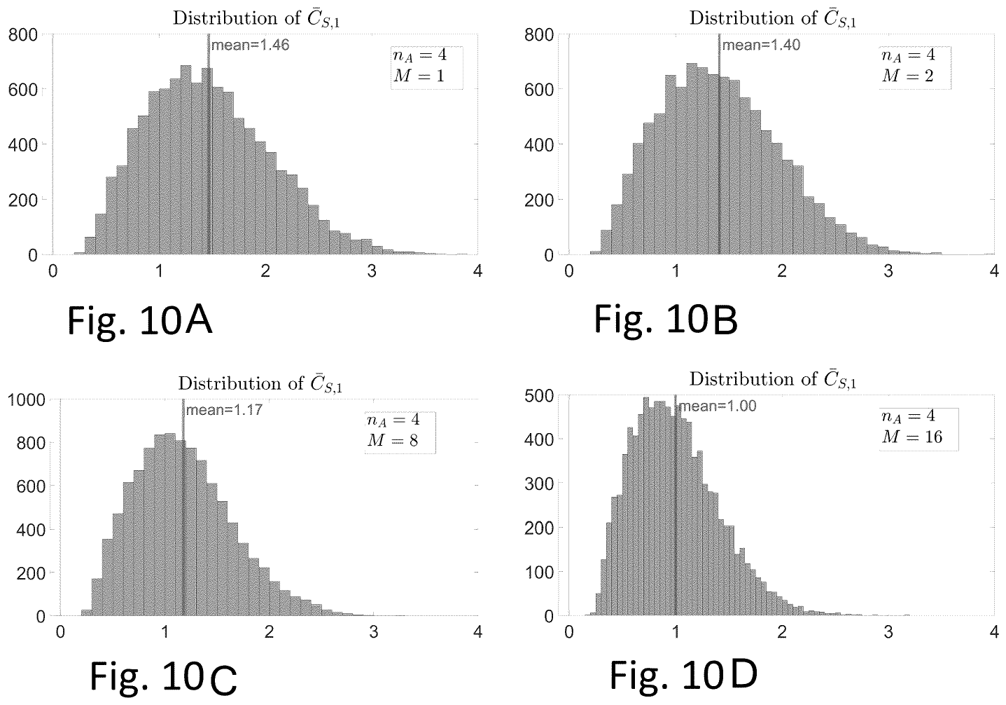

Now discussed is the secrecy capacity of MA-STEEP for each UE is also almost always positive even if M>1 provided p_{B}>>P_{A}. (Regardless of AP's power capacity, P_{A} for the probing symbols can be always chosen to meet the above condition for any given p_{B}.) Since all UEs are now statistically equivalent, we will choose i=1 among i=1, . . . , M without loss of generality. In FIGS. 9A-9D and FIGS. 10A-10D, illustrate that the distributions of C̅_̅{̅s̅,̅1̅}̅ subject to p_{A}=10 dB and p_{B}=30 dB are virtually always positive. We also see that the mean of C̅_̅{̅s̅,̅1̅}̅ decreases as M increases, but the reduction rate of C̅_̅{̅s̅,̅1̅}̅ is significantly smaller than the increasing rate of M. For example, FIGS. 1A-1D shows that after M is increased from 1 to 16, the mean of C̅_̅{̅s̅,̅1̅}̅ is reduced by only 13.5%.

Unlike FIGS. 9A-9D where p_{A}=10 dB and p_{B}=30 dB, FIGS. 10A-10D show the distributions of C̅_̅{̅s̅,̅1̅}̅ subject to p_{A}=20 dB and p_{B}=30 dB. In this case, we see a small probability that C̅_̅{̅s̅,̅1̅}̅ becomes zero when n_{A} is small (i.e., n_{A}=1).

Illustration of the Threshold

[symbol]

Recall [symbol] in Equation (206) for n_{A}=1, which must be exceeded by AP's receive SNR

$${S}_{A , 1} = \frac{{p}_{B} {\vert {h}_{A , 1} \vert}^{2}}{2 {σ}_{A , 1}^{2}}$$

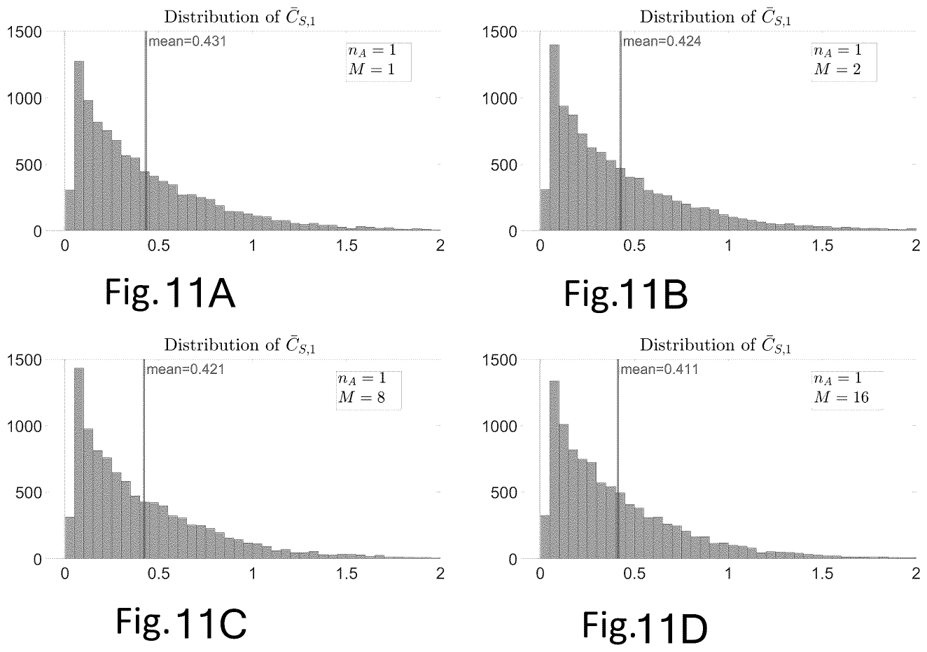

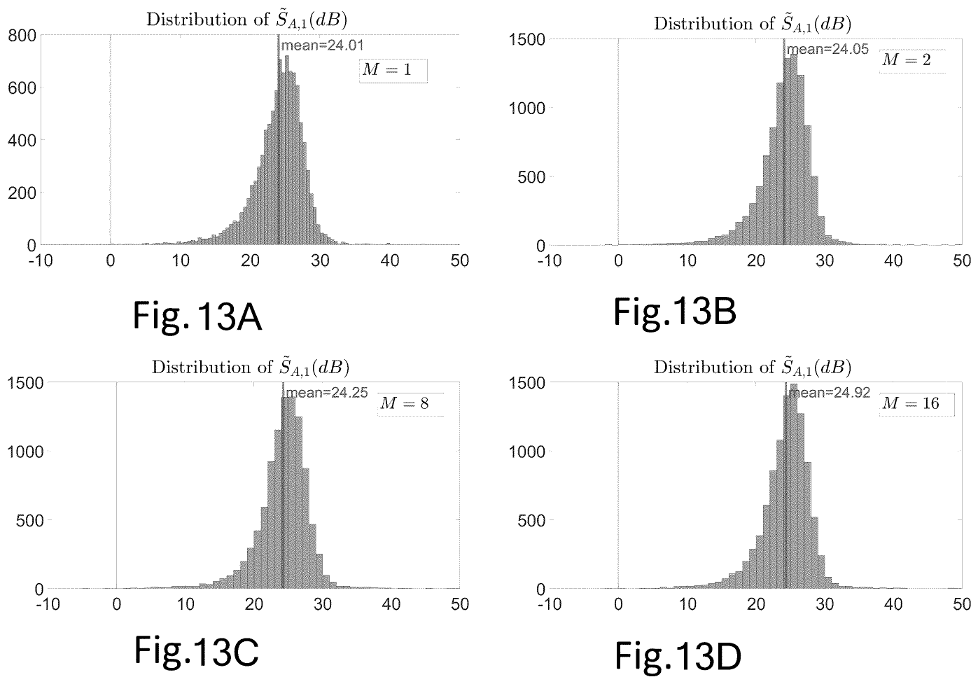

for the raw channel from UE₁ in order to achieve a positive secrecy rate for UE₁. FIGS. 13A-13D show the distributions of [symbol] in dB for n_{E}=4, p_{A}=20 dB and M=2, 4, 8, 16. We see that in these cases there is only a small probability that [symbol] is larger than 30 dB. We also see that the mean of [symbol] (dB) increases very slowly as M increases. This explains the small probability that C̅_̅{̅s̅,̅1̅}̅ becomes zero, as shown in FIGS. 11A-11D.

### Illustration of Total Secrecy Capacity C̅ₛ

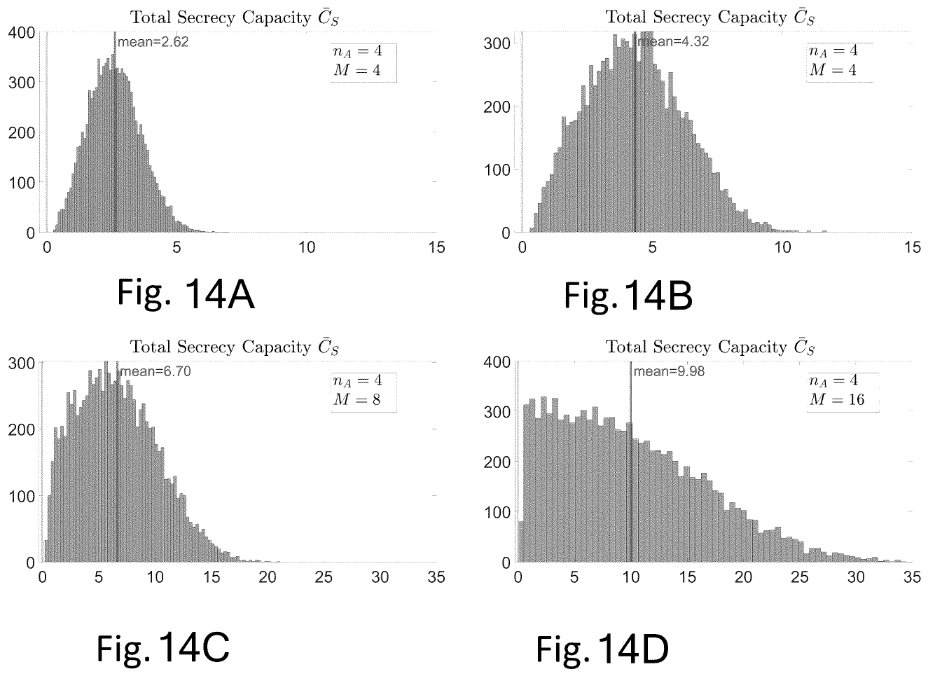

In FIGS. 14A-14D, show the distributions of C̅ₛ for M=2, 4, 8, 16 subject to n_{A}=n_{E}=4, p_{A}=10 dB and p_{B}=30 dB. Notice that FIG. 14A is the distribution of the sum of C̅_̅{̅s̅,̅1̅}̅ (as shown in FIG. 10B) and C̅_̅{̅s̅,̅2̅|̅1̅}̅. FIGS. 14A-14D suggest that the corresponding distribution of C̅_̅{̅s̅,̅2̅|̅1̅}̅ is also strongly positive. (Note that the bin size used for the distribution in FIG. 14A differs from that in FIG. 10B) However, we have also observed that if n_{A}<n_{E}, the probability for C̅_̅{̅s̅,̅2̅|̅1̅=̅0̅}̅ increases.

Since C̅ₛ in general has contributions from C̅_̅{̅s̅,̅i̅|̅1̅,̅ .̅ .̅ .̅ ,̅ i̅-̅1̅}̅ for all i=1, . . . , M, the mean value of C̅ₛ typically increases with M. This phenomenon differs from that for the common-nonce method at the networking layer, of which the total secrecy is no larger than a per-user secrecy. In other words, if Eve knows the secret message from one user, then she (who received all packets) knows the corresponding nonce and hence the secret messages from all users using the same nonce.

In this embodiment, discussed was MA-STEEP for secure multiple access from UEs to AP. MA-STEEP allows all UEs to effectively share a common stream of probes from AP, which makes MA-STEEP useful to meet future low-latency requirement. It has been shown that, using MA-STEEP subject to a power condition, the secrecy capacity from each UE to AP is positive with high probability and robust against an increasing number M of UEs, and the total secrecy capacity in general increases with M. Although the secrecy capacity loss from finite-length packets is not addressed in this paper, such a consideration would not change the novel advantage of MA-STEEP. To our knowledge, there has been no prior method which has similar properties as MA-STEEP.

### Secret-Message Transmission by Echoing Encrypted Probes-Additional Embodiment

As discussed previously, secret-message transmission from one node to another subject to eavesdropping has been a long-standing problem for secure communications, which is encountered widely in modern networks. The information-theoretical study of this problem, nowadays known as physical layer security, has a long history since the 1940's. Many achievements of great importance have been made by researchers in this field, which are centered around wiretap channel (WTC) and secret key generation (SKG). Yet, none teach how to produce a positive secrecy rate between Alice and Bob when the channel between them is half-duplex and always weaker than the receive channel at an eavesdropper (Eve). A few methods among the numerous works on SKG developed in the 1990's could tell us how to connect their developments to a WTC scheme in a broadly beneficial way. There appears a non-negligible disconnect between the numerous works on WTC and those on SKG.

One notable exception is offers a two-way protocol for a binary symmetric channel system is proposed to achieve a positive secrecy rate even if Eve's channel is stronger than users'.

As discussed previously, a general principle comprises two integral steps:

First, if Alice transmits independent realizations of a random integer X over a (memoryless) WTC system, and Bob and Eve receive the corresponding realizations of the random integers (binary or not) Y and Z, then it is known that the secret-key capacity C_{key} in bits per realization of {X, Y, Z} achievable by Alice and Bob via public communications satisfies

$$I ( X ; Y ) - I ( Y ; Z ) \leq {C}_{k e y} \leq I ( X ; Y \vert Z ) \qquad ( Equation 208 )$$

where I(X; Y|Z) (for example) denotes the mutual information between X and Y conditional on Z. This is also known as Maurer's bounds. In some cases, the upper and lower bounds coincide, i.e., C_{key}=I(X; Y)−I(Y; Z)=I(X; Y|Z) for a Gaussian case), which is generally positive regardless of the WTC secrecy capacity [I(X; Y)−(X; Z)]⁺ from Alice to Bob. Here x⁺≐ max(x, 0).

Second, given the random integers X, Y and Z at Alice, Bob and Eve respectively, an encryption lemma says that Bob can choose a uniform random integer S and transmit S⊕Y (a modulo sum of S and Y) via a public channel so that the secrecy rate of the effective WTC system from Bob to Alice equals/(X; Y)−I(Y; Z).

The above two-step principle is also a foundation for the embodiments above. However, STEEP as shown in this paper allows the following extensions: X, Y and Z are allowed to be real, complex, vectors and/or matrices; the modulo sum @ is allowed to be replaced by other suitable operations (examples will be shown); and the public channel from Bob to Alice and Eve may be replaced by any channels at the physical (or an upper) layer. Not necessarily all optimal in information theory, these extensions allow secure communications in a wider range of settings to be conducted rather simply with a guaranteed positive secrecy rate.

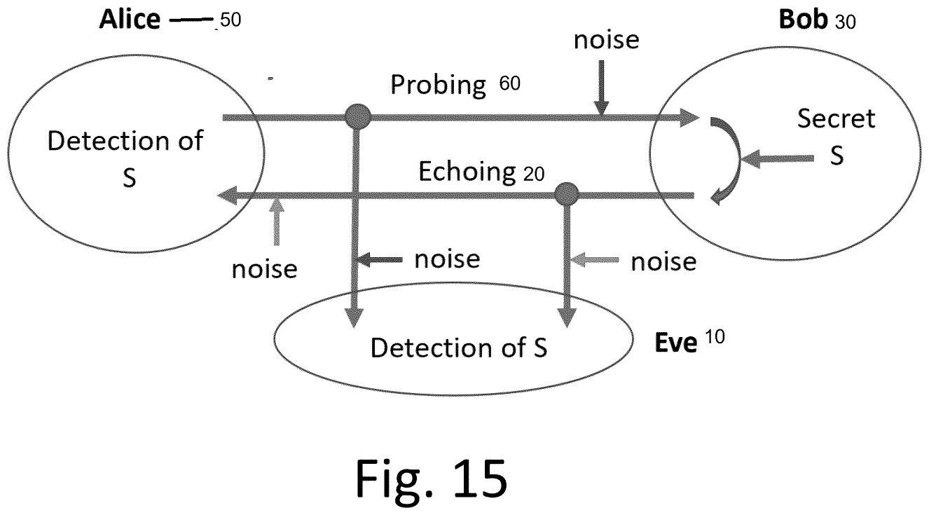

As illustrated in FIG. 15, there are two collaborative phases in STEEP. In phase 1 (or probing phase), random symbols or probes (step 60) are transmitted from Alice 50 to Bob 30. These probes arrive at Bob after a transformation by the channel response (step 20), which could result in some “effective” probes that can be estimated consistently (but not necessarily perfectly) by Bob 30. The exact definition of “effective probe” may vary, depending on how STEEP is implemented.

In phase 2 (or echoing phase) of STEEP, Bob's estimates of the effective probes are encrypted or combined with secret message symbols before they are transmitted (“echoed” back) to Alice. These collaborative two-phase operations result in an effective WTC system from Bob to Alice and Eve, which is almost surely in favour of the users subject to a sufficient power from Bob.

STEEP is a collaborative round-trip scheme between half-duplex nodes, which has a broad applicability and differs from many two-way full-duplex schemes in the prior art.

This embodiment provides a description of STEEP in its latest forms.

The primary contributions include novel insights into STEEP in three different settings. The first setting (or G-STEEP) uses Gaussian channel probing (GCP) and Gaussian linear encryption (GLE) over MIMO channels between two users, for which an achievable secrecy rate C_{s,G} is derived and analyzed. In particular, C_{s,G} is shown to converge to the secret-key capacity C_{key} based on GCP over MIMO channels if the echoing power in G-STEEP dominates the probing power and both become large.

The second setting (or P-STEEP) uses phase-shift-key (PSK) channel probing and PSK nonlinear encryption between two users, for which an achievable secrecy rate C_{s,P} is also presented. The third setting (or M-STEEP) uses GCP and GLE over multiple access channels between an access point (AP) and multiple users all of whom apply the same probes from the AP. An achievable secrecy rate C_{s,1} of M-STEEP from an arbitrary user to AP is shown to be a function that decreases gradually with some robustness (instead of abruptly) as the number M of users increases. In each setting, the achievable secrecy rate of STEEP is shown to be positive subject to a sufficiently large power in the echoing phase. Note that “capacity” and “achievable rate” are treated interchangeably in this paper since each stated achievable rate is the maximum possible under stated conditions.

The discussion is organized as follows. The physical-layer channel models of interest in this paper are described. G-STEEP, P-STEEP and M-STEEP are presented and analyzed respectively.

### Channel Models

Assume that the numbers of antennas on Alice, Bob and Eve are respectively n_{A}, n_{B} and n_{E}. In the case of wireline communications, each antenna here corresponds to a transceiver.

When Alice transmits (within a coherence time [symbol] ) a sequence of random vectors

$$\sqrt{\frac{{p}_{A}}{{n}_{A}} {x}_{A}} ( k ) ∈ {𝒞}^{{𝓃}_{𝒜} \times 1}$$

of power p_{A}, we assume that Bob and Eve receive respectively

$${y}_{B} ( k ) = \sqrt{{p}_{A} / {n}_{A} {H}_{B A {x}_{A}}} ( k ) + {w}_{B} ( k ) \qquad ( Equation 209 )$$

$${y}_{E A} ( k ) = \sqrt{{p}_{A} / {n}_{A} {H}_{E A {x}_{A}}} ( k ) + {w}_{E A} ( k ) \qquad ( Equation 210 )$$

where all noises are normalized circular complex Gaussian noises, i.e., w_{B}(k) is [symbol] (0, Iₙ_{_{B}}) and w_{EA}(k) is [symbol] (0, Iₙ_{_{E}}). For notational simplicity, we will also use the scaled versions of H_{BA} and H_{EA}, i.e.,

$${H}_{B A}^{′} \approx \sqrt{{p}_{A} / {n}_{A} {H}_{B A}} ∈ {𝒞}^{{n}_{B} \times {n}_{𝒜}} {H}_{E A}^{′} \approx \sqrt{{p}_{A} / {n}_{A} {H}_{E A}} ∈ {𝒞}^{{n}_{E} \times {n}_{𝒜}} .$$

Here k is the sampling index.

Similarly, when Bob transmits (within a coherence time [symbol] ) a sequence of random vectors

$$\sqrt{\frac{{p}_{B}}{{n}_{B}} {x}_{B}} ( k ) ∈ {𝒞}^{{𝓃}_{ℬ} \times 1}$$

of power p_{B}, we assume that Alice and Eve receive respectively

$${y}_{A} ( k ) = \sqrt{{p}_{B} / {n}_{B} {H}_{A B {x}_{B}}} ( k ) + {w}_{A} ( k ) \qquad ( Equation 211 )$$

$${y}_{E B} ( k ) = \sqrt{{p}_{B} / {n}_{B} {H}_{E B {x}_{B}}} ( k ) + {w}_{E B} ( k ) \qquad ( Equation 212 )$$

where the normalized noises w_{A}(k) and w_{EB}(k) are [symbol] (0, Iₙ_{_{A}}) and [symbol] (0, Iₙ_{_{E}}). We will also write

$${H}_{A B}^{′} = \sqrt{{p}_{B} / {n}_{B} {H}_{A B}} ∈ {𝒞}^{{𝓃}_{𝒜} \times {𝓃}_{ℬ}} and {H}_{EB}^{′} = \sqrt{{p}_{B} / {n}_{B} {H}_{E B}} ∈ {𝒞}^{{𝓃}_{ε} \times {𝓃}_{ℬ}} .$$

Alice and Bob are half-duplex. Namely, [symbol] and [symbol] do not overlap. But [symbol] and [symbol] may or may not belong to a common coherence period.

Each receive channel state information (CSI) is assumed to be known to the corresponding receiver. If there is any CSI feedback between Alice and Bob, this CSI is also assumed to be known to Eve. In fact, all CSI in this paper is treated as known to Eve.

Also assumed is that all signals and noises in each transmission direction (i.e., from Alice to Bob, or from Bob to Alice) are temporally independent.

So, for simpler notations, we will also drop the sampling (or slot) index “k”.

In this case, one should view the channel matrices as constant but the transmitted signals (and the noises) as random. The results on secrecy rates will be based on a large number of slots in each of probing and echoing phases.

In the case of temporally coded transmissions, the assumption of “temporal independence” could typically serve as an approximation.

STEEP with Gaussian Channel Probing and Gaussian Linear Encryption (G-STEEP)

In this section, G-STEEP is presented, and an achievable secrecy rate C_{s,G} of G-STEEP is also derived and discussed. Properties of C_{s,G} subject to large powers are highlighted.

Given n_{A}>n_{B}, the probing phase should be from Alice to Bob in order to have the largest C_{s,G}. This is because the degree of freedom (DoF) of the secret-key capacity C_{key} based on channel probing from a node with more antennas is larger than that from a node with less antennas. Such a connection between C_{s,G} and C_{key} will also be shown.

### Phase 1 of G-STEEP

In phase 1, Alice applies Gaussian probing, i.e., she transmits a realization of the random probing vector

$$\sqrt{\frac{{p}_{A}}{{n}_{A}} {x}_{A}}$$

in each probing slot where x_{A} is assumed to be [symbol] (0, Iₙ_{_{A}}). The corresponding signal received by Bob is y_{B} in Equation (211) (with “(k)” dropped). Let the (thin) SVD of H_{BA} be

$${U}_{BA {Π}_{B A {V}_{B A}^{H}}} = {\sum }_{i = 1}^{{n}_{B}} {π}_{B A , i {u}_{BA , {iv}_{BA , i}^{H}}} where {U}_{B A} = [ {u}_{BA , 1} , … , {u}_{B A , {n}_{B}} ] ∈ {𝒞}^{{𝓃}_{ℬ} \times {𝓃}_{ℬ}}$$

is unitary and

$${V}_{B A} = [ {v}_{BA , 1} , … , {v}_{B A , {n}_{B}} ] ∈ {𝒞}^{{𝓃}_{𝒜} \times {𝓃}_{ℬ}}$$

is column-wise orthonormal. Then we can write

$${y}_{B} = {U}_{BA {Π}_{B A}^{′} p} + {w}_{B} \qquad ( Equation 213 )$$

with

$${Π}_{B A}^{′} = \sqrt{{p}_{A} / {n}_{A} {Π}_{B A}} .$$

### Here

$$p \dot{=} {V}_{B A}^{H {x}_{A}}$$

which is here by definition the effective probing vector at Bob. Clearly, p is [symbol] (0, Iₙ_{_{B}}) given x_{A} being [symbol] (0, Iₙ_{_{A}}).

Given the Gaussian signal and noise model, the MMSE (minimum-mean-squared-error) estimate \hat{p} of p by Bob is linear and given by

$$\hat{p} = E \{ p {y}_{B}^{H} \} {( E \{ {y}_{B} {y}_{B}^{H} \} )}^{- 1} {y}_{B} = {Π}_{B A}^{′} {{U}_{B A}^{H} ( {U}_{BA {Π}_{B A}^{{}_{′2 {U}_{BA}^{H}}}} + {I}_{{n}_{B}} )}^{- 1 {y}_{B ∖}} = {{Π}_{B A}^{′} ( {Π}_{B A}^{′2} + {I}_{{n}_{B}} )}^{- 1 {U}_{B A}^{H {y}_{B}}} \qquad ( Equation 214 )$$

and

$${R}_{\hat{p}} \dot{=} E \{ \hat{p} {\hat{p}}^{{}_{H}} \} = {{Π}_{B A}^{′2} ( {Π}_{B A}^{′2} + {I}_{{n}_{B}} )}^{- 1} .$$

The operator E denotes the expectation.

The MSE matrix of \hat{p} is

$${R}_{Δ p} \dot{=} 𝔼 \{ ( \hat{p} - p ) , ( \hat{p} - {p}^{H} ) \} = {I}_{{n}_{B}} - {{π}_{BA}^{′} ( {π}_{BA}^{′2} + {I}_{{n}_{B}} )}^{- 1} {π}_{BA}^{′} = {( {π}_{BA}^{′2} + {I}_{{n}_{B}} )}^{- 1} = {I}_{{n}_{B}} - {R}_{\hat{p}} \qquad ( Equation 215 )$$

which is diagonal with the ith diagonal element being

$$\frac{1}{{π}_{B A i}^{′2} + 1} = 𝒪 ( 1 / {p}_{A} ) .$$

### Phase 2 of G-STEEP

In phase 2, Bob applies Gaussian linear encryption, i.e., he transmits

$$\sqrt{\frac{{p}_{B}}{2 {n}_{B}} {x}_{B}} = \sqrt{\frac{{p}_{B}}{2 {n}_{B}}} ( \hat{p} + s )$$

where the secret message vector s is assumed to be [symbol] (0, Iₙ_{_{B}}). Here p_{B} is the upper bound of the total transmit power from Bob. The corresponding signal received by Alice is

$${y}_{A} = {H}_{A B}^{″} ( \hat{p} + s ) + {w}_{A} \qquad ( Equation 216 )$$

with

$${H}_{A B}^{″} = \sqrt{1 / 2 {H}_{A B}^{′}} = \sqrt{{p}_{B} / ( 2 {n}_{B} ) {H}_{A B}} .$$

Assume that Alice and Eve both know the feedback of V_{BA} from Bob. Then, Alice also knows the effective probing vector

$$p = {V}_{B A}^{H {x}_{A}} .$$

Note that if n_{A}=n_{B}=1, then VBA would reduce to one and hence the above mentioned feedback would not be needed.

The MMSE estimate of s by Alice from y_{A} (and from her knowledge of the exact x_{A}) can be based on this zero-mean sufficient statistic Δy_{A}≐y_{A}− [symbol] {y_{A}|x_{A}}, which can be shown to be

$$Δ {y}_{A} = {y}_{A} - {H}_{A B}^{″} {R}_{\hat{p} p} \qquad ( Equation 217 )$$

Then the MMSE estimate of s by Alice is

$${\hat{s}}_{A} = {{H}_{AB}^{″ H} ( {H}_{AB}^{″} ( {R}_{Δ p ′} + {I}_{{n}_{B}} ) {H}_{AB}^{″ H} + {I}_{{n}_{A}} )}^{- 1} Δ {y}_{A} \qquad ( Equation 218 )$$

$$Here$$

$$Δ {p}^{′} \dot{=} \hat{p} - {R}_{\hat{p}} p = {R}_{Δ p} \hat{p} + {R}_{\hat{p}} Δ p \qquad ( Equation 219 )$$

$$and$$

$${R}_{Δ {p}^{′}} \dot{=} 𝔼 \{ Δ {p}^{′} Δ {p}^{′ H} \} = {R}_{Δ p} {R}_{\hat{p}} {R}_{Δ p} + {R}_{\hat{p}} {R}_{Δ p} {R}_{\hat{p}} = {R}_{\hat{p}} {R}_{Δ p} \qquad ( Equation 220 )$$

Then the MSE matrix of ŝ_{A} is

$${R}_{Δ {s}_{A}} \dot{=} 𝔼 \{ ( {\hat{s}}_{A} - {s}_{A} ) {( {\hat{s}}_{A} - {s}_{A} )}^{H} \} = {I}_{{n}_{B}} - {{H}_{AB}^{″ H} ( {H}_{AB}^{″} ( {R}_{Δ {p}^{{}_{′}}} + {I}_{{n}_{B}} ) {H}_{AB}^{{{}_{″ H}}^{}} + {I}_{{n}_{A}} )}^{- 1} {H}_{AB}^{{{}_{″}}^{}} = {I}_{nB} - {( {H}_{AB}^{{{}_{″ H}}^{}} {H}_{AB}^{{{}_{″}}^{}} ( {R}_{Δ {p}^{{}_{′}}} + {I}_{{n}_{B}} ) + {I}_{{n}_{B}} )}^{- 1} {H}_{AB}^{″ H} {H}_{AB}^{″} = {( {H}_{AB}^{{{}_{″ H}}^{}} {H}_{AB}^{{{}_{″}}^{}} ( {R}_{Δ {p}^{{}_{′}}} + {I}_{{n}_{B}} ) + {I}_{{n}_{B}} )}^{- 1} \cdot ( + ) \qquad ( Equation 221 )$$

Effective Channel Capacity from Bob to Alice

The effective channel capacity from Bob to Alice relative to s (in bits per round-trip symbol interval) is therefore

$${C}_{A \vert B , G} \dot{=} I ( s ; \{ {x}_{A} , {y}_{A} \} ) = I ( s ; {\hat{s}}_{A} ) = log \frac{1}{\vert {R}_{Δ {s}_{A}} \vert} = log \frac{\vert {H}_{AB}^{″ H} {H}_{AB}^{″} ( {R}_{Δ {p}^{′}} + {I}_{{n}_{B}} ) + {I}_{{n}_{B}} \vert}{\vert {H}_{AB}^{″ H} {H}_{AB}^{″} {R}_{Δ {p}^{′}} + {I}_{{n}_{B}} \vert} \dot{=} log \frac{{N}_{A \vert B}}{{D}_{A \vert B}} \qquad ( Equation 222 )$$

where N_{A|B} and D_{A|B} are defined in the obvious way.

Here |A| denotes the determinant of A. Notice that S, x_{A}, y_{A} are jointly Gaussian so that the 2nd and 3rd equalities in Equation (222) hold. Note that for p_{A}→0 or ∞, R_{Δp′}→0, and hence

$${C}_{A \vert B , G} \to log \vert {H}_{AB}^{″ H {H}_{AB}^{″}} + {I}_{{n}_{B}} \vert .$$

Effective Channel Capacity from Bob to Eve

After phases 1 and 2 of G-STEEP, the signals received by Eve are

$${y}_{EA} = {H}_{EA}^{′} {x}_{A} + {w}_{EA} \qquad ( Equation 223 )$$

$${y}_{E B} = {H}_{EB}^{″} ( \hat{p} + s ) + {w}_{EB} . \qquad ( Equation 224 )$$

It follows that

$$A \dot{=} 𝔼 \{ {y}_{EA} {y}_{EA}^{H} \} = {H}_{EA}^{′} {H}_{EA}^{′ H} + {I}_{{n}_{E}} \qquad ( Equation 225 )$$

$$B \dot{=} 𝔼 \{ {y}_{EB} {y}_{EB}^{H} \} = {H}_{EB}^{″} ( {R}_{\hat{p}} + {I}_{{n}_{B}} ) {H}_{EB}^{″ H} + {I}_{{n}_{E}} \qquad ( Equation 226 )$$

$$C \dot{=} 𝔼 \{ {y}_{EA} {y}_{EB}^{H} \} = {H}_{EA}^{′} {R}_{{x}_{A} , \hat{p}} {H}_{EB}^{″ H} . \qquad ( Equation 227 )$$

where

$${R}_{{x}_{A} , \hat{p}} \dot{=} 𝔼 \{ {x}_{A} {\hat{p}}^{{}_{Η}} \} . Let Q \dot{=} [ {V}_{BA} , {V}_{BA}^{⊥} ] ∈ {𝒞}^{{n}_{A} \times {n}_{A}}$$

be a unitary matrix. Then

$$\vert {R}_{{x}_{A} , \hat{p}} = 𝔼 \{ Q {Q}^{H} {x}_{A} {\hat{p}}^{{}_{H}} \} = Q 𝔼 \{ [ \begin{matrix}{V}_{B A}^{H} {x}_{A} {\hat{p}}^{{}_{H}} \\ {V}_{B A}^{⊥ H} {x}_{A} {\hat{p}}^{{}_{H}}\end{matrix} ] \} = Q [ \begin{matrix}{R}_{\hat{p}} \\ 0\end{matrix} ] = {V}_{BA} {R}_{\hat{p}} \vert , \qquad ( Equation 228 )$$

where we have used

$$E \{ p {\hat{p}}^{{}_{H}} \} = E \{ \hat{p} {\hat{p}}^{{}_{H}} \} = {R}_{\hat{p}} and {V}_{B A}^{⊥ HE} \{ {x}_{A {\hat{p}}^{{}_{H}}} \} = 0.$$

The MMSE estimate of s by Eve from y_{EA} and y_{EB} is

$${\hat{s}}_{E} = \vert {[ {0}_{{n}_{B} \times {n}_{E}} , {H}_{EB}^{″ H} ] [ \begin{matrix}A & C \\ {C}^{H} & B\end{matrix} ]}^{- 1} [ \begin{matrix}{y}_{EA} \\ {y}_{EB}\end{matrix} ] \qquad ( Equation 229 )$$

and the MSE matrix of ŝ_{E} is

$${R}_{Δ {s}_{E}} \dot{=} 𝔼 \{ ( {\hat{s}}_{E} - s ) {( {\hat{s}}_{E} - s )}^{H} \} = {I}_{{n}_{B}} - {[ {0}_{{n}_{S} \times {n}_{E}} , {H}_{EB}^{″ H} ] [ \begin{matrix}A & C \\ {C}^{H} & B\end{matrix} ]}^{- 1} [ \begin{matrix}{0}_{{n}_{E} \times {n}_{S}} \\ {H}_{EB}^{″}\end{matrix} ] = {I}_{{n}_{B}} - {{{H}^{\text{?}}}_{EB}^{{}_{{}_{{}_{{}_{{}_{{}_{″ H}}}}}}} ( {B}^{\text{?}} - {C}^{\text{?}} {{}^{H}}^{{}_{}} {{A}^{}}^{\text{?}} {}^{- \ddot{1}} C )}^{- 1} {H}_{EB}^{″} \qquad ( Equation 230 )$$

$$\text{?} \text{indicates text missing or illegible when filed}$$

It follows from Equation (226) and Equation (227) that

$${C}^{{HA}^{- 1 C}} = {H}_{E B}^{″} T {H}_{E B}^{″ H} \qquad ( Equation 231 )$$

$$with$$

$$T = {R}_{{x}_{A} , \hat{p}}^{H} {{H}_{EA}^{′ H} ( {H}_{EA}^{′} {H}_{EA}^{′ H} + {I}_{{n}_{E}} )}^{- 1} {H}_{EA}^{′} {R}_{{x}_{A} , \hat{p}} = {R}_{\hat{p}}^{H} {{V}_{BA}^{H} ( {H}_{EA}^{′ H} {H}_{EA}^{′} + {I}_{{n}_{A}} )}^{- 1} {H}_{EA}^{′ H} {H}_{EA}^{′} {V}_{B A} {R}_{\hat{p}} . \qquad ( Equation 232 )$$

$$Let$$

$${R}_{Δ {\hat{p}}_{E}} \dot{=} {R}_{\hat{p}} - T \qquad ( Equation 233 )$$

which is the MSE matrix of the MMSE estimate \hat{p}_{E} of \hat{p} from y_{EA}. Hence,

$$T = {R}_{{\hat{p}}_{E}} \dot{=} E \{ {\hat{p}}_{E {\hat{p}}_{E}^{H}} \} .$$

$$Note {lim}_{{p}_{A} \to 0 {R}_{Δ {{\hat{p}}_{E}}_{}}} = 0 .$$

Then Equation (230) becomes

$$\cdot {( {H}_{E B}^{″} ( {R}_{Δ {\hat{p}}_{E}} + {I}_{{n}_{B}} ) {H}_{E B}^{″ H} + {I}_{{n}_{E}} )}^{- 1} {H}_{E B}^{″} = {I}_{{n}_{B}} - {( {H}_{E B}^{″ H} {H}_{E B}^{″} ( {R}_{Δ {\hat{p}}_{E}} + {I}_{{n}_{B}} ) + {I}_{{n}_{B}} )}^{- 1} {H}_{E B}^{″ H} {H}_{E B}^{″} = {( {H}_{E B}^{″ H} {H}_{E B}^{″} ( {R}_{Δ {\hat{p}}_{E}} + {I}_{{n}_{B}} ) + {I}_{{n}_{B}} )}^{- 1} \cdot ( {H}_{E B}^{″ H} {H}_{E B}^{″} {R}_{Δ {\hat{p}}_{E}} + {I}_{{n}_{B}} ) \qquad ( Equation 234 )$$

Hence the capacity of the effective return channel from Bob to Eve relative to s (in bits per round-trip symbol interval) is

$${C}_{E \vert B , G} \dot{=} I ( s ; \{ {y}_{EA ,} {y}_{EB} \} ) = I ( s ; {\hat{s}}_{E} ) = log \frac{1}{\vert {R}_{Δ {s}_{E}} \vert} = log \frac{\vert {H}_{E B}^{″ H} {H}_{E B}^{″} ( {R}_{Δ {\hat{p}}_{E}} + {I}_{{n}_{B}} ) + {I}_{{n}_{B}} \vert}{\vert {H}_{E B}^{″ H} {H}_{E B}^{″} {R}_{Δ {\hat{p}}_{E}} + {I}_{{n}_{B}} \vert} \dot{=} log \frac{{N}_{E \vert B}}{{D}_{E \vert B}} . \qquad ( Equation 235 )$$

Again applied is the jointly Gaussian nature of s, y_{EA}, y_{EB} for the 2nd and 3rd equalities in Equation (235).

### Secrecy Capacity of G-STEEP

Theorem 1: An achievable secrecy rate of G-STEEP based on the effective wiretap-channel system from Bob to Alice against Eve (in bits per round-trip symbol interval) is

$${C}_{s , G} \dot{=} {( I ( s ; \{ {x}_{A} , {y}_{A} \} ) = I ( s ; \{ {y}_{EA ,} {y}_{EB} \} ) )}^{+} = {( {C}_{A \vert B , G} - {C}_{E \vert B , G} )}^{+} = {( log \frac{{N}_{A \vert B} {D}_{E \vert B}}{{D}_{A \vert B} {N}_{E \vert B}} )}^{+} = {[ log ( \frac{\vert {H}_{AB}^{″ H} {H}_{AB}^{″} ( {R}_{Δ {p}^{′}} + {I}_{{n}_{B}} ) + {I}_{{n}_{B}} \vert}{\vert {H}_{AB}^{″ H} {H}_{AB}^{″} {R}_{Δ {p}^{′}} + {I}_{{n}_{B}} \vert} \cdot \frac{\vert {H}_{E B}^{″ H} {H}_{E B}^{″} {R}_{Δ {\hat{p}}_{E}} + {I}_{{n}_{B}} \vert}{\vert {H}_{E B}^{″ H} {H}_{EB}^{″} ( {R}_{Δ {\hat{p}}_{E}} + {I}_{{n}_{B}} ) + {I}_{{n}_{B}} \vert} ) ]}^{+} . \qquad ( Equation 236 )$$

where R_{Δp′} is given in Equation (220), and R_{Δ\hat{p}}_{E} is given in Equation (233).

Proof: This follows from the WTC theory for Gaussian channels with respect to the message s from Bob, and the previous results shown in Equation (222) and Equation (235).

One may argue that the secret-key capacity based on {x_{A}, y_{A}} at Alice, {y_{B}, s} at Bob and {y_{EA}, y_{EB}} at Eve after both phases of G-STEEP (and using additional and iterative operations for information reconciliation and privacy amplification via public communications) should be larger than or equal to C_{s,G}.

Corollary 1: If n_{B}=1 and H_{AB}, H_{BA} and H_{EB} are replaced by h_{AB}, h_{BA} and h_{EB} (similarly for their scaled versions), then C_{s,G}≐(C_{A|B,G}−C_{E|B,G})⁺ with

$${C}_{A \vert B , G} = log ( 1 + \frac{\frac{{S}_{A B}}{2}}{\frac{1 {S}_{A B} {S}_{B A}}{2 {( {S}_{B A} + 1 )}^{2}} + 1} ) \qquad ( Equation 237 )$$

$${C}_{E \vert B , G} = log ( 1 + \frac{\frac{{S}_{E B}}{2}}{( {σ}_{2}^{} - t ) \frac{{S}_{E B}}{2} + 1} ) \\ where \\ {S}_{A B} = \vert {h}_{A B}^{′} {\vert}^{2} , {S}_{B A} = \vert {h}_{B A}^{′} {\vert}^{2} , {S}_{E B} = \vert {h}_{E B}^{′} {\vert}^{2} , {σ}_{2}^{} = \frac{{S}_{B A}}{{S}_{BA} + 1} \qquad ( Equation 238 )$$

$$and$$

$$t = {r}^{H} {{H}_{EA}^{′ H} ( {H}_{E A}^{′} {H}_{EA}^{′ H} + {I}_{{n}_{E}} )}^{- 1} {H}_{E A}^{′} r \\ with \\ r = {σ}_{2}^{} \frac{1}{\vert {h}_{B A} \vert} {h}_{B A}^{*} . \qquad ( Equation 239 )$$

Proof: This follows from Theorem 1. In particular, T in Equation 232 is now reduced to the scalar t.

It is seen that for the case of n_{B}=1, the effects of

$${h}_{A B}^{′} , {h}_{B A}^{′} and {h}_{E B}^{′}$$

on C_{s,G} are only through their norms. The effect of

$${H}_{E A}^{′}$$

on C_{s,G} is only through the scalar t.

### Properties of C_{s,G}

Assuming constant channel matrices, the secret-key capacity C_{key} (in bits per probing symbol interval) based on the data sets at Alice, Bob and Eve after phase 1 of G-STEEP (and a public communication phase after that) is

$${C}_{key} = log \vert {I}_{{n}_{A}} + {H}_{BA}^{′ H} {{H}_{BA}^{′} ( {H}_{EA}^{′ H} {H}_{E A}^{′} + {I}_{{n}_{A}} )}^{- 1} \qquad ( Equation 240 )$$

Proof: This follows from Theorem 1 where Maurer's lower and upper bounds, applied asymptotically to continuous sources via generalized mutual information, are used. C_{key} here is ξ_{B} in Equation (215) with constant channel matrices, and H_{EA} and

$$\frac{{p}_{A}}{{n}_{A}}$$

here are G_{A} and γ_{BA}. Furthermore, λ_{B} and λ_{EA} are both normalized to be one here.

Note that C_{key} is the maximum secret-key rate achievable based on the data sets generated in phase 1 of G-STEEP at Alice, Bob and Eve and through communications in the public network (where Eve has access to all communications). So, if Eve's receive channel from Bob is no weaker than Alice's receive channel from Bob (in phase 2 of G-STEEP), we should expect C_{s,G}≤C_{key}. If C_{s,G} approaches C_{key} under high powers, we can say that C_{s,G} is optimal against strong Eve under high powers.

But if Eve's receive channel from Bob is weaker than that at Alice, it is possible to have C_{s,G}>C_{key}. But one should not be excited by this situation. We know that C_{key} is based on the assumption that all communications for secret key generation are done in the public domain. If any of these communications are not public, the resulting C_{key} would be higher. So, for a meaningful comparison between C_{s,G} and C_{key}, we should assume that Eve's receive channel in phase 2 of G-STEEP is no weaker than that at Alice.

Proposition 1: Assume that H_{AB}, H_{BA}, H_{EA} and H_{EB} are typical realizations (where the rank of each matrix equals to the minimum of its numbers of rows and columns and the rank conditions. For n_{A}≥n_{B}, n_{E}≥1 and any given (fixed)

$${η}_{p} = \frac{{p}_{B}}{{p}_{A}} ,$$

$${lim}_{{p}_{A \to ∞}} \frac{1}{log {p}_{A}} {C}_{s , G} = {lim}_{{p}_{A \to ∞}} \frac{1}{log {p}_{A}} {C}_{k e y} = min ( {n}_{B} , {( {n}_{A} - {n}_{E} )}^{+} ) \qquad ( Equation 241 )$$

i.e., DoF(C_{s,G})=DoF(C_{key}). Namely, C_{s,G} is optimal in DoF.

The DoF only depends on the numbers of antennas on Alice, Bob and Eve, which is not affected by any finite scaling on channel matrices and/or on noise variances.

Proposition 2: Assume typical realizations of all channel matrices (like those in Proposition 1).

$${lim}_{{p}_{A} \to ∞} ( {lim}_{{p}_{B} \to ∞} {C}_{s , G} ) = {lim}_{{p}_{A} \to ∞} {C}_{key} = log \vert {I}_{{n}_{B}} + {\prod }_{BA}^{2} {{V}_{BA}^{H} ( {H}_{EA}^{H} {H}_{EA} )}^{- 1} {V}_{BA} \vert \qquad ( Equation 242 )$$

Namely, C_{s,G} is optimal (against strong Eve) asymptotically as

$${p}_{A} \to and \frac{{p}_{B}}{{p}_{A}} \to .$$

The above proposition is also intuitively justified if we think of

$$\frac{{p}_{B}}{{p}_{A}} \to$$

as somewhat similar to the case where phase 2 of G-STEEP only uses public communications and also think of p_{A}→ as somewhat similar to the case where the encryption in phase 2 is done via a modulo sum between two discrete random variables. In other words, for

$$\frac{{p}_{B}}{{p}_{A}} \to ,$$

both Alice and Eve would receive the same \sqrt{p_{B}}(\hat{p}+s) from Bob, i.e., the phase 2 would be via a public channel. For p_{B}→, \sqrt{p_{B}}(\hat{p}+s)=\sqrt{p_{B}\hat{p}}+\sqrt{p_{B}s} is a sum between \sqrt{p_{B}\hat{p}} and \sqrt{p_{B}s} (which would be virtually uniformly distributed), and this sum would be like a modulo-sum with an infinite modulo. Then the encryption lemma would suggest that in the case of

$${p}_{A} \to ∞ and \frac{{p}_{B}}{{p}_{A}} \to ∞ , {C}_{key} = {C}_{s , G} .$$

Since the limit in Equation 249 is always positive (unless H_{EA} has an infinite norm), this proposition also suggests that for a sufficiently large (but finite) p_{A} and a sufficiently large (but finite)

$$\frac{{p}_{B}}{{p}_{A}} ,$$

C_{s,G} is positive. We will see a more specific case of this next.
The Special Case of n_{A}=n_{B}=1

For n_{A}=n_{B}=1, we let H_{AB}, H_{BA}, H_{EA} and H_{EB} be replaced by h_{AB}, h_{BA}, h_{EA} and h_{EB}. Then it follows that

$${C}_{s , G} = {[ log ( 1 + \frac{b / 2}{{bA}_{1} / 2 + 1} ) - log ( 1 + \frac{β b / 2}{β {bA}_{2} / 2 + 1} ) ]}^{+} \qquad ( Equation 243 )$$

with

$$a \dot{=} {S}_{BA} \dot{=} {p}_{A} {\vert {h}_{BA} \vert}^{2} = {\vert {h}_{BA}^{′} \vert}^{2} and b \dot{=} {S}_{AB} \dot{=} {p}_{B} {\vert {h}_{AB} \vert}^{2} = {\vert {h}_{AB}^{′} \vert}^{2} .$$

### Also

$${A}_{1} = \frac{a}{{( a + 1 )}^{2}} and {A}_{2} = {A}_{1} \frac{( a + α a + 1 )}{α a + 1} with α \dot{=} \frac{{S}_{EA}}{{S}_{BA}} and β \dot{=} \frac{{S}_{EB}}{{S}_{AB}} .$$

### Furthermore,

$${S}_{EA} \dot{=} {p}_{A} {\vert {h}_{EA} \vert}^{2} = {\vert {h}_{EA}^{′} \vert}^{2} and {S}_{EB} \dot{=} {p}_{B} {\vert {h}_{EB} \vert}^{2} = {\vert {h}_{EB}^{′} \vert}^{2} .$$

Note that A₂>A₁ and they are invariant to b.

In this special case, all channel gains and noise variances are completely lumped into just four parameters: a, b, α and β. Here a and b are respectively the (raw channel) SNR at Bob in phase 1 and the (raw channel) SNR at Alice in phase 2. And a and b are proportional to p_{A} and p_{B} respectively. Furthermore, α and β are the SNR ratios measuring Eve's (raw) channel strengths over users' (raw) channel strengths in phases 1 and 2 respectively. It is important to distinguish between “raw channels” and “effective channels”, the latter of which are induced by STEEP.

In particular, if Eve's (raw) channel is stronger than users' (raw) channel in phase 1, then α>1; and if Eve's (raw) channel is stronger than users' (raw) channel in phase 2, then β>1. It is obvious that C_{s,G} increases as α and/or β decrease.

If α≥1 and β≥1, all conventional WTC schemes either from Alice to Bob or from Bob to Alice have zero secrecy capacity. (In the MIMO case, a similar conclusion can be drawn if n_{E}≥n_{A}≥n_{B} and the large-scale fading at Eve is smaller than those at Alice and Bob.)

Proposition 3: Assume n_{A}=n_{B}=1. Then C_{s,G}>0 if and only if

$$b > \overline{b} \dot{=} \frac{2 ( β - 1 )}{β ( {A}_{2} - {A}_{1} )} = \frac{2 ( β - 1 ) {( a + 1 )}^{2} ( α a + 1 )}{β {a}^{2}} . \qquad ( Equation ( 244 )$$

It is seen that as a (or equivalently p_{A}) either decreases to zero or increases to infinity, b̅ increases to infinity subject to β>1. But for α>1, β>1 and α>>1, we have

$$\overline{b} \approx 2 \frac{β - 1}{β} α a = 𝒪 ( a ) \qquad ( Equation 245 )$$

Hence, for α>1, β>1 and a given b (such as 20 dB to 30 dB in practice), the optimal value of α to maximize C_{s,G} is generally in between zero and b.

In practice, Equation (244) can be utilized to ensure a positive secrecy rate whenever an upper bound on a is available. In the case of random fading channels, the probability for Equation (244) not to hold can be kept small by keeping a large ratio of p_{B} over p_{A}.

1) Comparison to C_{key}: For n_{A}=n_{B}=1, Equation 240 reduces to

$${C}_{key} = log ( 1 + \frac{{S}_{BA}}{{S}_{EA} + 1} ) = log ( 1 + \frac{a}{α a + 1} ) = log \frac{{A}_{2}}{{A}_{1}} . \qquad ( Equation 246 )$$

It follows from Equation 243 that

$${lim}_{b \to ∞} {C}_{s , G} = {( log ( 1 + \frac{1}{{A}_{1}} ) - log ( 1 + \frac{1}{{A}_{2}} ) )}^{+} = {( log \frac{{A}_{2} ( {A}_{1} + 1 )}{{A}_{1} ( {A}_{2} + 1 )} )}^{+} < {C}_{key} \qquad ( Equation 247 )$$

Since C_{s,G} increases with b for β>1, then for β>1 we have C_{s,G}<C_{key} for all a, α and b. This is expected as discussed before.

However,

$${lim}_{a \to ∞} {C}_{key} = log ( 1 + \frac{1}{α} ) \qquad ( Equation 248 )$$

So, if both a and b are large but b dominates a, then C_{s,G}=C_{key}. This is a special case of Proposition 2.

$${lim}_{a \to ∞} ( {lim}_{b \to ∞} {C}_{s , G} ) = {lim}_{a \to ∞} {( log \frac{{A}_{2} ( {A}_{1} + 1 )}{{A}_{1} ( {A}_{2} + 1 )} )}^{+} = log ( 1 + \frac{1}{α} ) . \qquad ( Equation 249 )$$

STEEP with PSK Channel Probing and PSK Nonlinear Encryption (P-STEEP)

In this section, P-STEEP is presented assuming n_{A}=n_{B}=1 and n_{E}≥1.

It is important to note that for applications where power control is difficult (due to nonlinearity of power amplifier, channel disturbances, etc), nonlinear modulation such as PSK is always preferred to linear modulation.

A key difference between P-STEEP and G-STEEP is how the encryption is done by Bob on the estimated probes before they are echoed back.

### Operations at Alice and Bob

In phase 1 of P-STEEP, Alice sends out PSK probes \sqrt{p_{A}}x_{A}=\sqrt{p_{A}}e^{jθ} where θ is an M-ary discrete uniform random variable within [−π, π]. Then Bob receives

$${y}_{B} = \sqrt{{p}_{A}} {h}_{BA} {x}_{A} + {w}_{B} . \qquad ( Equation 250 )$$

A sufficient statistic from y_{B} for x_{A}=e^{jθ} (at Bob) is

$${r}_{B} \dot{=} \frac{1}{\sqrt{{p}_{A}} {h}_{BA}} {y}_{B} = {x}_{A} + {v}_{B} where \\ {v}_{B} is 𝒞𝒩 ( 0 , \frac{1}{{s}_{BA}} ) with {S}_{BA} = {p}_{A} {\vert {h}_{BA} \vert}^{2} . \qquad ( Equation 251 )$$

In phase 2 of P-STEEP, Bob applies PSK nonlinear encryption, i.e., he sends out

$$\sqrt{{p}_{B}} {x}_{B} = \sqrt{{p}_{B}} {e}^{j ϕ} {r}_{B}$$

where ϕ is a secret phase value (meant for Alice) randomly chosen from the same discrete constellation as θ. Here the construction of

$${x}_{B} = {e}^{j ϕ} {r}_{B}$$

is different from that for G-STEEP with n_{A}=n_{B}=1. This nonlinear encryption fits naturally with PSK (a nonlinear modulation).

It is important to note that while both θ and ϕ are discrete, r_{B} here is continuous. The use of continuous r_{B} (instead of a quantized r_{B} with the constellation size M) to construct x_{B}=e^{jϕ}r_{B} reduces the computational complexity at Bob (i.e., no detection is needed at Bob). It is however not clear whether this would yield a better secrecy rate than the quantized option. There is also a strategy in between “completely hard” and “completely soft”, i.e., replacing r_{B} by its quantized value with a constellation size equal to lM with l≥1. When l=1, we say that the quantized r_{B} is completely hard. As l becomes larger, the quantized r_{B} becomes “softer”. But in this paper, we only focus on continuous r_{B}.

Then Alice receives

$${y}_{A} = \sqrt{{p}_{B}} {h}_{AB} {x}_{B} + {w}_{A} \qquad ( Equation 252 )$$

A sufficient statistic from y_{A} for ϕ (at Alice) is

$${r}_{A} \dot{=} \frac{{x}_{A}^{*}}{\sqrt{{p}_{B}} {h}_{AB}} {y}_{A} = {e}^{j ϕ} + {e}^{j ϕ} {x}_{A}^{*} {v}_{B} + {x}_{A}^{*} {v}_{A} \\ where \\ {v}_{A} is 𝒞𝒩 ( 0 , \frac{1}{{s}_{AB}} ) with {S}_{AB} = {p}_{B} {\vert {h}_{AB} \vert}^{2} . \qquad ( Equation 253 )$$

Since v_{B} and v_{A} are independent circular complex Gaussian, we can also write

$${r}_{A} \dot{=} \frac{{x}_{A}^{*}}{\sqrt{{p}_{B}} {h}_{AB}} {y}_{A} = {e}^{j ϕ} + {v}_{B}^{′} + {v}_{A}^{′} \qquad ( Equation 254 )$$

where

$${v}_{B}^{′} and {v}_{A}^{′}$$

are independent of ϕ and each other, and they have the same distributions as v_{B} and v_{A}.

The minimum distance between the constellation points of e^{jϕ} is 2 sin π/M. Hence the error rate in detecting e^{jϕ} from r_{A} is (approximately for M=2^{m} with m≥2)

$${p}_{e , A} = {n}_{0} Q ( \frac{sin \frac{π}{M}}{{ϵ}_{A}} ) \qquad ( Equation 255 )$$

where n₀=1 for m=1, n₀=2 for m≥2,

$${ϵ}_{A} = \sqrt{\frac{1}{2 {S}_{BA}} + \frac{1}{2 {S}_{AB}}} \qquad ( Equation 256 )$$

and

$$Q ( x ) = {\int }_{x}^{∞} \frac{1}{\sqrt{2 π}} {e}^{- {u}^{2} / 2} du .$$

With Gray mapping of bits, p_{e,A} is also the (uncoded) secret-bit error rate suffered by Alice for all m≥1.

The effective capacity from Bob to Alice relative to ϕ is

$${C}_{A \vert B , P \dot{=} I ( ϕ ) ; {r}_{A} ) = H ( ϕ ) - H ( ϕ \vert {r}_{A} )} \qquad ( Equation 257 )$$

where H(ϕ)=log M (the entropy of ϕ).

To determine H(ϕ|r_{A}), we can view ϕ given r_{A} as the optimal decision of ϕ from r_{A}.

For M=2, the optimal decision of ϕ from r_{A} takes two possible values with the probabilities 1−p_{e,A} and p_{e,A} respectively. In this case,

$${C}_{A \vert B , P} = 1 - {h}_{2} ( {p}_{e , A} ) \qquad ( Equation 258 )$$

with h₂(p)≐−p log p−(1−p)log(1−p).

For M=2^{m} with m≥2, the optimal decision of ϕ from r_{A} takes approximately three possible values with the probabilities

$$1 - {p}_{e , A} , \frac{1}{2} {p}_{e , A} and \frac{1}{2} {p}_{e , A}$$

respectively. In this case, we can write

$${C}_{A \vert B , P} = m - {p}_{e , A} - {h}_{2} ( {p}_{e , A} ) \qquad ( Equation 259 )$$

with m≥2.

### Operations at Eve

After phases 1 and 2, the signals received by Eve are

$${y}_{EA} = \sqrt{{p}_{A} {h}_{EA}} {x}_{A} + {w}_{EA} \qquad ( Equation 260 )$$

$${y}_{EB} = \sqrt{{p}_{B} {h}_{EB}} {x}_{B} + {w}_{EB} \qquad ( Equation 261 )$$

or equivalently

$${r}_{EA} \dot{=} \frac{{h}_{EA}^{H}}{\sqrt{{p}_{A}} {\vert {h}_{EA} \vert}^{2}} {y}_{EA} = {x}_{A} + {v}_{EA} \qquad ( Equation 262 )$$

$${r}_{EB} \dot{=} \frac{{h}_{EB}^{H}}{\sqrt{{p}_{A}} {\vert {h}_{EB} \vert}^{2}} {y}_{EB} = {x}_{B} + {v}_{EB} \qquad ( Equation 263 )$$

Here v_{EA} is

$$𝒞𝒩 ( 0 , \frac{1}{{s}_{EA}} ) with {S}_{EA} = {p}_{A} {\vert {h}_{EA} \vert}^{2} , and$$

$${v}_{EB} is 𝒞𝒩 ( 0 , \frac{1}{{s}_{EB}} ) with {S}_{EB} = {p}_{B} {\vert {h}_{EB} \vert}^{2} .$$

Consider

$${r}_{E} \dot{=} {r}_{EA}^{*} {r}_{EB} = {e}^{j ϕ} + {x}_{A}^{*} {e}^{j ϕ} {v}_{B} + {x}_{A}^{*} {v}_{EB} + {v}_{EA}^{*} {e}^{j ϕ} {x}_{A} \qquad ( Equation 264 )$$

where ignored are the second-order terms of noises:

$${e}^{j ϕ} {v}_{EA}^{*} {v}_{B} and {v}_{EA}^{*} {v}_{EB} .$$

Since v_{B}, v_{EB}, and v_{EA} are independent circular complex Gaussian, it can be written

$${r}_{E} \dot{=} {r}_{EA}^{*} {r}_{EB} = {e}^{j ϕ} + {v}_{B}^{′} + {v}_{EB}^{′} + {v}_{EA}^{′} \qquad ( Equation 265 )$$

where

$${v}_{B}^{′} , {v}_{EB}^{′} and {v}_{EA}^{′}$$

are also independent circular complex Gaussian and are independent of ϕ and x_{A}, and they have the same distributions as v_{B}, v_{EB} and v_{EA} respectively.

Since {r_{EA}, r_{EB}} is a one-to-one function of {r_{EA}, r_{E}}, and r_{EA} is independent of r_{E} and ϕ, we now know that r_{E} is a sufficient statistic from {r_{EA}, e_{EB}} for ϕ.

So the optimal detection of e^{jϕ} from {r_{EA}, r_{EB}} is the same as that from r_{E}. We know that the error rate in detecting e_{jϕ} from r_{E} is (approximately for M=2^{m}≥4)

$${p}_{e , E} = {n}_{0} Q ( \frac{sin \frac{π}{M}}{{ϵ}_{E}} ) \\ where \qquad ( Equation 266 )$$

$${ϵ}_{E} = \sqrt{\frac{1}{2 {S}_{BA}} + \frac{1}{2 {S}_{EA}} + \frac{1}{2 {S}_{EB}}} \qquad ( Equation 267 )$$

It can be expressed The effective capacity can be expressed C_{E|B,P} from Bob to Eve relative to ϕ as

$${C}_{E \vert B , P = m - {p}_{e , E} - {h}_{2} ( {p}_{e , E} )} \qquad ( Equation 268 )$$

### Secrecy Capacity

The secrecy capacity of P-STEEP is

$${C}_{s , P} \dot{=} {( {C}_{A \vert B , P} - {C}_{E \vert B , P} )}^{+} = {h}_{2} ( {p}_{e , E} ) - {h}_{2} ( {p}_{e , A} ) \qquad ( Equation 269 )$$

which is positive if and only if p_{e,A}<p_{e,E} It is seen that p_{e,A}<p_{e,E} if and only if ϵ_{A}<ϵ_{E} It follows from Equations (256) and (262) that

Thus, p_{e,A}<p_{e,E} if and only if ϵ_{A}<ϵ_{E}. It follows that

$$\frac{{ϵ}_{A}^{2}}{{ϵ}_{E}^{2}} = \frac{\frac{1}{a} + \frac{1}{b}}{( 1 + \frac{1}{α} ) \frac{1}{a} + \frac{1}{β b}} \qquad ( Equation 270 )$$

where

$$a = {S}_{BA} , b = {S}_{AB} , α = \frac{{s}_{EA}}{{s}_{BA}} and β = \frac{{s}_{EB}}{{s}_{AB}} .$$

Hence ϵ_{A}<ϵ_{E} if and only if

$$\frac{b}{a} > α ( 1 - \frac{1}{β} ) \qquad ( Equation 271 )$$

The condition in Equation (271) always holds if β<1 (i.e., Eve's receive channel from Bob is weaker than Alice's receive channel from Bob). Otherwise, for β>1, the condition in Equation (271) can be met by a sufficiently large but finite p_{B} while p_{A} is finite (subject to all other parameters being finite).

### Ratio of Bit Error Rates

For large a and b, both p_{e,A} and p_{e,E} are small subject to α>1 and β>1. In this case, C_{s,P} is only a small positive value. But the ratio γₚ of p_{e,A} over p_{e,E} is also a meaningful metrics subject to a sufficiently long packet (e.g., a packet of n independent bits with np_{e,E}≈1).

Applying

$$\frac{x}{1 + {x}^{2}} {ϕ}_{0} ( x ) < Q ( x ) < \frac{{ϕ}_{0} ( x )}{x} with {ϕ}_{0} ( x ) = \frac{1}{\sqrt{2 π}} {e}^{- \frac{{x}^{2}}{2}}$$

and the condition in equation (274), one can verify that

$${γ}_{p} \dot{=} \frac{{p}_{e , A}}{{p}_{e , E}} < ( 1 + {δ}_{p} ) exp ( - P ) \\ where \qquad ( Equation 272 )$$

$${δ}_{p} = \frac{{ϵ}_{A} {ϵ}_{E}}{{sin}^{2} \frac{π}{M}} \qquad ( Equation 273 )$$

$$P = {sin}^{2} ( \frac{π}{M} ) \frac{{a}^{2} b ( β b + α a - α β a )}{( a + b ) ( α β a b + β a b + α {a}^{2} )} \qquad ( Equation 274 )$$

Here 1+δₚ≈1 for large a and b. To obtain a large P and hence a very small γₚ, we need a large a and a large b/a because

$${lim}_{b \to ∞} P = {sin}^{2} ( \frac{π}{M} ) \frac{a}{α + 1} \qquad ( Equation 275 )$$

which increases with a.

For example, if M=2, α=β=2, a=10² and b=10³ (i.e., 20 dB and 30 dB respectively), we have P≈26.4.

### STEEP for Multiple Access (M-STEEP)

Now, going back to G-STEEP but consider its use for multiple access. Specifically, let there be an access point (AP) with n_{A} antennas, and M units of single-antenna user equipment (UE) which are denoted by UE₁, . . . , UE_{M}. If we apply G-STEEP to AP and each UE separately, there would be a significant overhead associated with the channel probing for each UE. To reduce the overhead, an option is to allow all UEs to take advantage of the same probes transmitted by the AP. We will show a power condition under which the secrecy rate from each UE to AP stays positive for any given M.

In phase 1 of M-STEEP, AP broadcasts a sequence of independent realizations of the random probing vector \sqrt{p_{A}/n_{A}x}∈ [symbol] with x being [symbol] (0, I). Then UEᵢ receives

$${y}_{i} = \sqrt{{p}_{A} / {n}_{A} {h}_{i}^{T x}} + {w}_{i} = {h}_{i}^{′ Tx} + {w}_{i} \qquad ( Equation 276 )$$

with i=1, . . . , M,

$${h}_{i}^{′} = \sqrt{{p}_{A} / {n}_{A} {h}_{i}}$$

and wᵢ being [symbol] (0,1). The effective probe arriving at UEᵢ is defined to be

$${p}_{i} = {\overline{h}}_{i}^{Tx} with {\overline{h}}_{i}^{T} \dot{=} \frac{{h}_{i}^{T}}{\vert {h}_{i} \vert} .$$

The MMSE estimate of pᵢ is denoted by [symbol] , and its MSE is

$${d}_{i} \dot{=} \frac{1}{{S}_{i} + 1} \qquad ( Equation 277 )$$

with Sᵢ=(p_{A}/n_{A})|hᵢ|². The variance of [symbol] is

$${c}_{i} \dot{=} 1 - {d}_{i} = \frac{{S}_{i}}{{S}_{i} + 1} \qquad ( Equation 278 )$$

One can also verify that

$$E \{ {p}_{i} {p}_{j}^{*} \} = {ϕ}_{i , j} , E \{ \} = {c}_{i} {c}_{j} {ϕ}_{i , j} , and E \{ {p}_{i} \} = {c}_{j} {ϕ}_{i , j} with {ϕ}_{i , j} = {\overline{h}}_{i}^{T {\overline{h}}_{j}^{*}} .$$

In phase 2 of M-STEEP, the UEs use orthogonal multiple access to the AP. Specifically, UEᵢ sends out a sequence of random realizations of \sqrt{pᵤᵢ/2}( [symbol] +sᵢ) (of power upper bounded by pᵤᵢ) with sᵢ being a secret random symbol with the distribution [symbol] (0,1), and the corresponding signal received by the AP is

$${y}_{Ai} = \sqrt{{p}_{ui} / 2} ( \hat{{p}_{ι}} + {s}_{i} ) {h}_{Ai} + {w}_{Ai ∖} = \sqrt{1 / 2} ( \hat{{p}_{ι}} + {s}_{i} ) {h}_{Ai}^{′} + {w}_{Ai} ∈ {𝒞}^{{𝓃}_{𝒜} \times 1} \qquad ( Equation 279 )$$

with w_{Ai} being [symbol] (0,1) and h′_{Ai}=\sqrt{pᵤᵢh_{Ai}}.

It follows with n_{B}=1 that the effective capacity from UEᵢ to AP relative to sᵢ is

$${C}_{A \vert i} \dot{=} I ( {s}_{i} ; \hat{{s}_{ι}} ) = log ( 1 + \frac{\frac{{S}_{Ai}}{2}}{\frac{{S}_{i} {S}_{Ai} / 2}{{( {S}_{i} + 1 )}^{2}} + 1} ) \qquad ( Equation 280 )$$

where [symbol] is the MMSE estimate of sᵢ by AP, S_{Ai}=pᵤᵢ|h_{Ai}|² and Sᵢ was defined before.
Effective Return Channel from Each UE to Eve

The signals received by Eve during both phases of M-STEEP are

$${y}_{EA} = \sqrt{{p}_{A} / {n}_{A} {H}_{EAx}} + {w}_{EA} = {H}_{EA}^{′} x + {w}_{EA} \qquad ( Equation 281 )$$

$${y}_{Ei} = \sqrt{{p}_{ui} / 2} {h}_{{E}_{i}} ( \hat{{p}_{i}} + {s}_{i} ) + {w}_{Ei} = \sqrt{1 / 2} {h}_{{E}_{i}}^{′} ( \hat{{p}_{i}} + {s}_{i} ) + {w}_{Ei} , \qquad ( Equation 282 )$$

for all i=1, . . . , M. Here

$${h}_{E i}^{′} = \sqrt{{p}_{ui} {h}_{Ei}} ,$$

and [symbol] for every i depends on x. Also note that s₁, . . . , s_{M} are independent of each other.

It can be shown that the MSE of the MMSE estimate [symbol] of sᵢ by Eve using

$${y}_{E} \approx {[ {y}_{E 1}^{T} , … , {y}_{EM}^{T} , {y}_{EA}^{T} ]}^{T}$$

is

$${σ}_{Δ {s}_{iE}}^{2} = 1 - {r}_{i}^{{HR}^{- 1 r} i} \qquad ( Equation 283 )$$

where rᵢ^{H}=E{s_{iy}_{_{E}}_{^{H}}} and R=E{y_{Ey}_{_{E}}_{^{H}}}. Furthermore,

$${r}_{i} = {[ {0}_{{n}_{E} ( i - 1 )}^{T} , \sqrt{1 / 2 {h}_{Ei}^{′ T}} , {0}_{{n}_{E} ( M - i + 1 )}^{T} ]}^{T} \qquad ( Equation 284 )$$

$$and$$

$$R = [ \begin{matrix}{R}_{1 , 1} & ⋯ & {R}_{1 , M + 1} \\ ⋯ & ⋯ & ⋯ \\ {R}_{M + 1 , 1} & ⋯ & {R}_{M + 1 , M + 1}\end{matrix} ] \qquad ( Equation 285 )$$

Here 0ₘ is a zero vector of m elements, and

$${R}_{i , j} = {R}_{j , i}^{H}$$

for all i and j. For 1≤i≤M, 1≤j≤M and i≠j,

$${R}_{i , i} = ( 1 / 2 ) ( 1 + {c}_{i} ) {h}_{Ei}^{′} {h}_{Ei}^{′ H} + {I}_{{n}_{E}} \qquad ( Equation 286 )$$

$${R}_{i , j} = ( 1 / 2 ) {ϵ}_{i , j {h}_{Ei}^{′} {h}_{Ej}^{′ H}} \qquad ( Equation 287 )$$

$${R}_{i , M + 1} = \sqrt{1 / 2 {h}_{Ei}^{′} {r}_{x , i}^{{HH}_{EA}^{′ H}}} \qquad ( Equation 288 )$$

$${R}_{M + 1 , M + 1} = {H}_{EA}^{′} {H}_{EA}^{′ H} + {I}_{{n}_{E}} \qquad ( Equation 289 )$$

where

$${ϵ}_{i , j} = E \{ \} = {c}_{i} {c}_{j} {ϕ}_{i , j} and {r}_{x , i} = E \{ x \} = {c}_{i} {\overline{h}}_{i}^{*} .$$

To obtain an insight into

$${σ}_{Δ {s}_{i , E}}^{2} ,$$

let us next choose i=1 without loss of generality. We can rewrite Equation (285) as

$$R = [ \begin{matrix}{R}_{1 , 1} & {\overline{R}}_{1} \\ {\overline{R}}_{1}^{H} & {\overline{R}}_{1 , 1}\end{matrix} ] \qquad ( Equation 290 )$$

where R_{1,1} is the same n_{E}×n_{E} upper-left block of R in Equation (285).

Then

$${R}^{- 1} = [ \begin{matrix}{( {R}_{1 , 1} - {\overline{R}}_{1} {\overline{R}}_{1 , 1}^{- 1} {\overline{R}}_{1}^{H} )}^{- 1} & * \\ * & *\end{matrix} ] \qquad ( Equation 291 )$$

where * denotes matrix blocks of no importance.

Hence, Equation (283) with i=1 becomes

$${σ}_{Δ {s}_{1 , E}}^{2} = 1 - ( 1 / 2 ) {{h}_{E 1}^{′ H} ( {R}_{1 , 1} - {\overline{R}}_{1 {\overline{R}}_{1 , 1}^{- 1 {\overline{R}}_{1}^{H}}} )}^{- 1 {h}_{E 1}^{′}} \qquad ( Equation 292 )$$

$$Recall$$

$${R}_{1 , 1} = ( 1 / 2 ) ( 1 + {c}_{1} ) {h}_{E 1}^{′} {h}_{E 1}^{′ H} + {I}_{{n}_{E}} \qquad ( Equation 293 )$$

$${\overline{R}}_{1} = \sqrt{1 / 2 {h}_{E 1}^{′} {c}_{1}^{H}} \qquad ( Equation 294 )$$

$$with {c}_{1}^{H} = [ \sqrt{1 / 2} {ϵ}_{1 , 2 {h}_{E 2}^{′ H}} , … , \sqrt{1 / 2} {ϵ}_{1 , {Mh}_{EM}^{′ H} '} {r}_{x , 1}^{{HH}_{EA}^{′ H}} ] .$$

$$Hence$$

$$\overline{{R}_{1}} {\overline{R}}_{1 , 1}^{- 1} {\overline{R}}_{1}^{H} = ( 1 / 2 ) {h}_{E 1}^{′} {c}_{1}^{H} {\overline{R}}_{1 , 1}^{- 1} {c}_{1} {h}_{E 1}^{′ H} . \qquad ( Equation 295 )$$

$$Let$$

$${γ}_{1} = 1 + {c}_{1} - {c}_{1}^{H {\overline{R}}_{1 , 1}^{- 1 {c}_{1}}} \qquad ( Equation 296 )$$

We see that

$${γ}_{1} - 1 = {c}_{1} - {c}_{1}^{H {\overline{R}}_{1 , 1}^{- 1 {c}_{1}}} > 0$$

which is effectively the MSE of the MMSE estimate of [symbol] by Eve using

$${y}_{E \vert 1 \dot{=} {[ {y}_{E , 2}^{T} , … , {y}_{E , M}^{T} , {y}_{E A}^{T} ]}^{T}} .$$

It follows that

$${σ}_{Δ {s}_{1 , E}}^{2} = 1 - ( 1 / 2 ) {{h}_{E 1}^{′ H} ( ( 1 / 2 ) {γ}_{1} {h}_{E 1}^{′} {h}_{E 1}^{′ H} + {I}_{{n}_{E}} )}^{- 1} {h}_{E 1}^{′} \qquad ( Equation 297 )$$

$$= 1 - {( {γ}_{1} {‖ {h}_{E 1}^{′} ‖}^{2} / 2 + 1 )}^{- 1} {‖ {h}_{E 1}^{′} ‖}^{2} / 2$$

$$= \frac{( {γ}_{1} - 1 ) {S}_{E , 1} / 2 + 1}{{γ}_{1} {S}_{E , 1} / 2 + 1} ,$$

$$with {S}_{E , 1} = {\vert {h}_{E 1}^{′} \vert}^{2} .$$

Finally, the capacity of the effective return channel from an arbitrary UE, labelled as UE₁, to AP relative to s₁ is

$${C}_{E \vert 1} = I ( {s}_{1} ; {y}_{E} ) = I ( {s}_{1} ; {s}_{1 , E} ) = log ( 1 / {σ}_{Δ {s}_{1 , E}}^{2} ) = log ( 1 + \frac{{S}_{E , 1} / 2}{( {γ}_{1} - 1 ) {S}_{E , 1} / 2 + 1} ) \qquad ( Equation 298 )$$

Proposition 4: An achievable secrecy rate of M-STEEP from an arbitrarily selected UE₁ to the AP relative to the message symbol s₁ from UE₁ is

$${C}_{s , 1} = {( {C}_{A \vert 1} - {C}_{E \vert 1} )}^{+} = {[ log ( 1 + \frac{\frac{{S}_{A , 1}}{2}}{\frac{{S}_{1} {S}_{A , 1} / 2}{{( {S}_{1} + 1 )}^{2}} + 1} ) - log ( 1 + \frac{{S}_{E , 1} / 2}{( {γ}_{1} - 1 ) {S}_{E , 1} / 2 + 1} ) ]}^{+} \qquad ( Equation 299 )$$

where only γ₁ is affected by UEᵢ's power for all i, i.e., only γ₁ depends on

$${S}_{E , i} = {\vert {h}_{E i}^{′} \vert}^{2}$$

for all i=1, . . . , M.

If M=1, it reduces to Corollary 1.

Proposition 5: Assume n_{A}=1, rewrite

$${H}_{EA}^{′} as {h}_{EA}^{l} , and let {S}_{i} = {\vert {h}_{i}^{′} \vert}^{2} , {S}_{A i} = {\vert {h}_{A i}^{′} \vert}^{2} and {S}_{E i} = {\vert {h}_{E i}^{′} \vert}^{2} , {S}_{EA} = {\vert {h}_{EA}^{′} \vert}^{2} , {α}_{i} = \frac{{S}_{EA}}{{S}_{i}} and {β}_{i} = \frac{{S}_{E i}}{{S}_{A i}} .$$

Then γ₁−1 in Equation (299) becomes

$${γ}_{1} - 1 = \frac{{S}_{1}}{{( {S}_{1} + 1 )}^{2}} ( 1 + \frac{{S}_{1}}{{α}_{1} {S}_{1} + 1} ( 1 - \frac{{t}_{1 , M}}{{α}_{1} {S}_{1} + 1} ) ) \qquad ( Equation 300 )$$

Also t_{1,M}=0 for M=1, and t_{1,M} for M≥2 is defined in Equation (345) which is a function of S_{E,A} and S_{E,i} for all i≠1. And t_{1,M}<min (M−1, α₁S₁+1). Consequently, C_{s,1}>0 if and only if

$${S}_{A , 1} / 2 > ( 1 - \frac{1}{{β}_{1}} ) \frac{{( {S}_{1} + 1 )}^{2} ( {α}_{1} {S}_{1} + 1 )}{{S}_{1}^{2} ( 1 - \frac{{t}_{1 , M}}{{α}_{1} {S}_{1} + 1} )} \qquad ( Equation 301 )$$

Note that the left side of Equation (301) is proportional to pᵤ₁ (the power from UE₁) and the right side of Equation (301) is invariant to pᵤ₁ and large pᵤᵢ for all i≠1.

This proposition has also been validated by computer simulations. If M=1, Equation (301) reduces to Equation (244). But more importantly, it is seen from Equation (301) that for any given M, the secrecy rate from any UE to AP stays positive if that UE uses a sufficiently large power according to Equation (301).

### Total Secrecy Capacity of M-STEEP

A total secrecy rate of M-STEEP can be expressed as

$${C}_{s} = {C}_{s , 1} + {C}_{s , 2 \vert 1 + … + {C}_{s , M \vert 1 , … , M - 1}} \qquad ( Equation 302 )$$

with C_{s, i|1, . . . , i−1}≐[C_{A, i|1, . . . , i−1}−C_{E,i|1, . . . , i−1}]\hat{ }+ which is the secrecy rate from EUᵢ to AP subject to s₁, . . . , sᵢ₋₁ being known to AP and Eve. Furthermore, we have

$${C}_{A , i \vert 1 , … , i - 1 = I ( {s}_{i} ; {y}_{A} \vert {s}_{1} , … , {s}_{i - 1} , x )} and {C}_{E , i \vert 1 , … , i - 1 = I ( {s}_{i} ; {y}_{E} \vert {s}_{1} , … , {s}_{i - 1} )} . Here {y}_{A} = {[ {y}_{A 1}^{T} , … , {y}_{A M}^{T} ]}^{T} and {y}_{E} = {[ {y}_{E 1}^{T} , … , {y}_{E M}^{T} , {y}_{E A}^{T} ]}^{T} .$$

It is easy to verify that the capacity from UEᵢ to AP for sᵢ is invariant to s₁, . . . , sᵢ₋₁ being known to AP or not. Hence C_{A,i|1, . . . , i-1=C}_{_{A,i}} as given by Equation 280.

The MSE of the MMSE estimate of sᵢ by Eve using y_{E} and s₁, . . . , sᵢ₋₁ is

$${σ}_{Δ {s}_{i E}}^{2} = 1 - {r}_{i}^{H} {R}^{- 1} {r}_{i} \qquad ( Equation 303 )$$

$$where {r}_{i}^{H} = 𝔼 \{ {s}_{i} {y}_{E}^{H} \} and R = 𝔼 \{ {y}_{E} {y}_{E}^{H} \} and R = 𝔼 \{ {y}_{E} {y}_{E}^{H} \} \qquad ( Equation 304 )$$

$$Here {r}_{i} = {{[ {0}_{{n}_{E} ( i - 1 )}^{T} , \sqrt{1 / 2} {h}_{E i}^{′ T} , {0}_{{n}_{E} ( M - i + 1 )}^{T} ]}^{T}}^{T}$$

with

$${\overline{y}}_{E , j} = {y}_{E , j} - {h}_{Ej}^{′} {s}_{j} .$$

Furthermore, rᵢ given by Equation (284), and Rᵢ is the same as R in Equation (285) except that the jth diagonal block R_{j,j} of R for j=1, . . . , i−1 should be replaced by

$${\overline{R}}_{j , j} = {c}_{{jh}_{Ej}^{′} {h}_{Ej}^{′ {HI}_{{n}_{E}}}}$$

### Finally,

$${C}_{E , i \vert 1 , … , i - 1} = - log {σ}_{Δ s}^{2} \text{?}$$

$$\text{?} \text{indicates text missing or illegible when filed}$$

Subject to i.i.d. Gaussian random channel parameters, numerical results suggest that the medium of Cₛ increases as M increases while the medium of C_{s,1} decreases (but rather slowly) as M increases. Further mathematical analysis of Cₛ remains open.

To summarize, the effective WTC system constructed by STEEP is such that the user's effective channel is almost surely stronger than Eve's effective channel. Because of this, a positive secrecy rate is virtually given without the need to know Eve's CSI. Furthermore, to realize a positive secrecy rate for STEEP, we do not necessarily need to use a capacity-achieving channel coding scheme. All we need is a channel code for which the optimal decoding can be done by the receiving user in phase 2. For example, a convolution code can be used by Bob in phase 2 to encode the stream of the secret information. Then Alice can perform the maximum likelihood decoding, such as Viterbi decoding, of the secret information. Since the decoding at Alice is optimal and the effective channel from Bob to Alice is stronger than the effective channel from Bob to Eve, the error rate at Eve is always higher than that at Alice. The lack of capacity achieving of a channel code would reduce the net channel capacities for both user and Eve but without necessarily a significant change to a positive secrecy rate. For a Gaussian-noise channel, the error rate drops exponentially as SNR increases, which creates a drastic difference between the number of errors at Alice and those at Eve. Such a gap of error rates can be used as a secrecy measure.

Provided no error is detected at Alice (using any of the established channel codes), if the secret information is meant to generate a secret key, a hash function could then be applied at Alice and Bob to produce the secret key with a higher confidence of its secrecy (also known as privacy amplification). The secret-key rate in bits/s/Hz of this STEEP-assisted method for SKG does not reduce to zero as the channel coherence time increases, unlike numerous methods in the prior art based on reciprocal channels. To know the exact amount of secrecy, it would always require the knowledge of Eve's channel. But it could suffice in practice that there is at least some amount of positive secrecy rate even in the worst possible case.

STEEP may also remind one of a widely used method for networking security called “nonce”. The usefulness of nonce is based on the assumption that Alice can send a nonce reliably to Bob while Eve can not receive it. Then this nonce can be used (normally once) by Bob to encrypt a message to be sent to Alice. Unlike nonce, STEEP allows Eve to receive the probes from Alice but with some noise while Bob does not have to receive the probes with more accuracy than Eve, and the noisy probes received by Bob are used to encrypt a secret message to be sent to Alice. STEEP is naturally applicable at the physical layer due to presence of independent noises while it is also applicable at a higher layer.

### Embodiment for Secure UAV Communications By STEEP Against Full-Duplex Active Eavesdropper

Unmanned aerial vehicle (UAV) assisted wireless communication has emerged as a highly promising element in the landscape of future wireless networks. This embodiment describes the application of “Secret-message Transmission by Echoing Encrypted Probes (STEEP)” to secure UAV communications between a ground station (Alice) and a UAV (Bob). Even with the presence of strong jamming from a full-duplex eavesdropper (Eve), STEEP shows resilience and maintains a strong positive secrecy rate in bits per channel use in every channel coherence period as long as Eve's observations during the probing phase of STEEP are not noiseless. STEEP is a novel round-trip transmission scheme for secure communications, overcoming limitations where prior schemes fail to achieve a positive secrecy rate when Eve's receive channel is stronger than users'.

Unmanned aerial vehicles (UAVs), also known as drones, have altered industries, revolutionized civilian applications, and opened up new fronts in military communications. These versatile low-altitude platforms have been used for different purposes from aerial cinematography and mapping to precision agriculture, infrastructure inspection, rescue missions, and military expeditions. Wireless communications serve as a lifeline for UAVs, enabling real-time data exchanges and navigation updates. Moreover, lower-altitude UAV deployment reduces shadowing effects, ensuring high Line of Sight (LoS) communication probability with the ground. However, its ubiquity and openness make UAV communications vulnerable to wiretapping, jamming and cyber attacks, risking mission success, data confidentiality and public safety.

Recently there have been a lot of research activities on physical layer security (PLS) for UAV communications. The PLS of UAV communication systems have been explored, where a ground sender, Alice, transmits confidential messages to a hovering UAV, while eavesdroppers are randomly positioned around the ground source. The prior art studied a UAV system with a linear trajectory, where a UAV performs inspection tasks along a straight path and communicates with a ground receiver while an eavesdropping UAV attempts to intercept the signal. Other prior art investigated energy-efficient and secure transmission in a downlink Air-2-Ground wiretap system with consideration of UAV's jitter effects. They also optimized the beamforming for confidential signal and artificial noise (AN) to minimize total transmission power from a UAV-mounted base station, and also addressed jamming from a full-duplex eavesdropper aimed at damaging the legitimate channel. The prior art also looked into a UAV-2-Vehicle system, where a UAV serves as a temporary aerial station exchanging information with a legitimate ground vehicle, subject to interception by an eavesdropping vehicle. Utilizing stochastic geometry theory, they examined the impact of UAV's 3D spatial randomness, and ground vehicles' positioning along highway, on the downlink and uplink secrecy outage performance. Furthermore, other art examined the ergodic secrecy outage rate while considering an aerial eavesdropper flying along a random trajectory with smooth turns in 3D spherical spaces. Other prior art applied a similar scheme as shown in the above references but considered secrecy outage for transmission from a multi-antenna ground station to a UAV subject to jamming from a multi-antenna full-duplex active Eve.

For the prior UAV works, it is widely assumed that Alice or Bob has more antennas than Eve does, and/or that the legitimate channel is stronger than Eve's channel with a significant probability. This is clearly not always practical. But the above assumption has been necessitated by the fact that the secrecy capacity of the classic wiretap channel transmission schemes would be zero otherwise.

The novel scheme called “Secret-message Transmission by Echoing Encrypted Probes (STEEP)” described is is described, which is a hybrid of the notions for secret key generation and wiretap channel transmission, based on generalized channel probing and generalized preprocessing for secret key generation. A unique property of STEEP is that it enables a positive secrecy capacity even if Eve's channel is always stronger than the (legitimate) users' channel.

This embodiment describes STEEP for a UAV based system subject to jamming from a full-duplex active Eve. It is shown that STEEP is far more resilient than conventional schemes as STEEP achieves a positive secrecy capacity under constant jamming from Eve. This unique feature of STEEP sets it apart from previous wiretap channel schemes and/or reciprocal-channel-based key generation schemes. Furthermore, the influence of jamming and channel fading on STEEP's performance is demonstrated, comparing it to a conventional half-duplex two-way scheme under identical power allocations.

### Principle of STEEP-Recap

To recap, the principle of STEEP as described above is a round-trip transmission scheme with a probing phase (phase 1) and an echoing phase (phase 2). Specifically, before node B transmits a secret message to node A, node A initiates the probing phase by transmitting probing (random) symbols to node B. Then node B obtains an estimate of each (effective) probing symbol. The estimated probes are subsequently encrypted with a secret message (meant for node A) and echoed back to node A in the echoing phase. Since node A knows the exact probing symbols and Eve can only has a noisy version of the probing symbols, node A has an advantage over Eve in detecting the secret message from node B provided that the effective noise or error rate in the echoing phase from node B to node A is kept small. Consequently, this results in a positive secrecy rate as long as Eve's receive channel strength during the probing phase is not infinitely stronger than that from node A to node B.

### Network Model

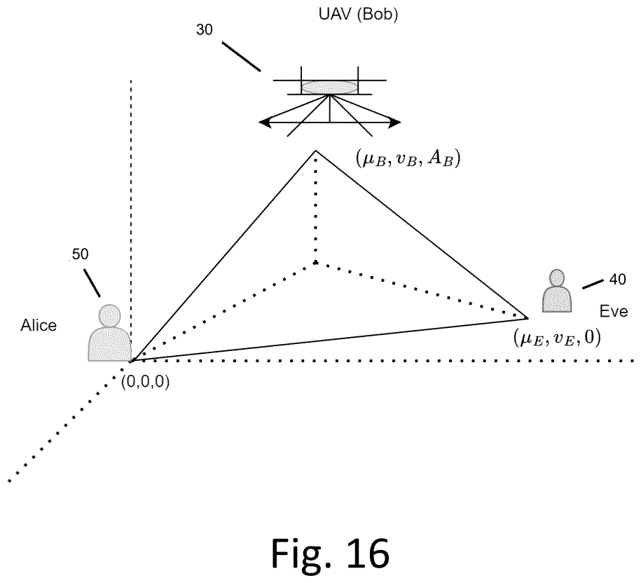

In this embodiment, a network is illustrated in FIG. 16. Here Alice 50 and Eve 40 are ground stations with n_{A} and n_{E} antennas respectively. Eve is capable of jamming and receiving in full-duplex. Bob 30 is the UAV with a single antenna. The 3D Cartesian coordinates of Alice, Bob and Eve are respectively ζ_{A}=(0,0,0), ζ_{B}=(μᵤ, vᵤ, [symbol] ᵤ), and ζ_{E}=(μ_{E}, v_{E}, 0). We assume that the height of UAV, [symbol] ᵤ, satisfies

$$0 \leq {𝒜}_{u} \leq {𝒜}_{u}^{m ax} .$$

The channel vectors from Alice to Bob and from Bob to Alice are respectively h_{B,A}∈ [symbol] and h_{AB}∈ [symbol] . The channel matrix from Alice to Eve and the channel vector from Bob to Eve are respectively \sqrt{γ_{E,A}H_{E,A}}∈ [symbol] and \sqrt{γ_{E,B}h_{E,B}}∈ [symbol] . Here γ_{E,A} and γ_{E,B} are used to model the large scale fading gains at Eve (relative to the link between Alice and Bob). For channels between air and ground, we consider both line-of-sight (LoS) and non-line-of-sight (NLoS) components, i.e.,

$${h}_{B , A} = \sqrt{\frac{{K}_{B , A}}{1 + {K}_{B , A}}} {h}_{B , A}^{L} + \sqrt{\frac{1}{1 + {K}_{B , A}}} {h}_{B , A}^{N} \qquad ( Equation 305 )$$

$${h}_{A , B} = \sqrt{\frac{{K}_{A , B}}{1 + {K}_{A , B}}} {h}_{A , B}^{L} + \sqrt{\frac{1}{1 + {K}_{A , B}}} {h}_{A , B}^{N} \qquad ( Equation 306 )$$

$${h}_{E , B} = \sqrt{\frac{{K}_{E}}{1 + {K}_{E}}} {h}_{E , B}^{L} + \sqrt{\frac{1}{1 + {K}_{E}}} {h}_{E , B}^{N} \qquad ( Equation 307 )$$

Here K_{B,A}, K_{A,B} and K_{E} are the Rician K-factors. The first terms are the LoS components, and the second terms are the NLOS components. The entries

$${h}_{B , A}^{N} , {h}_{A , B}^{N} , {h}_{E , B}^{N} ,$$

due to NLOS, are independent and identically distributed (i.i.d.) variables with the circularly symmetric complex Gaussian distribution with zero mean and unit variance, i.e., [symbol] (0,1). The entries of

$${h}_{B , A}^{L} , {h}_{A , B}^{L} , {h}_{E , B}^{L}$$

follow the tar-field planar wave model without multipath. For example, assuming a uniform linear array of antennas at Alice, the ith entry of

$${h}_{B , A}^{L}$$

can be expressed as

$${( {h}_{B , A}^{L} )}_{i} = {e}^{- j 2 {πδ}_{B , A} ( i - 1 ) sin {ϕ}_{{B , A}_{}} cos {θ}_{B , A}} \qquad ( Equation 308 )$$

where δ_{B,A} is the antenna spacing divided by wavelength, ϕ_{B,A} is the azimuth angle between Alice and Bob relative to the broadside of the antenna array (parallel to the ground), and θ_{B,A} is the elevation angle between Alice and Bob, i.e.,

$${θ}_{B , A} = arcsin ( \frac{{𝒜}_{ℬ}}{{d}_{B , A}} ) with \qquad ( Equation 309 )$$

$${d}_{B , A} = \sqrt{{μ}_{B}^{2} + {ν}_{B}^{2} + {𝒜}_{ℬ}^{2}} \qquad ( Equation 310 )$$

The structures of

$${h}_{A , B}^{L} and {h}_{E , B}^{L}$$

can be similarly determined. The channel matrix from Alice to Eve is \sqrt{γ_{E,A}H_{E,A}}∈ [symbol] , the elements of which are typically only due to NLoS and hence modelled as i.i.d. [symbol] (0, γ_{E,A}).

Assume that all line-of-sight components are reciprocal

$$( e . g . , {h}_{A , B}^{L} = {h}_{B , A}^{L} ) ,$$

all γ gains are reciprocal (e.g., γ_{E,A}=γ_{A,E}), but the NLOS channel parameters are all statistically independent (e.g., H_{E,A} is independent of H_{A,E}).

### Conventional Two-Way UAV

Now to formulate a conventional scheme to compare with STEEP where a full-duplex Eve who knows h_{B,E} transmits a beamformed jamming signal to degrade the reception at UAV. Since STEEP requires both Alice and Bob to consume powers for transmission, for comparison purposes, we consider a conventional two-way half-duplex scheme between Alice and Bob. In the conventional scheme, Alice transmits a secret message to Bob in phase 1, and Bob sends an independent secret message to Alice in phase 2, which is detailed below.

### Phase 1

In phase 1, Alice applies optimal beamforming and artificial noise. Specifically, for each sample interval, Alice transmits \sqrt{p_{A}}(wₛs_{A}+Wₐₙₛ_{ₐₙ}) where s_{A} is a secret-carrying symbol assumed to be [symbol] (0, αₛ), and sₐₙ is an artificial noise symbol assumed to be

$$𝒞𝒩 ( 0 , {β}_{{sI}_{{n}_{A} - 1}} ) .$$

### Also

$${w}_{s} = \frac{{h}_{BA}^{*}}{\vert {h}_{BA} \vert} , and [ {W}_{a} , {w}_{s} ]$$

is a unitary matrix with

$${w}_{s}^{{HW}_{a}} = 0.$$

### Moreover,

$${β}_{s} = \frac{1 - {α}_{s}}{{n}_{A} - 1}$$

so that p_{A} is the effective transmit power consumed by Alice.

Following the transmission from Alice, the signals received by Bob and Eve are respectively

$${y}_{B , 1} = \sqrt{{p}_{A}} {h}_{B , A}^{T} {w}_{s} {s}_{A} + \sqrt{{p}_{E} {γ}_{B , E}} {h}_{B , E}^{T} xBE + wB \qquad ( Equation 311 )$$

$${y}_{E , 1} = \sqrt{{p}_{A} {γ}_{E , A}} {H}_{E , A} ( {w}_{s} {s}_{A} + {W}_{an} {s}_{an} ) + \sqrt{ρ {p}_{E}} {H}_{E , E} {x}_{B , E} + {W}_{E , A} \qquad ( Equation 312 )$$

where x_{B,E} is the jamming signal from Eve to Bob, \sqrt{γ_{B,E}}h_{B,E} is the channel vector from Eve to Bob, H_{E,E} is the self-interference matrix at Eve, and ρ denotes the (residual) self-interference coefficient.

To maximally degrade the reception at Bob, Eve chooses the following beamformed jamming signal:

$${x}_{B , E} = {\overline{h}}_{B , E}^{*} {n}_{B , E} \\ with \\ {\overline{h}}_{B , E}^{*} = \frac{{h}_{B , E}^{*}}{\vert {h}_{B , E} \vert} \\ and \\ {n}_{B , E} \\ being \\ 𝒞𝒩 ( 0 , 1 ) . \qquad ( Equation 313 )$$

Assume that all noise elements such as w_{B} and elements in w_{E,A} are i.i.d. [symbol] (0,1).

In this case, the effective signal-to-noise ratio (SNR), or equivalently the signal-to-noise-and-interference ratio, in γ_{B,1} at Bob is

$$S N {R}_{B , 1} = \frac{{α}_{s} {p}_{A} {\vert {h}_{B , A} \vert}^{2}}{{p}_{E} {γ}_{B , E} {\vert {h}_{B , E} \vert}^{2} + 1} \qquad ( Equation 314 )$$

To determine the effective SNR in γ_{E,1} at Eve, we consider a (scalar) sufficient statistic of γ_{E,1} for s_{A}, which is

$${y}_{E , 1} \dot{=} {w}_{G , s}^{{Hy}_{E , 1}} \qquad ( Equation 315 )$$

with

$${w}_{G , s} = \frac{{H}_{E , {Aw}_{s}}}{\vert {H}_{E , {Aw}_{s}} \vert} .$$

It is easy to verify that the effective SNR in γ_{E,1} is

$$S N {R}_{E , 1} = \frac{{α}_{s} {p}_{A} {γ}_{E , A} {\vert {H}_{E , {Aw}_{s}} \vert}^{2}}{{T}_{1} + {T}_{2} + 1} \\ with \\ {T}_{1} = {β}_{s} {p}_{A} {γ}_{E , A} {\vert {w}_{G , s}^{{HH}_{E , {AW}_{an}}} \vert}^{2} \\ and \\ {T}_{2} = ρ {p}_{E} {\vert {w}_{G , s}^{{HH}_{E , E {\overline{h}}_{B , E}^{*}}} \vert}^{2} . \qquad ( Equation 316 )$$

So, the secrecy capacity from Alice to Bob (in bits per complex channel use) is

$$\overline{{C}_{1}} = {C}_{1}^{+} \dot{=} max ( 0 , {C}_{1} )$$

with

$${C}_{1} = log ( 1 + S N {R}_{B , 1} ) - log ( 1 + S N {R}_{E , 1} ) \qquad ( Equation 317 )$$

Here the first term is the capacity from Alice to Bob while the second term is the capacity from Alice to Eve.

### Phase 2

Unlike Alice, Bob with a single antenna is unable to apply artificial noise. Let a random symbol transmitted by Bob be \sqrt{p_{B}}s_{B} with the distribution [symbol] (0, p_{B}). The signals received by Alice and Eve are respectively

$${y}_{A , 2} = \sqrt{{p}_{B}} {h}_{A , B} {s}_{B} + \sqrt{\frac{{p}_{E} {γ}_{A , E}}{{n}_{E}}} {H}_{A , E} xAE + wA \qquad ( Equation 318 )$$

$${y}_{E , 2} = \sqrt{{p}_{B} {γ}_{E , B}} {h}_{E , B} {s}_{B} + \sqrt{\frac{ρ {p}_{E}}{{n}_{E}}} {H}_{E , E} {x}_{A , E} + {W}_{E , B} \qquad ( Equation 319 )$$

In this case, we assume that the jamming signal x_{A},E from Eve to Alice is independent of the channel matrix H_{A,E} from Eve to Alice. Furthermore, x_{A,E} is [symbol] (0, Iₙ_{_{E}}), and x_{A,E} is also independent of x_{B,E}.

The effective SNR at Alice is the SNR in

$${\overline{h}}_{A , B}^{{Hy}_{A , 2}} with {\overline{h}}_{A , B} = \frac{{h}_{A , B}}{\vert {h}_{A , B} \vert} ,$$

which is

$$S N {R}_{A , 2} = \frac{{p}_{B} {\vert {h}_{A , B} \vert}^{2}}{\frac{{p}_{E} {γ}_{A , E}}{{n}_{E}} {\vert {\overline{h}}_{A , B}^{{HH}_{A , E}} \vert}^{2} + 1} \qquad ( Equation 320 )$$

Similarly, the effective SNR at Eve is

$$S N {R}_{E , 2} = \frac{{p}_{B} {γ}_{E , B} {\vert {h}_{E , B} \vert}^{2}}{\frac{ρ {p}_{E}}{{n}_{E}} {\vert {\overline{h}}_{E , B}^{{HH}_{E , E}} \vert}^{2} + 1} \\ with \\ {\overline{h}}_{E , B} = \frac{{h}_{E , B}}{\vert {h}_{E , B} \vert} . \qquad ( Equation 321 )$$

Then the secrecy capacity from Bob to Alice is

$$\overline{{C}_{2}} = {C}_{2}^{+}$$

with

$${C}_{2} = log ( 1 + S N {R}_{A , 2} ) - log ( 1 + S N {R}_{E , 2} ) \qquad ( Equation 322 )$$

### Total Secrecy Capacity

The total secrecy capacity (in bits per round-trip complex channel use) of the conventional scheme is

$$\overline{{C}_{c o n v}} = \overline{{C}_{1}} + \overline{{C}_{2}} \qquad ( Equation 323 )$$

For a target secrecy rate Rₛ, the secrecy outage probability of the conventional scheme is

$${O}_{c o n v} ( {R}_{s} ) ≐ Prob ( \overline{{C}_{c o n v}} \leq {R}_{s} ) \qquad ( Equation 324 )$$

### Application of STEEP to UAV

We now consider a secret-message transmission from Bob to Alice using STEEP.

### Phase 1

In phase 1 of STEEP, Alice sends a sequence of random probing vectors. Such a vector is denoted by \sqrt{p_{A}/n_{A}}x_{A} where x_{A} is [symbol] (0, Iₙ_{_{A}}). The signals received by Bob and Eve in this phase are

$${\{ y \} \_B = √ \overline{{p}_{A} {n}_{A}} {h}_{B , A}^{T} x )}_{A} + \sqrt{{p}_{E} {γ}_{B , E}} {h}_{B , E}^{T} {x}_{B , E} + {w}_{B} \qquad ( Equation 325 )$$

$${y}_{E , A} = \sqrt{\frac{{p}_{A} {γ}_{E , A}}{{n}_{A}}} {H}_{E , A} {x}_{A} + \sqrt{ρ {p}_{E}} {H}_{E , E} {x}_{B , E} + {W}_{E , A} \qquad ( Equation 326 )$$

where x_{B,E} is the jamming noise from Eve as discussed before, i.e.

$${x}_{B E} = {\overline{h}}_{B , E}^{*} {n}_{B , E} .$$

We will call the following an “effective probe” arriving at Bob:

$${p}_{0} = {e}^{- j {θ}_{B}} {\overline{h}}_{B , A}^{T} {x}_{A} \qquad ( Equation 327 )$$

$$with$$

$$\overline{\overline{{h}_{B , A}}} = \frac{1}{\vert {h}_{B , A} \vert} {h}_{B , A}$$

and θ_{B}=0 for n_{A}≥2. If n_{A}=1, we can choose θ_{B} to be the phase of h̅_̅{̅B̅,̅A̅}̅ so that no channel feedback from Bob to Alice would be necessary.

### Phase 2

In phase 2 of STEEP, Bob transmits a sequence of mutually to forward-error-correction channel coding, they are not exactly independent.} independent symbols, and such a symbol is structured as

$$\sqrt{{p}_{B}} {x}_{B} = \sqrt{\frac{{p}_{B}}{2}} ( + s ) \qquad ( Equation 328 )$$

where s is a symbol in a secret message from Bob, and [symbol] is the MMSE estimate of p₀ by Bob from y_{B}. We will also let s be [symbol] (0,1). Here x_{B} is called an “encrypted probe”.

Now the signals received by Alice and Eve are respectively

$${y}_{A} = \sqrt{{p}_{B}} {h}_{A , B} {x}_{B} + \sqrt{\frac{{p}_{E} {γ}_{A , E}}{{n}_{E}}} {H}_{A , E} {x}_{A , E} + {w}_{A} \qquad ( Equation 329 )$$

$${y}_{E , B} = \sqrt{{p}_{B} {γ}_{E , B}} {h}_{E , B} {x}_{B} + \sqrt{\frac{ρ {p}_{E}}{{n}_{E}}} {H}_{E , E} {x}_{A , E} + {w}_{E , B} , \qquad ( Equation 330 )$$

Where x_{A,E} is the jamming noise from Eve to Alice (as discussed before). As assumed before, w_{A} is [symbol] (0, I), and w_{E,B} is [symbol] (0, I).

Alice now needs to detect the information in s using her knowledge of x_{A} and y_{A} while Eve could try to detect the information in s based on y_{E,A} and y_{E,B}.

### Secrecy Analysis of STEEP

1) Optimal estimation at Bob: Since [symbol] is the MMSE estimate of p₀ from y_{B}, it follows from Equation (325) that

$$\begin{matrix}{\hat{p}}_{0} & = 𝔼 \{ {p}_{0} {y}_{B}^{H} \} {( E \{ {y}_{B} {y}_{B}^{H} \} )}^{− 1} {y}_{B}\end{matrix} = \frac{\sqrt{\frac{{p}_{A}}{{n}_{A}}} ‖ {h}_{B , A} ‖ {y}_{B}}{\frac{{p}_{A}}{{n}_{A}} {‖ {h}_{B , A} ‖}^{2} + {p}_{E} {γ}_{B , E} {‖ {h}_{B , E} ‖}^{2} + 1} . \qquad ( Equation 331 )$$

Furthermore, the MSE of [symbol] is

$${σ}_{Δ {p}_{0}}^{2} ≐ 𝔼 \{ {\vert Δ {p}_{0} \vert}^{2} \} = 𝔼 \{ {\vert {p}_{0} \text{?} − {p}_{0} \vert}^{2} \} = \frac{{S}_{B , E} + 1}{{S}_{B , A} + {S}_{B , E} + 1} \qquad ( Equation 332 )$$

$$with$$

$${S}_{B , A} = \frac{{p}_{A}}{{n}_{A}} {\vert {h}_{B , A} \vert}^{2} \qquad ( Equation 333 )$$

$$and$$

$${S}_{B , E} = {P}_{E} {γ}_{B , E} {\vert {h}_{B , E} \vert}^{2} .$$

$$Also$$

$${sigma}_{2}^{} ≐ E \{ \vert {\vert}^{2} \} = \frac{{S}_{B , A}}{{S}_{B , A} + {S}_{B , E} + 1}$$

$$\text{?} \text{indicates text missing or illegible when filed}$$

2) Optimal estimation at Alice: It follows that

$$Δ {y}_{A} ≐ {y}_{A} - E ( {y}_{A} \vert {x}_{A} ) = {y}_{A} - \sqrt{\frac{{p}_{B}}{2}} {h}_{A , B} σ \frac{2}{} {p}_{0} \qquad ( Equation 334 )$$

and the MMSE estimate of s by Alice is given by

$$Δ {y}_{A} ≐ {y}_{A} - 𝔼 ( {y}_{A} \vert {x}_{A} ) = {y}_{A} - √ \frac{{p}_{B}}{2} {h}_{A , B} σ \frac{2}{{\hat{p}}_{0}} {p}_{0} \qquad ( Equation 335 )$$

Furthermore, the MSE of [symbol] is

$${σ}_{Δ {s}_{A}}^{2} = 1 - \frac{{p}_{B}}{2} {{h}_{AB}^{H} ( \frac{{p}_{B}}{2} ( {σ}_{{\hat{p}}_{0}}^{2} {σ}_{Δ {p}_{0}}^{2} + 1 ) {h}_{A , B} {h}_{A , B}^{H} + \frac{{p}_{E} {γ}_{A , E}}{{n}_{E}} {H}_{A , E} {H}_{A , B}^{H} + {I}_{{n}_{A}} )}^{2} {h}_{AB} \qquad ( Equation 336 )$$

So, the capacity of the effective return channel from Bob to Alice (relative to s) is

$${C}_{A \vert B} = log \frac{1}{{σ}_{Δ {s}_{A}}^{2}} \qquad ( Equation 337 )$$

3) Optimal estimation at Eve: Recall that the signals received by Eve are y_{E,A} in Equation (326) and y_{E,B} in Equation (330).

$$Let {y}_{E} = {[ {y}_{EA}^{T} , {y}_{EB}^{T} ]}^{T} .$$

Then the MMSE estimate of s by Eve is

$$= E \{ s {y}_{E}^{H} \} {( E \{ {y}_{E} {y}_{E}^{H} \} )}^{- 1} {y}_{E} \qquad ( Equation 338 )$$

### and its MSE is

$${σ}_{Δ {s}_{E}}^{2} ≐ E \{ {\vert - s \vert}^{2} \} = 1 - E \{ s {y}_{E}^{H} \} {( E \{ {y}_{E} {y}_{E}^{H} \} )}^{- 1} {( E \{ s {y}_{E}^{H} \} )}^{H} \qquad ( Equation 339 )$$

$$Here$$

$$𝔼 \{ {sy}_{E}^{H} \} = [ {0}^{T} , \sqrt{\frac{{p}_{B} {γ}_{E , B}}{2}} {h}_{E , B}^{H} ] , \qquad ( Equation 340 )$$

$$𝔼 \{ {y}_{B} {y}_{E}^{H} \} = [ \begin{matrix}A & C \\ {C}^{H} & B\end{matrix} ] \qquad ( Equation 341 )$$

$$A = \frac{{p}_{A} {γ}_{E , A}}{{n}_{A}} {H}_{E , A} {H}_{E , A}^{H} + ρ {p}_{E} {H}_{E , E} {\overline{h}}_{E , B}^{⋆} {\overline{h}}_{B , E}^{T} {H}_{E , E}^{H} + {I}_{{n}_{E}} \qquad ( Equation 342 )$$

$$\begin{matrix} & B = {t}_{1} \frac{{p}_{A} {γ}_{E , B}}{2} {h}_{E , B} {h}_{E , B}^{H} + \frac{ρ {p}_{E}}{{n}_{E}} {H}_{E , E} {H}_{E , E}^{H} + {I}_{{n}_{E}}\end{matrix} \qquad ( Equation 343 )$$

$$C = \sqrt{\frac{{p}_{A} {p}_{B} {γ}_{E , A} {γ}_{E , B}}{2 {n}_{A}}} {H}_{E , A} r {h}_{E , B}^{H} \qquad ( Equation 344 )$$

$$where$$

$${t}_{1} = {σ}_{2}^{} + 1 and r = E \{ {x}_{A} \} .$$

We have also used the independence between X_{A,E} and x_{B,E}. Let Q=[q₁, Q₁] be an n_{A}×n_{A} unitary matrix with

$${q}_{1} = {\overline{h}}_{B , A}^{*} .$$

### Then

$$r = 𝔼 \{ {QQ}^{H} {x}_{A} {\hat{p}}_{0}^{*} \} = Q [ \begin{matrix}{σ}_{{\hat{p}}_{0}}^{2} \\ {Q}_{1}^{H} r\end{matrix} ] = Q [ \begin{matrix}{σ}_{{\hat{p}}_{0}}^{2} \\ 0\end{matrix} ] = {σ}_{{\hat{p}}_{0}}^{2} {q}_{1} . \qquad ( Equation 345 )$$

Therefore, it follows from Equation (339) that

$${σ}_{Δ {s}_{E}}^{2} = 1 - \frac{1}{2} {p}_{B} {{γ}_{E , {Bh}_{E , B}^{H}} ( B - {C}^{H} {A}^{- 1} C )}^{- 1} {h}_{E , B} \qquad ( Equation 346 )$$

Furthermore,

$${C}^{H} {A}^{- 1} C = \frac{1}{2} {t}_{2} {p}_{B} {γ}_{E , {Bh}_{E , {Bh}_{E , B}^{H}}} \\ with \\ {t}_{2} = \frac{{p}_{A} {γ}_{E , A}}{{n}_{A}} {r}^{H} {H}_{E , A}^{{HA}^{- 1} {H}_{E , {A}^{r}}} . \\ So , \\ {σ}_{Δ {s}_{E}}^{2} = 1 - \frac{1}{2} {p}_{B} {γ}_{E , B} {h}_{E , B}^{H} {( ( {t}_{1} - {t}_{2} ) \frac{{p}_{B} {γ}_{E , B}}{2} {h}_{E , B} {h}_{E , B}^{{H}_{}} + \frac{ρ {p}_{E}}{{n}_{E}} {H}_{E , E} {H}_{E , E}^{H} + {I}_{{n}_{E}} )}^{- 1} {h}_{E , B} . \qquad ( Equation 347 )$$

The capacity of the effective return channel from Bob to Alice (relative to s) is

$${C}_{E \vert B = log \frac{1}{{σ}_{Δ {s}_{E}}^{2}}} \qquad ( Equation 348 )$$

### Secrecy Capacity of STEEP

Based on the classic wiretap channel theory and the above analysis of the effective channels with respect to the secret message transmitted from Bob, the secrecy capacity of STEEP (in bits per round-trip complex channel use) from (34) and (46) is C̅_̅{̅S̅T̅E̅E̅P̅}̅ with

$${C}_{STEEP} = {C}_{A \vert B - {C}_{E \vert B}} \qquad ( Equation 349 )$$

Considering random channel realizations, especially when Eve's channels are unknown to users, we can use the secrecy outage probability of STEEP, relative to a target secrecy rate Rₛ, as defined below:

$${O}_{STEEP} ( {R}_{s} ) = Prob ( \overline{\overline{{C}_{STEEP}}} \leq {R}_{s} ) \qquad ( Equation 350 )$$

### Numerical Results

In this section, we consider the scenario where Eve is directly below Bob (UAV), i.e.,

$${θ}_{E , B} = \frac{π}{2} .$$

Hence we can choose

$${γ}_{E , A} = \frac{1}{{cos}^{2} {θ}_{B , A}} and {γ}_{E , B} = \frac{1}{{sin}^{2} {θ}_{B , A}}$$

to reflect the relative channel gains.

Furthermore, we assume that Bob is in the broadside of the antenna arrays at Alice and Eve, i.e., ϕ_{A,B}=ϕ_{E,B}=0. Hence,

$${h}_{A , B}^{L} = {h}_{E , B}^{L} = {[ 1 , … , 1 ]}^{T} .$$

We also assume that K_{A,B}=K_{E,B}=20 dB and αₛ=0.5. The statistical results shown below are based on 10⁴ independent realizations of all channel parameters.

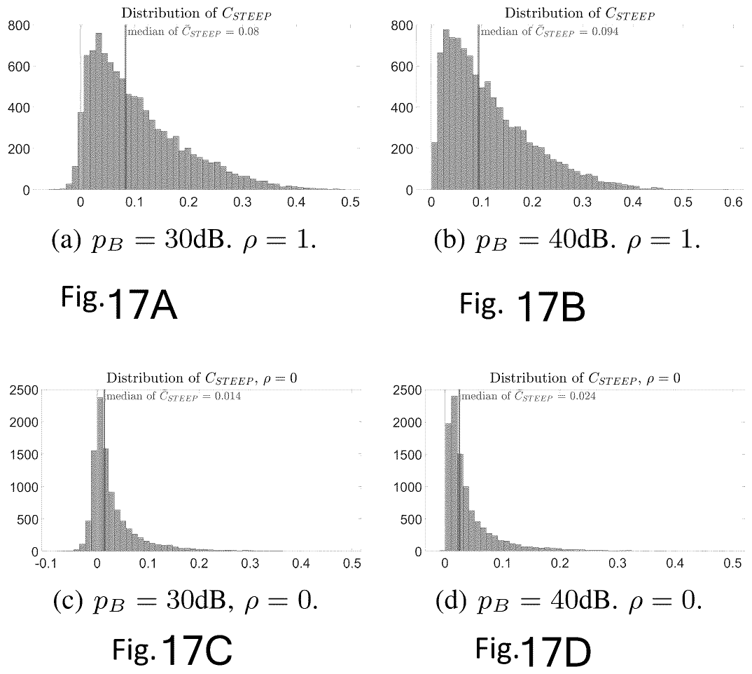

In FIGS. 17A-17D, shown are the distributions of C_{STEEP} for four combinations of p_{B}=30 dB or 40 dB and ρ=1 or 0. The principle of STEEP requires the channel quality in the echoing phase to be relatively strong to ensure a positive secrecy. So, here p_{B} is chosen to be 10 dB and 20 dB larger than p_{A}. It is seen that C_{STEEP} is larger than zero with a high probability for the case of p_{B}=40 dB.

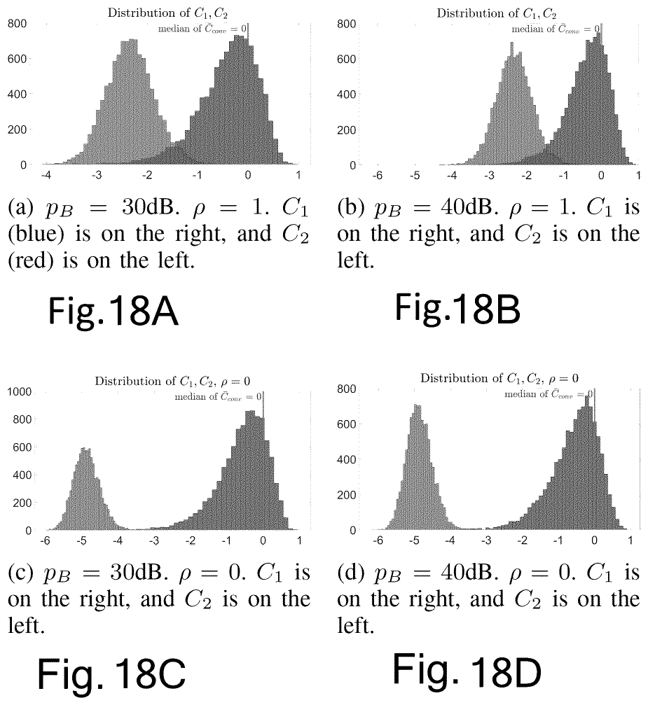

In contrast to FIGS. 17A-17D, FIGS. 18A-18D show the distributions of C₁ and C₂ for the conventional scheme where p_{B}=30.40 dB and ρ=1,0. We see that in all cases, C₂ is less than zero (i.e., C̅₂̅=0) with probability equal to one. A nonzero probability for C̅_̅{̅c̅o̅n̅v̅}̅>0 comes from that of C₁>0, which is considerably smaller than the probability of C̅_̅{̅S̅T̅E̅E̅P̅}̅>0. Also note that C₁ is invariant to p_{B} while C₂ is invariant to p_{A}. We also see that C₁ is not sensitive to ρ. This is because the noise at Eve is mostly due to the artificial noise from Alice, not due to self-interference. But C₂ reduces significantly as p decreases.

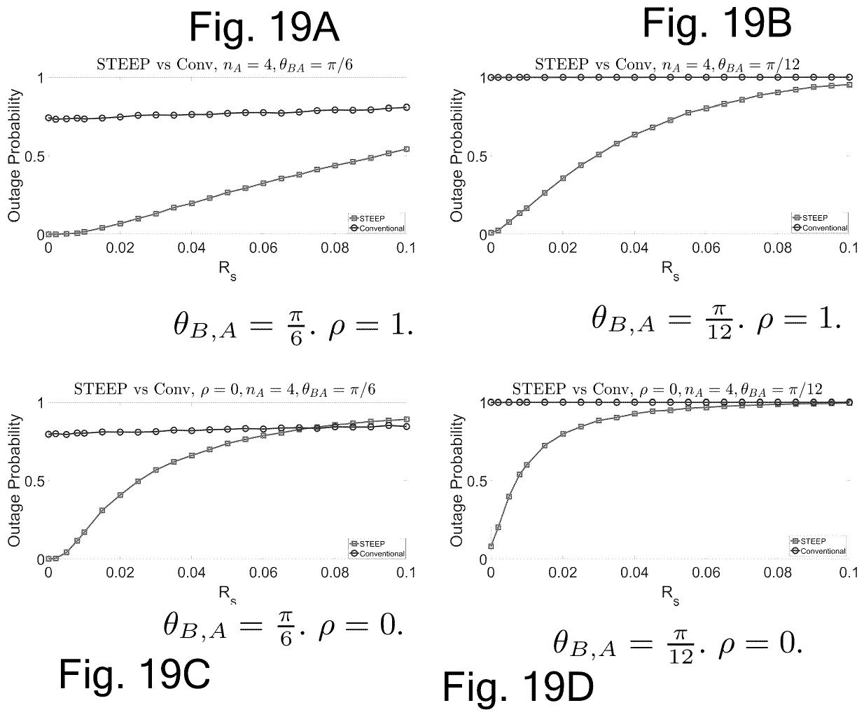

FIGS. 19A-19D compare the secrecy outage probabilities of the STEEP and conventional schemes versus a range of small but positive Rₛ for

$${θ}_{B , A} = \frac{π}{6} , \frac{π}{12}$$

and ρ=1,0. As expected, for a small positive Rₛ, the outage rate of STEEP is small with a sufficiently large p_{B}.

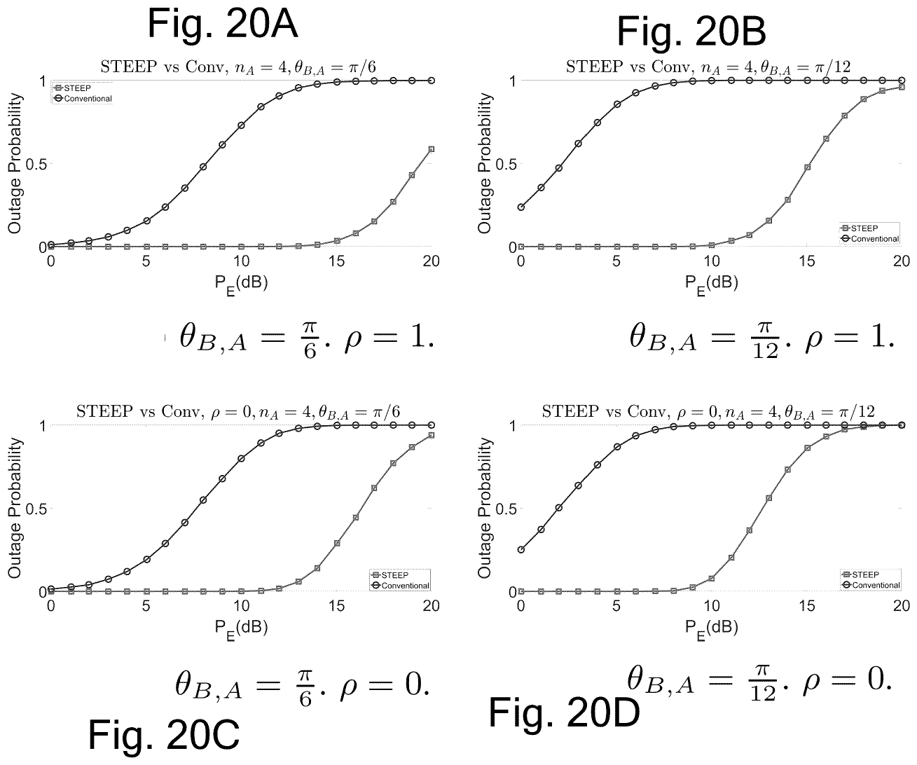

FIGS. 20A-20D compares the secrecy outage probabilities of both schemes versus p_{E}. In all cases of

$${θ}_{B , A} = \frac{π}{6} or \frac{π}{12}$$

and ρ=1 or 0, STEEP shows a much greater robustness against secrecy outage than the conventional scheme. As explained earlier, the performance of the conventional scheme is not sensitive to ρ.

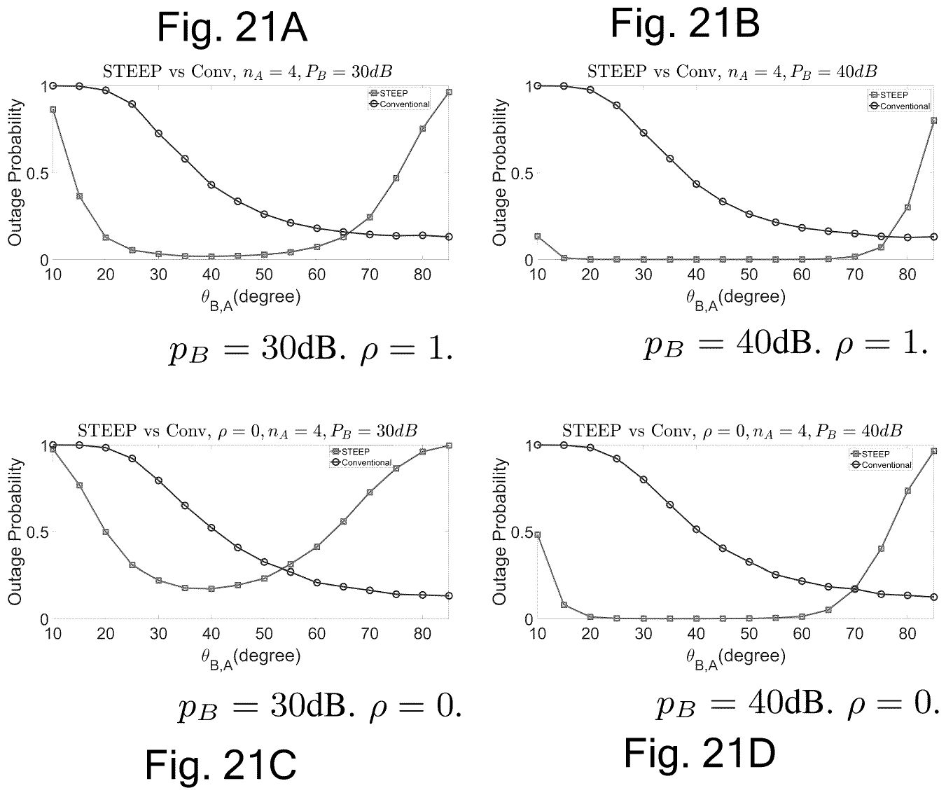

FIGS. 21A-21D, compare the secrecy outage probabilities of both schemes versus the elevation angle θ_{B,A}. We see that the conventional scheme always performs very poorly when θ_{B,A} is small but its performance improves as θ_{B,A} increases. Note that as θ_{B,A} reduces within

$$( 0 , \frac{π}{2} ) ,$$

the channel gain between Bob and Eve (relative to the channel gain between Alice and Bob) increases, and as θ_{B,A} increases, the channel gain between Alice and Eve increases. When Eve is close to Alice, the artificial noise from Alice with multiple antennas is effective. But when Eve is close to Bob, the reception quality at Bob suffers significantly due to the jamming noise from the full-duplex Eve. However, for STEEP, we see that there is a wide range of θB,A within which the secrecy outage rate is virtually zero. We also see that as p_{B} increases, this range increases. In fact, it can be shown that for any

$$0 < {θ}_{B , A} < \frac{π}{2}$$

(and given all other parameters), there is a finite threshold of p_{B} beyond which C̅_̅{̅S̅T̅E̅E̅P̅}̅>0.

In this embodiment, discussed was a novel application of STEEP for UAV communications subject to both jamming and eavesdropping from a full-duplex multi-antenna active adversary (Eve). The legitimate nodes in this applications are a single-antenna UAV (Bob) and a multi-antenna ground station (Alice). There was analyzed the secrecy capacity of STEEP for this application as well as the secrecy capacity of a widely adopted conventional scheme using artificial noise from Alice. Provided were numerical illustrations of these secrecy capacities and their corresponding secrecy outage probabilities. The results show that STEEP has a much stronger robustness in achieving positive secrecy rates and/or low probabilities of secrecy outage than the conventional scheme. This is consistent with a STEEP's property that its secrecy capacity in bits per round-trip channel use is positive as long as Eve's channel strength during the probing phase is finite and the user's channel strength during the echoing phase is sufficiently strong.

What is claimed is:

1. A method for secret message transmission by echoing encrypted probes, comprising:
a first node transmits probe signals to a second node over a probing channel, and unintentionally transmits the probe signals to a third node, over one or more probing channels, from which the third node obtains a noisy version of the probe signals while the first node may receive a noisier version of the probe signals; and
the first node echoes back estimates of the signal probes, but encrypted by the first node's secret key, over one or more return channels that have a higher quality than the probing channel to achieve a positive secrecy rate from the first node to the second node.

2. The method of claim 1, wherein transmission from the first node to the second node and third node is established wherein an effective return channel from the first node to the second node is guaranteed to be stronger than that from the first node to the third node to achieve the positive secrecy rate.

3. The method of claim 1, wherein the probing channel is wireless, or wireline, analog or digital, fading or non-fading, etc.

4. The method of claim 1, wherein the probing channel is wireline.

5. The method of claim 1, wherein the probing channel is analog.

6. The method of claim 1, wherein the probing channel is digital.

7. The method of claim 1, wherein the probing channel is fading.

8. The method of claim 1, wherein the probing channel is non-fading.

9. The method of claim 1, wherein at least one of the first or second nodes is an unmanned aerial vehicle.

10. The method of claim 1, wherein at least one of the first or second nodes is a drone.

11. A systems for secret message transmission by echoing encrypted probes, comprising:
a first node that transmits probe signals to a second node over a probing channel, and unintentionally transmits the probe signals to a third node, over one or more probing channels, from which the third node obtains a noisy version of the probe signals while the first node may receive a noisier version of the probe signals;
wherein the first node echoes back estimates of the signal probes, but encrypted by the first node's secret key, over one or more return channels that have a higher quality than the probing channel to achieve a positive secrecy rate from the first node to the second node.

12. The system of claim 11, wherein transmission from the first node to the second node and third node is established wherein an effective return channel from the first node to the second node is guaranteed to be stronger than that from the first node to the third node to achieve the positive secrecy rate.

13. The system of claim 11, wherein the probing channel is wireless, or wireline, analog or digital, fading or non-fading, etc.

14. The system of claim 11, wherein the probing channel is wireline.

15. The system of claim 11, wherein the probing channel is analog.

16. The system of claim 11, wherein the probing channel is digital.

17. The system of claim 11, wherein the probing channel is fading.

18. The system of claim 11, wherein the probing channel is non-fading.

19. The system of claim 11, wherein at least one of the first or second nodes is an unmanned aerial vehicle.

20. The system of claim 11, wherein at least one of the first or second nodes is a drone.
